SEQUENCE LISTING (283 sequences)

SEQ ID NO: 1 - DNA, 22 bp, Homo sapiens
cagacaacgtaagtgtgattta

SEQ ID NO: 2 - DNA, 21 bp, Homo sapiens
cagacaacataagtgtgattt

SEQ ID NO: 3 - DNA, 22 bp, Homo sapiens
tgtctggaaagtcagcctttag

SEQ ID NO: 4 - DNA, 19 bp, Homo sapiens
ttgtctgaaagtcagcctt

SEQ ID NO: 5 - DNA, 18 bp, Homo sapiens
ttgtctgaaagtcagcct

SEQ ID NO: 6 - DNA, 21 bp, Homo sapiens
ccatttctacactaatgtcca

SEQ ID NO: 7 - DNA, 20 bp, Homo sapiens
atttctacactaatgtccac

SEQ ID NO: 8 - DNA, 20 bp, Homo sapiens
cattaatgtagaaatggccg

SEQ ID NO: 9 - DNA, 26 bp, Homo sapiens
caaaaggatttataaacttcaatccg

SEQ ID NO: 10 - DNA, 26 bp, Homo sapiens
accaaaaggatttataaacttcaatc

SEQ ID NO: 11 - DNA, 23 bp, Homo sapiens
caaaaggatttacaaacttcaat

SEQ ID NO: 12 - DNA, 20 bp, Homo sapiens
aatggcgttacagccaccaa

SEQ ID NO: 13 - DNA, 19 bp, Homo sapiens
aatggcgttacagccacca

SEQ ID NO: 14 - DNA, 20 bp, Homo sapiens
atggcattacagccaccaac

SEQ ID NO: 15 - DNA, 28 bp, Homo sapiens
gcaatacttgtgatgaatgatttaatat

SEQ ID NO: 16 - DNA, 30 bp, Homo sapiens
ttgcaatacttgtgatgatttaatatcaag

SEQ ID NO: 17 - DNA, 22 bp, Homo sapiens
cagccggaactgaggaatttca

SEQ ID NO: 18 - DNA, 21 bp, Homo sapiens
cagccggaactgaggaatttc

SEQ ID NO: 19 - DNA, 21 bp, Homo sapiens
cagccagaactgaggaatttc

SEQ ID NO: 20 - DNA, 21 bp, Homo sapiens
atagggcaaacactgagacac

SEQ ID NO: 21 - DNA, 21 bp, Homo sapiens
caatagggcaaacactgagac

SEQ ID NO: 22 - DNA, 22 bp, Homo sapiens
aatagggcaaaaactgagacac

SEQ ID NO: 23 - DNA, 22 bp, Homo sapiens
atagggcaaaaactgagacaca

SEQ ID NO: 24 - DNA, 23 bp, Homo sapiens
ggaagaaaagtgtgaatttctgc

SEQ ID NO: 25 - DNA, 20 bp, Homo sapiens
taaggaagaaaagtgttaat

SEQ ID NO: 26 - DNA, 19 bp, Homo sapiens
tcttcgaatcattgatgtg

SEQ ID NO: 27 - DNA, 20 bp, Homo sapiens
aatgagtcgaagagcttttg

SEQ ID NO: 28 - DNA, 19 bp, Homo sapiens
tcttcgactcattgatgtg

SEQ ID NO: 29 - DNA, 22 bp, Homo sapiens
tggtcttgctagcgcaactcca

SEQ ID NO: 30 - DNA, 23 bp, Homo sapiens
tttggtcttgctagcgcaactcc

SEQ ID NO: 31 - DNA, 19 bp, Homo sapiens
tggtcttgctagcacaact

SEQ ID NO: 32 - DNA, 22 bp, Homo sapiens
tattcaaagcaatgagtatccc

SEQ ID NO: 33 - DNA, 21 bp, Homo sapiens
tattcaaagcaatgagtatcc

SEQ ID NO: 34 - DNA, 20 bp, Homo sapiens
tattcaaagcagtgagtatc

SEQ ID NO: 35 - DNA, 23 bp, Homo sapiens
tacacatttcttcatcaatcata

SEQ ID NO: 36 - DNA, 21 bp, Homo sapiens
gctatgattgttgaagaaatg

SEQ ID NO: 37 - DNA, 21 bp, Homo sapiens
aagcactgcagtaccttggaa

SEQ ID NO: 38 - DNA, 24 bp, Homo sapiens
tcatgtagcatttaccacagttga

SEQ ID NO: 39 - DNA, 30 bp, Homo sapiens
tgagcttttctttcttttttatctttctat

SEQ ID NO: 40 - DNA, 27 bp, Homo sapiens
gcaaaaatgtgagaagggacctcataa

SEQ ID NO: 41 - DNA, 30 bp, Homo sapiens
atgtgtaatgataggtcttgtcaaatagtt

SEQ ID NO: 42 - DNA, 30 bp, Homo sapiens
ctgtgttgaagtgatttttttggtaaaata

SEQ ID NO: 43 - DNA, 28 bp, Homo sapiens
attgatcagctatgagttataagaattt

SEQ ID NO: 44 - DNA, 29 bp, Homo sapiens
aaacatttggtaacaacaagtctgtataa

SEQ ID NO: 45 - DNA, 29 bp, Homo sapiens
acccacagataatagagaacaagatcaaa

SEQ ID NO: 46 - DNA, 30 bp, Homo sapiens
atgagtataaggtagaaaatagattatctc

SEQ ID NO: 47 - DNA, 25 bp, Homo sapiens
ccaaggtccttcattagctcaatct

SEQ ID NO: 48 - DNA, 29 bp, Homo sapiens
aaatatccttggaagagatatttattttc

SEQ ID NO: 49 - DNA, 23 bp, Homo sapiens
ccggattcacagataagggtacg

SEQ ID NO: 50 - DNA, 26 bp, Homo sapiens
cagtgacatcaataccctctatttct

SEQ ID NO: 51 - DNA, 22 bp, Homo sapiens
agtgatgtcagagtaccccaat

SEQ ID NO: 52 - DNA, 30 bp, Homo sapiens
cctcatctacttgacacaataaaagttgta

SEQ ID NO: 53 - DNA, 26 bp, Homo sapiens
atgttaaatcacacttacgttgtctg

SEQ ID NO: 54 - DNA, 24 bp, Homo sapiens
tgctatgattttcttgcgctgttc

SEQ ID NO: 55 - DNA, 21 bp, Homo sapiens
agtggaacacagagttgcatg

SEQ ID NO: 56 - DNA, 29 bp, Homo sapiens
acttgtgatgaatgatttaatatcaagat

SEQ ID NO: 57 - DNA, 21 bp, Homo sapiens
ttgtctggaaagtcagccttt

SEQ ID NO: 58 - DNA, 24 bp, Homo sapiens
gttaaatcacacttacgttgtctg

SEQ ID NO: 59 - DNA, 23 bp, Homo sapiens
gacaatagggcaaacactgagac

SEQ ID NO: 60 - DNA, 22 bp, Homo sapiens
atgattttcttgcgctgttcca

SEQ ID NO: 61 - DNA, 20 bp, Homo sapiens
agtggaacacagagttgcat

SEQ ID NO: 62 - DNA, 21 bp, Homo sapiens
agccggaactgaggaatttca

SEQ ID NO: 63 - DNA, 30 bp, Homo sapiens
acttgtgatgaatgatttaatatcaagatt

SEQ ID NO: 64 - DNA, 24 bp, Homo sapiens
gttgtctggaaagtcagcctttag

SEQ ID NO: 65 - DNA, 21 bp, Homo sapiens
atgattttcttgcgctgttcc

SEQ ID NO: 66 - DNA, 28 bp, Homo sapiens
agatgttaaatcacacttatgttgtctg

SEQ ID NO: 67 - DNA, 24 bp, Homo sapiens
caatagggcaaaaactgagacaca

SEQ ID NO: 68 - DNA, 24 bp, Homo sapiens
gctatgattttcttgtgctgttcc

SEQ ID NO: 69 - DNA, 19 bp, Homo sapiens
aagtggaacgcagagttgc

SEQ ID NO: 70 - DNA, 22 bp, Homo sapiens
cagccagaactgaggaatttca

SEQ ID NO: 71 - DNA, 30 bp, Homo sapiens
gcaatacttgtgatgatttaatatcaagat

SEQ ID NO: 72 - DNA, 23 bp, Homo sapiens
gttgtctgaaagtcagcctttag

SEQ ID NO: 73 - DNA, 26 bp, Homo sapiens
atgttaaatcacacttatgttgtctg

SEQ ID NO: 74 - DNA, 24 bp, Homo sapiens
ctatgattttcttgtgctgttcca

SEQ ID NO: 75 - DNA, 20 bp, Homo sapiens
gaagtggaacgcagagttgc

SEQ ID NO: 76 - DNA, 24 bp, Homo sapiens
gttgtctgaaagtcagcctttagt

SEQ ID NO: 77 - DNA, 80 bp, Homo sapiens
attaaaaatatgtttgaggatgtaagctagtttcaaaattttaaccatgacaattgatttccccgtaggtattcaaagca

SEQ ID NO: 78 - DNA, 80 bp, Homo sapiens
gcttcagacattttttctgggggaggcagcgaaggatttctgatctgtgggatactcactgctttgaatacctacgggga

SEQ ID NO: 79 - DNA, 30 bp, Homo sapiens
aatatgtttgaggatgtaagctagtttcaa

SEQ ID NO: 80 - DNA, 20 bp, Homo sapiens
acattttttctgggggaggc

SEQ ID NO: 81 - DNA, 21 bp, Homo sapiens
accgggcacctgtactcctca

SEQ ID NO: 82 - DNA, 22 bp, Homo sapiens
gcatgagctaaggcacccagac

SEQ ID NO: 83 - DNA, 20 bp, Homo sapiens
caaagtcggtggggccagga

SEQ ID NO: 84 - DNA, 20 bp, Homo sapiens
acctggaggactgaatgctg

SEQ ID NO: 85 - DNA, 20 bp, Homo sapiens
gagggaggcgatcacgttgc

SEQ ID NO: 86 - DNA, 20 bp, Homo sapiens
ggtggggctaatgccttcat

SEQ ID NO: 87 - DNA, 21 bp, Homo sapiens
atgttggaggaggtcaggctt

SEQ ID NO: 88 - DNA, 20 bp, Homo sapiens
agggattgagaccccgttct

SEQ ID NO: 89 - DNA, 20 bp, Homo sapiens
ggtagaaaatagattatctc

SEQ ID NO: 90 - DNA, 19 bp, Homo sapiens
gatttgctaagacaagctg

SEQ ID NO: 91 - DNA, 27 bp, Homo sapiens
tcctctgcaaaaatgtgagaagggacc

SEQ ID NO: 92 - DNA, 22 bp, Homo sapiens
cagcaaagcaactggcagattc

SEQ ID NO: 93 - DNA, 21 bp, Homo sapiens
cagtgacatcaataccctcta

SEQ ID NO: 94 - DNA, 22 bp, Homo sapiens
tttggttcataaggtgttgtcc

SEQ ID NO: 95 - DNA, 22 bp, Homo sapiens
tgagctaacatgcttccttatt

SEQ ID NO: 96 - DNA, 23 bp, Homo sapiens
aaacagtttctcttaagtggtga

SEQ ID NO: 97 - DNA, 24 bp, Homo sapiens
acacattgtttatgctgtctttag

SEQ ID NO: 98 - DNA, 23 bp, Homo sapiens
gcatgaaatagtgtatcagtggt

SEQ ID NO: 99 - DNA, 18 bp, Homo sapiens
ccatgtatggccctggac

SEQ ID NO: 100 - DNA, 25 bp, Homo sapiens
ttcaccaacttatgccaattctctt

SEQ ID NO: 101 - DNA, 29 bp, Homo sapiens
caccatggacagatgtttttaaaactttc

SEQ ID NO: 102 - DNA, 30 bp, Homo sapiens
aagtattgtactgttgtgttctttttaata

SEQ ID NO: 103 - DNA, 26 bp, Homo sapiens
atggaccatctgatcttcatcttcat

SEQ ID NO: 104 - DNA, 30 bp, Homo sapiens
gacttaatatcataagctttagcatgtgta

SEQ ID NO: 105 - DNA, 28 bp, Homo sapiens
agtgtatgtaaaatcttgccttacaatg

SEQ ID NO: 106 - DNA, 28 bp, Homo sapiens
gtctttagagtatcctggctttaaatcc

SEQ ID NO: 107 - DNA, 18 bp, Homo sapiens
caatggcgttacagccac

SEQ ID NO: 108 - DNA, 19 bp, Homo sapiens
ttaaatcacacttacgttg

SEQ ID NO: 109 - DNA, 20 bp, Homo sapiens
tgttaaatcacacttacgtt

SEQ ID NO: 110 - DNA, 20 bp, Homo sapiens
caacgtaagtgtgatttaac

SEQ ID NO: 111 - DNA, 20 bp, Homo sapiens
agaaattcacacttttcttc

SEQ ID NO: 112 - DNA, 20 bp, Homo sapiens
taaggaagaaaagtgtgaat

SEQ ID NO: 113 - DNA, 22 bp, Homo sapiens
taaggaagaaaagtgtgaattt

SEQ ID NO: 114 - DNA, 20 bp, Homo sapiens
tattcaaagcaatgagtatc

SEQ ID NO: 115 - DNA, 20 bp, Homo sapiens
ggatactcattgctttgaat

SEQ ID NO: 116 - DNA, 20 bp, Homo sapiens
gtattcaaagcaatgagtat

SEQ ID NO: 117 - DNA, 20 bp, Homo sapiens
ggacattagtgtagaaatgg

SEQ ID NO: 118 - DNA, 20 bp, Homo sapiens
gtggacattagtgtagaaat

SEQ ID NO: 119 - DNA, 20 bp, Homo sapiens
ccggattgaagtttataaat

SEQ ID NO: 120 - DNA, 21 bp, Homo sapiens
gattgaagtttataaatcctt

SEQ ID NO: 121 - DNA, 22 bp, Homo sapiens
attgaagtttataaatcctttt

SEQ ID NO: 122 - DNA, 23 bp, Homo sapiens
aaaaggatttataaacttcaatc

SEQ ID NO: 123 - DNA, 21 bp, Homo sapiens
attgaagtttataaatccttt

SEQ ID NO: 124 - DNA, 17 bp, Homo sapiens
gagttgcgctagcaaga

SEQ ID NO: 125 - DNA, 20 bp, Homo sapiens
ttggtcttgctagcgcaact

SEQ ID NO: 126 - DNA, 19 bp, Homo sapiens
ggtcttgctagcgcaactc

SEQ ID NO: 127 - DNA, 16 bp, Homo sapiens
gtcttgctagcgcaac

SEQ ID NO: 128 - DNA, 19 bp, Homo sapiens
ctcttcgaatcattgatgt

SEQ ID NO: 129 - DNA, 22 bp, Homo sapiens
tcaatgattcgaagagcttttg

SEQ ID NO: 130 - DNA, 19 bp, Homo sapiens
atcaatgattcgaagagct

SEQ ID NO: 131 - DNA, 21 bp, Homo sapiens
cagaaattcacacttttcttc

SEQ ID NO: 132 - DNA, 21 bp, Homo sapiens
gaagaaaagtgtgaatttctg

SEQ ID NO: 133 - DNA, 21 bp, Homo sapiens
aaattcacacttttcttcctt

SEQ ID NO: 134 - DNA, 21 bp, Homo sapiens
aagtggaacacagagttgcat

SEQ ID NO: 135 - DNA, 19 bp, Homo sapiens
ccaatggcattacagccac

SEQ ID NO: 136 - DNA, 19 bp, Homo sapiens
atggcattacagccaccaa

SEQ ID NO: 137 - DNA, 21 bp, Homo sapiens
ttaaatcacacttatgttgtc

SEQ ID NO: 138 - DNA, 20 bp, Homo sapiens
ttaaatcacacttatgttgt

SEQ ID NO: 139 - DNA, 21 bp, Homo sapiens
caacataagtgtgatttaaca

SEQ ID NO: 140 - DNA, 20 bp, Homo sapiens
cagaaattaacacttttctt

SEQ ID NO: 141 - DNA, 23 bp, Homo sapiens
aggaagaaaagtgttaatttctg

SEQ ID NO: 142 - DNA, 21 bp, Homo sapiens
ctaaggaagaaaagtgttaat

SEQ ID NO: 143 - DNA, 20 bp, Homo sapiens
atactcactgctttgaatac

SEQ ID NO: 144 - DNA, 20 bp, Homo sapiens
gtattcaaagcagtgagtat

SEQ ID NO: 145 - DNA, 21 bp, Homo sapiens
gtggacattaatgtagaaatg

SEQ ID NO: 146 - DNA, 21 bp, Homo sapiens
ccatttctacattaatgtcca

SEQ ID NO: 147 - DNA, 20 bp, Homo sapiens
gccatttctacattaatgtc

SEQ ID NO: 148 - DNA, 20 bp, Homo sapiens
gattgaagtttgtaaatcct

SEQ ID NO: 149 - DNA, 20 bp, Homo sapiens
ggattgaagtttgtaaatcc

SEQ ID NO: 150 - DNA, 21 bp, Homo sapiens
ttgaagtttgtaaatcctttt

SEQ ID NO: 151 - DNA, 20 bp, Homo sapiens
aaaggatttacaaacttcaa

SEQ ID NO: 152 - DNA, 20 bp, Homo sapiens
ttgaagtttgtaaatccttt

SEQ ID NO: 153 - DNA, 17 bp, Homo sapiens
tggagttgtgctagcaa

SEQ ID NO: 154 - DNA, 18 bp, Homo sapiens
gtcttgctagcacaactc

SEQ ID NO: 155 - DNA, 16 bp, Homo sapiens
tggtcttgctagcaca

SEQ ID NO: 156 - DNA, 19 bp, Homo sapiens
tcaatgagtcgaagagctt

SEQ ID NO: 157 - DNA, 21 bp, Homo sapiens
gcagaaattaacacttttctt

SEQ ID NO: 158 - DNA, 22 bp, Homo sapiens
ggaagaaaagtgttaatttctg

SEQ ID NO: 159 - DNA, 22 bp, Homo sapiens
gaagaaaagtgttaatttctgc

SEQ ID NO: 160 - DNA, 22 bp, Homo sapiens
cagaaattaacacttttcttcc

SEQ ID NO: 161 - DNA, 20 bp, Homo sapiens
tggaacgcagagttgcatga

SEQ ID NO: 162 - DNA, 28 bp, Homo sapiens
gtttgcaatacttgtgatgatttaatat

SEQ ID NO: 163 - DNA, 23 bp, Homo sapiens
ttgtctgaaagtcagcctttagt

SEQ ID NO: 164 - DNA, 21 bp, Homo sapiens
gctatgattgatgaagaaatg

SEQ ID NO: 165 - DNA, 20 bp, Homo sapiens
tatgattgatgaagaaatgt

SEQ ID NO: 166 - DNA, 19 bp, Homo sapiens
gctatgattgatgaagaaa

SEQ ID NO: 167 - DNA, 25 bp, Homo sapiens
acacatttcttcatcaatcatagcc

SEQ ID NO: 168 - DNA, 21 bp, Homo sapiens
gctatgattgttgaagaaatg

SEQ ID NO: 169 - DNA, 20 bp, Homo sapiens
tatgattgttgaagaaatgt

SEQ ID NO: 170 - DNA, 20 bp, Homo sapiens
ctatgattgttgaagaaatg

SEQ ID NO: 171 - DNA, 23 bp, Homo sapiens
tacacatttcttcaacaatcata

SEQ ID NO: 172 - DNA, 23 bp, Homo sapiens
cacatttcttcaacaatcatagc

SEQ ID NO: 173 - DNA, 18 bp, Homo sapiens
gttgtctggaaagtcagc

SEQ ID NO: 174 - DNA, 17 bp, Homo sapiens
gtctggaaagtcagcct

SEQ ID NO: 175 - DNA, 18 bp, Homo sapiens
tgtctggaaagtcagcct

SEQ ID NO: 176 - DNA, 21 bp, Homo sapiens
gttgtctgaaagtcagccttt

SEQ ID NO: 177 - DNA, 23 bp, Homo sapiens
ggattgaagtttgtaaatccttt

SEQ ID NO: 178 - DNA, 24 bp, Homo sapiens
agctgaacacaaggatcatgattt

SEQ ID NO: 179 - DNA, 25 bp, Homo sapiens
actgttgctatagttgcaccataga

SEQ ID NO: 180 - DNA, 30 bp, Homo sapiens
aaagctacattttgttctttcagtctaatc

SEQ ID NO: 181 - DNA, 30 bp, Homo sapiens
caatgagtgaagacctagttacagtataca

SEQ ID NO: 182 - DNA, 30 bp, Homo sapiens
gctatgagttataagaatttgggatcataa

SEQ ID NO: 183 - DNA, 28 bp, Homo sapiens
aagttgtggtaattaaaacttctttaat

SEQ ID NO: 184 - DNA, 29 bp, Homo sapiens
cttgagcttttctttcttttttatctttc

SEQ ID NO: 185 - DNA, 30 bp, Homo sapiens
agaagggacctcataaaatattgtcatatg

SEQ ID NO: 186 - DNA, 22 bp, Homo sapiens
caaaaccccatccagcttcaaa

SEQ ID NO: 187 - DNA, 23 bp, Homo sapiens
agcctgaactacccctcttttac

SEQ ID NO: 188 - DNA, 25 bp, Homo sapiens
atggaccatctgatcttcatcttca

SEQ ID NO: 189 - DNA, 29 bp, Homo sapiens
tgttttagatggaacttgctaaggaagaa

SEQ ID NO: 190 - DNA, 24 bp, Homo sapiens
ccaaggtccttcattagctcaatc

SEQ ID NO: 191 - DNA, 30 bp, Homo sapiens
aaatatccttggaagagatatttattttct

SEQ ID NO: 192 - DNA, 22 bp, Homo sapiens
atgtcagagtaccccaatcgag

SEQ ID NO: 193 - DNA, 29 bp, Homo sapiens
cattgctatttaaaacaagaattcgtttg

SEQ ID NO: 194 - DNA, 30 bp, Homo sapiens
acccacagataatagagaacaagatcaaat

SEQ ID NO: 195 - DNA, 30 bp, Homo sapiens
ttttgtacctaaaaatgatacgattttatt

SEQ ID NO: 196 - DNA, 29 bp, Homo sapiens
ctaagtgtatgtaaaatcttgccttacaa

SEQ ID NO: 197 - DNA, 27 bp, Homo sapiens
gctgtctttagagtatcctggctttaa

SEQ ID NO: 198 - DNA, 21 bp, Homo sapiens
accttaacacaccggattcac

SEQ ID NO: 199 - DNA, 23 bp, Homo sapiens
gctggacgtagttgtctcatagt

SEQ ID NO: 200 - DNA, 30 bp, Homo sapiens
agtaggcatacttatatagttggcataatt

SEQ ID NO: 201 - DNA, 30 bp, Homo sapiens
agacctagttacagtatacatgaaacaatc

SEQ ID NO: 202 - DNA, 21 bp, Homo sapiens
gggcacaaaactcttgcaaca

SEQ ID NO: 203 - DNA, 30 bp, Homo sapiens
aggagaagacatgttctcaagataaaatag

SEQ ID NO: 204 - DNA, 30 bp, Homo sapiens
ggtttttatgagttcttgagcttttctttc

SEQ ID NO: 205 - DNA, 30 bp, Homo sapiens
acctcataaaatattgtcatatggaaatga

SEQ ID NO: 206 - DNA, 30 bp, Homo sapiens
aggtcttgtcaaatagtttaataagtagta

SEQ ID NO: 207 - DNA, 30 bp, Homo sapiens
agtttttttcattgtaaacagactgttgta

SEQ ID NO: 208 - DNA, 28 bp, Homo sapiens
gcactaaaataacagacaattgcatcac

SEQ ID NO: 209 - DNA, 30 bp, Homo sapiens
cagtgatttacaaaatgcaaataactggta

SEQ ID NO: 210 - DNA, 30 bp, Homo sapiens
tcattagctcaatctcaaaattcactacat

SEQ ID NO: 211 - DNA, 28 bp, Homo sapiens
atccttggaagagatatttattttctac

SEQ ID NO: 212 - DNA, 20 bp, Homo sapiens
accccaatcgagccaaaaag

SEQ ID NO: 213 - DNA, 28 bp, Homo sapiens
caaaattttaaccatgacaattgatttc

SEQ ID NO: 214 - DNA, 29 bp, Homo sapiens
atgaacctggattttcatgataaatcaca

SEQ ID NO: 215 - DNA, 30 bp, Homo sapiens
tttgtacctaaaaatgatacgattttattt

SEQ ID NO: 216 - DNA, 29 bp, Homo sapiens
gaaatagtgtatcagtggtacttacaaag

SEQ ID NO: 217 - DNA, 25 bp, Homo sapiens
gagtatcctggctttaaatcctcga

SEQ ID NO: 218 - DNA, 22 bp, Homo sapiens
accttaacacaccggattcaca

SEQ ID NO: 219 - DNA, 26 bp, Homo sapiens
gtttgcaggctatacagtttgatcca

SEQ ID NO: 220 - DNA, 29 bp, Homo sapiens
ctttcagtctaatcttgttttctgctatg

SEQ ID NO: 221 - DNA, 22 bp, Homo sapiens
aattaacggaacctgataccga

SEQ ID NO: 222 - DNA, 30 bp, Homo sapiens
ctatgagttataagaatttgggatcataaa

SEQ ID NO: 223 - DNA, 30 bp, Homo sapiens
atttggtaacaacaagtctgtataatattt

SEQ ID NO: 224 - DNA, 30 bp, Homo sapiens
agttcttgagcttttctttcttttttatct

SEQ ID NO: 225 - DNA, 30 bp, Homo sapiens
aggagactcaatatctttactctttcatca

SEQ ID NO: 226 - DNA, 23 bp, Homo sapiens
caaaaccccatccagcttcaaaa

SEQ ID NO: 227 - DNA, 25 bp, Homo sapiens
acccctcttttacactcctattgat

SEQ ID NO: 228 - DNA, 26 bp, Homo sapiens
acagcactaaaataacagacaattgc

SEQ ID NO: 229 - DNA, 29 bp, Homo sapiens
atcataagctttagcatgtgtaattcaat

SEQ ID NO: 230 - DNA, 29 bp, Homo sapiens
tgctgttaatctttagtgtagagcttact

SEQ ID NO: 231 - DNA, 30 bp, Homo sapiens
actaatccataaagacatgttacctttttt

SEQ ID NO: 232 - DNA, 20 bp, Homo sapiens
acttatacttgcaggcccag

SEQ ID NO: 233 - DNA, 30 bp, Homo sapiens
cattgctatttaaaacaagaattcgtttga

SEQ ID NO: 234 - DNA, 30 bp, Homo sapiens
gcctatagaagtcatatttaatggtttaac

SEQ ID NO: 235 - DNA, 29 bp, Homo sapiens
attgcttaaaaatgttttgtacctaaaaa

SEQ ID NO: 236 - DNA, 30 bp, Homo sapiens
ctaagtgtatgtaaaatcttgccttacaat

SEQ ID NO: 237 - DNA, 25 bp, Homo sapiens
agagtatcctggctttaaatcctcg

SEQ ID NO: 238 - DNA, 22 bp, Homo sapiens
atcaccttaacacaccggattc

SEQ ID NO: 239 - DNA, 20 bp, Homo sapiens
ctgcccaccataaccgacac

SEQ ID NO: 240 - DNA, 30 bp, Homo sapiens
cttttggggataaaacagtttctcttaagt

SEQ ID NO: 241 - DNA, 23 bp, Homo sapiens
cggaacctgataccgagaagact

SEQ ID NO: 242 - DNA, 28 bp, Homo sapiens
aggaatattgatcagctatgagttataa

SEQ ID NO: 243 - DNA, 26 bp, Homo sapiens
atttgagaaagtaaagttgtggtaat

SEQ ID NO: 244 - DNA, 29 bp, Homo sapiens
tgagcttttctttcttttttatctttcta

SEQ ID NO: 245 - DNA, 28 bp, Homo sapiens
caaaaatgtgagaagggacctcataaaa

SEQ ID NO: 246 - DNA, 21 bp, Homo sapiens
caaaaccccatccagcttcaa

SEQ ID NO: 247 - DNA, 23 bp, Homo sapiens
actcctattgatctggtggacat

SEQ ID NO: 248 - DNA, 26 bp, Homo sapiens
actgtacctttaggatcactcagaac

SEQ ID NO: 249 - DNA, 30 bp, Homo sapiens
ctttagcatgtgtaattcaattagaaatca

SEQ ID NO: 250 - DNA, 28 bp, Homo sapiens
cattagctcaatctcaaaattcactaca

SEQ ID NO: 251 - DNA, 30 bp, Homo sapiens
cctttttttaagattggtcaaagattggtc

SEQ ID NO: 252 - DNA, 22 bp, Homo sapiens
agtaccccaatcgagccaaaaa

SEQ ID NO: 253 - DNA, 24 bp, Homo sapiens
ggcatgactctagaaaggaaagac

SEQ ID NO: 254 - DNA, 25 bp, Homo sapiens
accttgtttgcaatacttgtgatga

SEQ ID NO: 255 - DNA, 30 bp, Homo sapiens
atgttttgtacctaaaaatgatacgatttt

SEQ ID NO: 256 - DNA, 28 bp, Homo sapiens
aatcacggctgtactttaataccttatt

SEQ ID NO: 257 - DNA, 28 bp, Homo sapiens
ctttagagtatcctggctttaaatcctc

SEQ ID NO: 258 - DNA, 29 bp, Homo sapiens
gaacacaaggatcatgattttaaaagatc

SEQ ID NO: 259 - DNA, 25 bp, Homo sapiens
ctatttctgtttgcaggctatacag

SEQ ID NO: 260 - DNA, 26 bp, Homo sapiens
agtggtgaaaaagctacattttgttc

SEQ ID NO: 261 - DNA, 30 bp, Homo sapiens
agttacagtatacatgaaacaatccctaga

SEQ ID NO: 262 - DNA, 23 bp, Homo sapiens
ccaagaaagcacaatgcaagaag

SEQ ID NO: 263 - DNA, 30 bp, Homo sapiens
tgaatgggttttaactatcgtgtcttataa

SEQ ID NO: 264 - DNA, 25 bp, Homo sapiens
acatggcacccatttataacaaagc

SEQ ID NO: 265 - DNA, 29 bp, Homo sapiens
aagggacctcataaaatattgtcatatgg

SEQ ID NO: 266 - DNA, 29 bp, Homo sapiens
atgtgtaatgataggtcttgtcaaatagt

SEQ ID NO: 267 - DNA, 30 bp, Homo sapiens
tttttttcattgtaaacagactgttgtaat

SEQ ID NO: 268 - DNA, 30 bp, Homo sapiens
actagaagaggaaaataaattttaaagtga

SEQ ID NO: 269 - DNA, 30 bp, Homo sapiens
atcataagctttagcatgtgtaattcaatt

SEQ ID NO: 270 - DNA, 29 bp, Homo sapiens
agataggtgtttttttcatttacctttac

SEQ ID NO: 271 - DNA, 30 bp, Homo sapiens
cttgtgtgatatataaatatccttggaaga

SEQ ID NO: 272 - DNA, 20 bp, Homo sapiens
agtaccccaatcgagccaaa

SEQ ID NO: 273 - DNA, 30 bp, Homo sapiens
caagaattcgtttgaaacattaaaaatatg

SEQ ID NO: 274 - DNA, 28 bp, Homo sapiens
aaatctgaatttaccttgtttgcaatac

SEQ ID NO: 275 - DNA, 30 bp, Homo sapiens
gttttgtacctaaaaatgatacgattttat

SEQ ID NO: 276 - DNA, 30 bp, Homo sapiens
gcagtgtaattaaaaatacactttcaaact

SEQ ID NO: 277 - DNA, 21 bp, Homo sapiens
gcctgggtgacaaagtgagag

SEQ ID NO: 278 - DNA, 17 bp, Homo sapiens
catgtatggccctggac

SEQ ID NO: 279 - DNA, 23 bp, Homo sapiens
aacttatgccaattctcttgttt

SEQ ID NO: 280 - DNA, 18 bp, Homo sapiens
agagagaccgtgtctcaa

SEQ ID NO: 281 - DNA, 25 bp, Homo sapiens
tggtacttacaaagcagttcttatc

SEQ ID NO: 282 - DNA, 22 bp, Homo sapiens
gtcctcatgcatatcttgtgtg

SEQ ID NO: 283 - DNA, 18 bp, Homo sapiens
gcttctgcctgatgtagc

(19) United States
(12) Patent Application Publication
(10) Pub. No.: US 2010/0240548 A1
(43) Pub. Date: Sep. 23, 2010

(54) Genotyping Dihydropyrimidine Dehydrogenase Deficiency

(76) Inventors: MORITZ EIDENS, MAINZ (DE); STEFAN PRAUSE, MAINZ (DE); ALEXANDER WEISE, Gensingen (DE); ANDREAS PFUETZNER, MAINZ (DE)

Correspondence Address: MORGAN, LEWIS & BOCKIUS, LLP (SF), ONE MARKET SPEAR STREET TOWER, SAN FRANCISCO, CA, 94105, US

(21) Appl. No.: 12/636,701

(22) Filed: Dec. 11, 2009

Related U.S. Application Data
(60) Provisional application No. 61/121,833, filed on Dec. 11, 2008.

(51) Int. Cl. C40B 30/04; C40B 40/06

(52) U.S. Cl. 506/9; 506/16

(57) ABSTRACT

The invention provides compositions and methods relating to a multiplex test which detects all relevant genetic risk markers associated with DPD deficiency in one single reaction test.

### CROSS-REFERENCE TO RELATED APPLICATIONS

This application claims the benefit under 35 USC 119(e) of U.S. Application 61/121,833, filed Dec. 11, 2008, which is incorporated by reference in its entirety.

### TECHNICAL FIELD

The invention relates to the field of pharmacogenetics and molecular detection.

### BACKGROUND

Pharmacogenetics is the study of clinical testing of genetic variation that gives rise to differing response to drugs, and is increasingly important in the practice of medicine. Pharmacogenetic screening is especially important in oncology, as a small percentage of the patients receiving certain chemotherapeutic agents suffer from adverse drug reactions (ADRs), which may lead to severe toxicities or even death. One prominent example is the intolerance of 5-FU (Fluorouracil), which effect is also known as the pharmacogenetic syndrome “DPD deficiency.” For example, tumor patients who are carriers of the most abundant exon 14 skipping mutation in the DPYD gene are at a significantly higher risk to suffer severe or mortal side effects during chemotherapy with 5-Fluorouracil or related prodrugs such as capecitabine. Similarly, a number of other mutations in the DPYD gene are correlated with or responsible for the occurrence of adverse drug reactions^{[1,2]}

5-Fluorouracil (5-FU) is one of the most widely prescribed chemotherapeutic agents in the treatment of various cancers like colorectal cancer, breast cancer, pancreatic cancer, and head and neck cancer. In the normal case, the 5-FU dose becomes rapidly degraded in the patient's body.

The enzyme dihydropyrimidine dehydrogenase (DPD) is the rate-limiting enzyme in the degradation of pyrimidine bases like thymidine and uracil. DPD enzyme is also the main catalytic part involved in the degradation process of structurally related compounds like 5-Fluorouracil, capecitabine or other prodrugs.

There are >32 known sequence variations in the DPYD gene, which lead to structural aberrations in the enzyme which impair the enzymatic degradation function. The most prevalent and severe one is the exon 14 skipping mutation at position 1 of intron 14 in the DPYD gene. The consequence is a partial or complete deficiency of the DPD enzyme. Affected patients are not capable of degrading the 5-Fluorouracil fast enough or even at all and as a consequence severe or life threatening side effects may occur during the treatment. The problem can occur with homozygous or heterozygous carriers of the respective alleles.

Currently, several technologies are available for the genotyping of the human DPYD. Most important in this context is sequencing and real-time PCR. Sequencing is done according to Sanger's method, by applying fluorescence labelled ddNTPs, which incorporate into the DNA during amplification and thereby stop this reaction. After separation, each different nucleotide can be detected by a special reader using four different fluorophores. Real-time PCR is another method which can be used to detect mutations by means of melting curve analysis. The melting curve is related to fluorescence labelled, sequence specific probes, which melt differently depending on whether the target is a wild-type or a mutated DNA. The change of fluorescence signal can be detected by the real-time measuring instrument. Several protocols have been developed to detect different DPYD genotypes by these methods.

However, genotyping the DPYD in an easy, fast and cost-effective manner remains a challenge in the art. Just a small number of the relevant mutations can be detected quickly and cost-effectively by sequencing and real-time PCR. This small number of detectable alleles is not enough to obtain an accurate picture of the patient's drug metabolism risk profile. Due to the potentially serious consequences of deficiency, in DPD deficiency it is especially important to detect more than just one or two genetic polymorphisms in order to get comprehensive information about a patient's risk profile. No existing method can detect all relevant markers in one reaction in a cost effective manner.

### SUMMARY OF INVENTION

It is aim of this invention to provide a multiplex test which detects all relevant genetic risk markers associated with DPD deficiency in one single reaction test. The composition of the selected markers is unique, as it contributes to a most accurate and comprehensive predictive risk profile for a patient.

With the aim to minimize these risks and to ensure safer therapy, the described set of mutation specific reagents covers genetic mutations which contribute to an increased toxicity risk during 5-FU chemotherapies, for all populations worldwide reported in the medical literature. Thus, a user obtains an exact and reliable medical statement of the patients predicted 5-FU tolerability and the associated risk profile of development of severe toxicities. The speed of the method is more than two fold better than competitive methods. Simple, compact, reasonably priced equipment can be used, facilitating the availability of testing in a larger number of laboratories. Since the macroarray chip is integrated into a common 1.5 mL lab tube, no expensive specialized equipment has to be purchased by the laboratory and lab personnel needs no special training

Furthermore, due to the utilization of a precipitation reaction for detection instead of fluorescence, as is done with the competitive technologies described above, reagents are much lower cost. Moreover, genotyping results can be read out by a cost-effective reader or a microscope, and since detection is principally based on colorimetry, no expensive fluorescence base detection system has to be used.

The specific design of the probes enables the detection of all described alleles in one single chip, while the specialized design of multiple multiplex primer pairs for PCR allows all the mutation detection reactions to be run in one single tube. Thus, the process of genotyping is less difficult and faster than it has ever been.

Accordingly, in one aspect, the invention provides a kit comprising a solid support comprising a capture probe set comprising: (a) an isolated nucleic acid comprising SEQ ID NO: 1 or its complement, (b) an isolated nucleic acid comprising SEQ ID NO: 2 or its complement, (c) an isolated nucleic acid comprising SEQ ID NO: 3 or its complement, (d) an isolated nucleic acid comprising SEQ ID NO: 4 or its complement, (e) an isolated nucleic acid comprising SEQ ID NO: 5 or its complement, (f) an isolated nucleic acid comprising SEQ ID NO: 6 or its complement, (g) an isolated nucleic acid comprising SEQ ID NO: 7 or its complement, (h) an isolated nucleic acid comprising SEQ ID NO: 8 or its complement, (i) an isolated nucleic acid comprising SEQ ID NO: 9 or its complement, (j) an isolated nucleic acid comprising SEQ ID NO: 10 or its complement, (k) an isolated nucleic acid comprising SEQ ID NO: 11 or its complement, (l) an isolated nucleic acid comprising SEQ ID NO: 12 or its complement, (m) an isolated nucleic acid comprising SEQ ID NO: 13 or its complement, (n) an isolated nucleic acid comprising SEQ ID NO: 14 or its complement, (o) an isolated nucleic acid comprising SEQ ID NO: 15 or its complement, (p) an isolated nucleic acid comprising SEQ ID NO: 16 or its complement, (q) an isolated nucleic acid comprising SEQ ID NO: 17 or its complement, (r) an isolated nucleic acid comprising SEQ ID NO: 18 or its complement, (s) an isolated nucleic acid comprising SEQ ID NO: 19 or its complement, (t) an isolated nucleic acid comprising SEQ ID NO: 20 or its complement, (u) an isolated nucleic acid comprising SEQ ID NO: 21 or its complement, (v) an isolated nucleic acid comprising SEQ ID NO: 22 or its complement, (w) an isolated nucleic acid comprising SEQ ID NO: 23 or its complement, (x) an isolated nucleic acid comprising SEQ ID NO: 24 or its complement, (y) an isolated nucleic acid comprising SEQ ID NO: 25 or its complement, (z) an isolated nucleic acid comprising SEQ ID NO: 26 or its complement, (aa) an isolated nucleic acid comprising SEQ ID NO: 27 or its complement, (ab) an isolated nucleic acid comprising SEQ ID NO: 28 or its complement, (ac) an isolated nucleic acid comprising SEQ ID NO: 29 or its complement, (ad) an isolated nucleic acid comprising SEQ ID NO: 30 or its complement, (ae) an isolated nucleic acid comprising SEQ ID NO: 31 or its complement, (af) an isolated nucleic acid comprising SEQ ID NO: 32 or its complement, (ag) an isolated nucleic acid comprising SEQ ID NO: 33 or its complement, (ah) an isolated nucleic acid comprising SEQ ID NO: 34 or its complement, (ai) an isolated nucleic acid comprising SEQ ID NO: 35 or its complement, and (aj) a nucleic acid comprising SEQ ID NO: 36 or its complement, wherein each of the isolated nucleic acids has a length of about 18 to about 50 nucleic acids.

In one embodiment, the capture probe set comprises: (a) an isolated nucleic acid consisting of SEQ ID NO: 1, (b) an isolated nucleic acid consisting of SEQ ID NO: 2, (c) an isolated nucleic acid consisting of SEQ ID NO: 3, (d) an isolated nucleic acid consisting of SEQ ID NO: 4, (e) an isolated nucleic acid consisting of SEQ ID NO: 5, (f) an isolated nucleic acid consisting of SEQ ID NO: 6, (g) an isolated nucleic acid consisting of SEQ ID NO: 7, (h) an isolated nucleic acid consisting of SEQ ID NO: 8, (i) an isolated nucleic acid consisting of SEQ ID NO: 9, (j) an isolated nucleic acid consisting of SEQ ID NO: 10, (k) an isolated nucleic acid consisting of SEQ ID NO: 11, (l) an isolated nucleic acid consisting of SEQ ID NO: 12, (m) an isolated nucleic acid consisting of SEQ ID NO: 13, (n) an isolated nucleic acid consisting of SEQ ID NO: 14, (o) an isolated nucleic acid consisting of SEQ ID NO: 15, (p) an isolated nucleic acid consisting of SEQ ID NO: 16, (q) an isolated nucleic acid consisting of SEQ ID NO: 17, (r) an isolated nucleic acid consisting of SEQ ID NO: 18, (s) an isolated nucleic acid consisting of SEQ ID NO: 19, (t) an isolated nucleic acid consisting of SEQ ID NO: 20, (u) an isolated nucleic acid consisting of SEQ ID NO: 21, (v) an isolated nucleic acid consisting of SEQ ID NO: 22, (w) an isolated nucleic acid consisting of SEQ ID NO: 23, (x) an isolated nucleic acid consisting of SEQ ID NO: 24, (y) an isolated nucleic acid consisting of SEQ ID NO: 25, (z) an isolated nucleic acid consisting of SEQ ID NO: 26, (aa) an isolated nucleic acid consisting of SEQ ID NO: 27, (ab) an isolated nucleic acid consisting of SEQ ID NO: 28, (ac) an isolated nucleic acid consisting of SEQ ID NO: 29, (ad) an isolated nucleic acid consisting of SEQ ID NO: 30, (ae) an isolated nucleic acid consisting of SEQ ID NO: 31, (af) an isolated nucleic acid consisting of SEQ ID NO: 32, (ag) an isolated nucleic acid consisting of SEQ ID NO: 33, (ah) an isolated nucleic acid consisting of SEQ ID NO: 34, (ai) an isolated nucleic acid consisting of SEQ ID NO: 35, and (aj) a nucleic acid consisting of SEQ ID NO: 36.

In one embodiment, the kit further comprises a primer set comprising: (a) an isolated nucleic acid comprising SEQ ID NO: 37 or its complement, (b) an isolated nucleic acid comprising SEQ ID NO: 38 or its complement, (c) an isolated nucleic acid comprising SEQ ID NO: 39 or its complement, (d) an isolated nucleic acid comprising SEQ ID NO: 40 or its complement, (e) an isolated nucleic acid comprising SEQ ID NO: 41 or its complement, (f) an isolated nucleic acid comprising SEQ ID NO: 42 or its complement, (g) an isolated nucleic acid comprising SEQ ID NO: 43 or its complement, (h) an isolated nucleic acid comprising SEQ ID NO: 44 or its complement, (i) an isolated nucleic acid comprising SEQ ID NO: 45 or its complement, (j) an isolated nucleic acid comprising SEQ ID NO: 46 or its complement, (k) an isolated nucleic acid comprising SEQ ID NO: 47 or its complement, (l) an isolated nucleic acid comprising SEQ ID NO: 48 or its complement, (m) an isolated nucleic acid comprising SEQ ID NO: 49 or its complement, (n) an isolated nucleic acid comprising SEQ ID NO: 50 or its complement, (o) an isolated nucleic acid comprising SEQ ID NO: 51 or its complement, and an isolated nucleic acid comprising SEQ ID NO: 52 or its complement, wherein each of the isolated nucleic acids has a length of about 21 to about 50 nucleic acids.

In one embodiment, the primer set comprises: (a) an isolated nucleic acid consisting of SEQ ID NO: 37, (b) an isolated nucleic acid consisting of SEQ ID NO: 38, (c) an isolated nucleic acid consisting of SEQ ID NO: 39, (d) an isolated nucleic acid consisting of SEQ ID NO: 40, (e) an isolated nucleic acid consisting of SEQ ID NO: 41, (f) an isolated nucleic acid consisting of SEQ ID NO: 42, (g) an isolated nucleic acid consisting of SEQ ID NO: 43, (h) an isolated nucleic acid consisting of SEQ ID NO: 44, (i) an isolated nucleic acid consisting of SEQ ID NO: 45, (j) an isolated nucleic acid consisting of SEQ ID NO: 46, (k) an isolated nucleic acid consisting of SEQ ID NO: 47, (l) an isolated nucleic acid consisting of SEQ ID NO: 48, (m) an isolated nucleic acid consisting of SEQ ID NO: 49, (n) an isolated nucleic acid consisting of SEQ ID NO: 50, (o) an isolated nucleic acid consisting of SEQ ID NO: 51 and (p) an isolated nucleic acid consisting of SEQ ID NO: 52.

In one embodiment, at least one of the isolated nucleic acids of the primer set comprises a detectable label.

In one embodiment, the detectable label is biotin.

In one embodiment, the kit further comprises a conjugated enzyme.

In one embodiment, the kit further comprises a precipitating agent.

In one aspect, the invention provides a method of detecting one or more polymorphisms in a nucleic acid comprising the DPYD gene, the method comprising: (a) generating a plurality of amplicons in a sample comprising the nucleic acid, wherein the generating step comprises contacting the sample with the primer set of a kit of the invention and wherein each of the plurality of amplicons comprises a detectable label; (b) contacting the plurality of amplicons with the solid support of a kit of the invention; and (c) detecting the presence or absence of the detectable label, thereby detecting one or more polymorphisms in the nucleic acid

In one embodiment, detecting step comprises contacting the sample with a conjugated enzyme.

In one embodiment, the detecting step comprises contacting the sample with a precipitating agent.

In one aspect, the invention provides a method of determining dihydropyrimidine dehydrogenase genotype in a subject, the method comprising determining whether a nucleic acid in a sample from the subject is characterized by a plurality of DPYD alleles comprising *2A, *3, *4, *5, *6, *7, *8, *10, *12, *13, A551T, M166V and D949V.

In one embodiment, the plurality of DPYD alleles consists of *2A, *3, *4, *5, *6, *7, *8, *10, *12, *13, A551T, M166V and D949V.

In one aspect, the invention provides a kit comprising: a) a capture probe that will hybridize under high stringency conditions to the complement of SEQ ID NO: 1 and contains G at a position corresponding to position 9 of SEQ ID NO: 1; b) a capture probe that will hybridize under high stringency conditions to the complement of SEQ ID NO: 2 and contains A at a position corresponding to position 9 of SEQ ID NO: 2; c) a capture probe that will hybridize under high stringency conditions to the complement of SEQ ID NO: 3 and contains G at a position corresponding to position 7 of SEQ ID NO: 3; d) a capture probe that will hybridize under high stringency conditions to the complement of SEQ ID NO: 4; e) a capture probe that will hybridize under high stringency conditions to the complement of SEQ ID NO: 5; f) a capture probe that will hybridize under high stringency conditions to the complement of SEQ ID NO: 6 and contains C at a position corresponding to position 12 of SEQ ID NO: 6; g) a capture probe that will hybridize under high stringency conditions to the complement of SEQ ID NO: 7 and contains C at a position corresponding to position 10 of SEQ ID NO: 7; h) a capture probe that will hybridize under high stringency conditions to the complement of SEQ ID NO: 8 and contains A at a position corresponding to position 6 of SEQ ID NO: 8; i) a capture probe that will hybridize under high stringency conditions to the complement of SEQ ID NO: 9 and contains T at a position corresponding to position 13 of SEQ ID NO: 9; j) a capture probe that will hybridize under high stringency conditions to the complement of SEQ ID NO: 10 and contains T at a position corresponding to position 15 of SEQ ID NO: 10; k) a capture probe that will hybridize under high stringency conditions to the complement of SEQ ID NO: 11 and contains C at a position corresponding to position 13 of SEQ ID NO: 11; l) a capture probe that will hybridize under high stringency conditions to the complement of SEQ ID NO: 12 and contains G at a position corresponding to position 7 of SEQ ID NO: 12; m) a capture probe that will hybridize under high stringency conditions to the complement of SEQ ID NO: 13 and contains G at a position corresponding to position 7 of SEQ ID NO: 13; n) a capture probe that will hybridize under high stringency conditions to the complement of SEQ ID NO: 14 and contains A at a position corresponding to position 6 of SEQ ID NO: 14; o) a capture probe that will hybridize under high stringency conditions to the complement of SEQ ID NO: 15 and contains ATGA at positions corresponding to positions 17-20 of SEQ ID NO: 15; p) a capture probe that will hybridize under high stringency conditions to the complement of SEQ ID NO: 16; q) a capture probe that will hybridize under high stringency conditions to the complement of SEQ ID NO: 17 and contains G at a position corresponding to position 6 of SEQ ID NO: 17; r) a capture probe that will hybridize under high stringency conditions to the complement of SEQ ID NO: 18 and contains G at a position corresponding to position 6 of SEQ ID NO: 18; s) a capture probe that will hybridize under high stringency conditions to the complement of SEQ ID NO: 19 and contains A at a position corresponding to position 6 of SEQ ID NO: 19; t) a capture probe that will hybridize under high stringency conditions to the complement of SEQ ID NO: 20 and contains C at a position corresponding to position 11 of SEQ ID NO: 20; u) a capture probe that will hybridize under high stringency conditions to the complement of SEQ ID NO: 21 and contains C at a position corresponding to position 13 of SEQ ID NO: 21; v) a capture probe that will hybridize under high stringency conditions to the complement of SEQ ID NO: 22 and contains A at a position corresponding to position 12 of SEQ ID NO: 22; w) a capture probe that will hybridize under high stringency conditions to the complement of SEQ ID NO: 23 and contains A at a position corresponding to position 11 of SEQ ID NO: 23; x) a capture probe that will hybridize under high stringency conditions to the complement of SEQ ID NO: 24 and contains G at a position corresponding to position 14 of SEQ ID NO: 24; y) a capture probe that will hybridize under high stringency conditions to the complement of SEQ ID NO: 25 and contains T at a position corresponding to position 17 of SEQ ID NO: 25; z) a capture probe that will hybridize under high stringency conditions to the complement of SEQ ID NO: 26 and contains A at a position corresponding to position 8 of SEQ ID NO: 26; aa) a capture probe that will hybridize under high stringency conditions to the complement of SEQ ID NO: 27 and contains G at a position corresponding to position 6 of SEQ ID NO: 27; ab) a capture probe that will hybridize under high stringency conditions to the complement of SEQ ID NO: 28 and contains C at a position corresponding to position 8 of SEQ ID NO: 28; ac) a capture probe that will hybridize under high stringency conditions to the complement of SEQ ID NO: 29 and contains G at a position corresponding to position 14 of SEQ ID NO: 29; ad) a capture probe that will hybridize under high stringency conditions to the complement of SEQ ID NO: 30 and contains G at a position corresponding to position 16 of SEQ ID NO: 30; ae) a capture probe that will hybridize under high stringency conditions to the complement of SEQ ID NO: 31 and contains A at a position corresponding to position 14 of SEQ ID NO: 31; af) a capture probe that will hybridize under high stringency conditions to the complement of SEQ ID NO: 32 and contains A at a position corresponding to position 12 of SEQ ID NO: 32; ag) a capture probe that will hybridize under high stringency conditions to the complement of SEQ ID NO: 33 and contains A at a position corresponding to position 12 of SEQ ID NO: 33; ah) a capture probe that will hybridize under high stringency conditions to the complement of SEQ ID NO: 34 and contains G at a position corresponding to position 12 of SEQ ID NO: 34; ai) a capture probe that will hybridize under high stringency conditions to the complement of SEQ ID NO: 35 and contains T at a position corresponding to position 15 of SEQ ID NO: 35; and aj) a capture probe that will hybridize under high stringency conditions to the complement of SEQ ID NO: 36 and contains T at a position corresponding to position 11 of SEQ ID NO: 36.

In one embodiment, each of the capture probes has a length of about 18 to about 50 nucleic acids.

In one embodiment, each of the capture probes has a length of about 18 to about 40 nucleic acids.

In one embodiment, each of the capture probes has a length of about 18 to about 30 nucleic acids.

### BRIEF DESCRIPTION OF DRAWINGS

FIG. 1 shows sequences of probes that are useful for genotyping various DPYD alleles. The underlined nucleic acid corresponds to the nucleic acid at the “interrogation position” of the probe, which is used to determine the nucleic acid at the “detection position” in the DPYD gene or a fragment thereof. These terms are defined herein. As will be understood by those of skill in the art, determining a SNP at a detection position can comprise determining the nucleic acid found in a wild-type allele or the variant allele in either sense or antisense strand. As will also be understood, an interrogation position might not be defined in a probe testing for a deletion mutant.

FIG. 2 shows sequences of primers that are useful for genotyping various DPYD alleles. These primers can be used in four separate PCR reactions as follows and described below: Tube 1: 2A3, M166V, D949V (and 12, not shown in this table); Tube 2: 6, 8, Multi; Tube 3: 7; Tube 4: 10.

FIGS. 3A-3L show additional probes and primers that are useful for genotyping various DPYD alleles.

FIG. 4 shows a schematic for sample merging and dilution.

FIG. 5 shows how to interpret genotype results using a risk classification into 4 different groups. Each detected variant has a number. The higher the number, the higher the resulting risk. For example a patient with *1/*2A and *1/D949V has the values 4+4, resulting in the highest risk group.

FIGS. 6A-6F show images of three different chips tested. FIG. 6A shows one type of chip, FIGS. 6B and 6C show another type and FIG. 6D-6F show a third.

FIGS. 7A-7G show data collected for each of the three different types of chips.

### DESCRIPTION OF EMBODIMENTS

### I. Overview

The present invention provides compositions and methods for detecting the presence or absence of single nucleotide polymorphisms (SNPs; either alone or in any combination) in a dihydropyrimidine dehydrogenase (DPYD or DPD) gene. The investigated variations are connected to a decrease in (or absence of) DPD enzyme activity, which in turn leads to an increased risk for severe side effects and toxicities during a 5-Fluorouracil (5-FU) containing chemotherapy. 5-FU is a cytostatic drug that is routinely used for the treatment of many solid tumours.

Next to age, gender and environmental influences such like diet and co-medication, there are genetic factors that have a major impact on the catalytic activity of many enzymes. It is known that patients with decreased or totally absent function of the DPYD enzyme are at a higher risk to develop severe to lethal side effects upon chemotherapy with 5-Fluorouracil. Those risks range between grades 3-4 according to the WHO.

Analysis of the DPYD gene can help to reduce the risk of 5-FU related toxicities by anticipating the catalytic function of the DPYD enzyme for each individual patient. With this assay, patients bearing variants leading to a decreased enzyme activity can be identified prior to therapy initiation and can be treated accordingly with lower doses or alternative medications if applicable. Of all patients bearing one of the variants and treated with 5-FU, more than 40% will experience severe side effects.

As many cases of 5-FU related side effects can be explained by mutations in the DPYD gene, genotyping of those variants can help to optimize and individualize chemotherapies to prevent undesired effects and lower the costs that emerge from prolonged hospitalization and the treatment of adverse reactions.

No test exists which predicts the risk for the occurrence of severe side effects during a 5-FU chemotherapy in the way covered by the panel of SNPs in this invention.

The combinations of SNPs probed by the invention include the most clinically relevant mutations that are highly predictive for DPD deficiency in a subject, including, but not limited to, *2A, *3, *4, *5, *6, *7, *8, *10, *12, *13, A551T, M166V and D949V, all of which are described in further detail below. Other SNPs can be detected, such as *9A. The set used in the present invention can optionally include or exclude any of these SNPs. Thus, by probing for the presence of the various combinations of SNPs described herein, the practitioner can determine the degree of DPD deficiency in a subject and hence the subject's ability to tolerate certain chemotherapeutic drugs, such as 5-fluorouracil, which are metabolized by DPD.

The relevant SNPs are detected through multiplex methods of the invention that allow for the fast, easy and cost-effective determination of genetic mutations. A number of probes (referred to as “capture probes”, as described below) and primers have been specially developed for this purpose and are described herein. Generally, the capture probes of the invention are attached to a solid support, to form an array. Capture probes are designed to bind to the area of the sequence containing the SNP location: in general, one capture probe is bound at a first location on the array which selectively binds to the target sequence containing the wild-type allele with a second capture probe at a second location that selectively binds to a target sequence containing a variant allele. (In some cases, there may be additional capture probes to the same SNP if there are either different wild-type alleles or different variants).

The primers of the invention are used in amplification reactions to generate amplicons corresponding to portions of the DPD gene containing a position at which a SNP potentially occurs. As is more fully outlined below, the target sequence (e.g. the amplicon) comprises a position for which sequence information is desired, generally referred to herein as the “detection position”. As used herein, the base in the capture probe which basepairs with the detection position base in a hybrid is termed the “interrogation position”.

The amplicons comprise a detectable label, which is generally added in one of two ways: either by pre-labeling the primers, resulting in labeled amplicons, or, in the case where PCR is used, by including labeled dNTPs during the amplification reaction; in either case, the resulting amplicon has a label. This label can be a direct or indirect label as more fully outlined below. In some embodiments, the indirect label is biotin, and a secondary label comprising a streptavidin-enzyme conjugate is added, such as a horseradish peroxidase conjugate, which binds to the detectable label and generates a visible precipitate upon addition of a precipitating agent. The solid supports, primers and detection reagents that are useful for detecting the DPD polymorphisms described herein can be conveniently assembled into relatively cost-effective kits.

### II. Samples

Accordingly, the present invention provides compositions and methods for detecting the presence or absence of target nucleic acid sequences, particularly DPYD SNP sequences, in a sample. As will be appreciated by those in the art, the sample solution may comprise any number of things, including, but not limited to, bodily fluids (including, but not limited to, blood, urine, serum, lymph, saliva, anal and vaginal secretions, perspiration and semen, of virtually any organism, with mammalian samples being preferred and human samples being particularly preferred). In an exemplary embodiment, the sample comprises blood, such as whole blood.

If required, the target sequence is prepared using known techniques. For example, the sample may be treated to lyse the cells, using known lysis buffers, electroporation, etc., with purification and/or amplification as needed, as will be appreciated by those in the art. Suitable amplification techniques can be done, with PCR finding particular use in the invention as described herein.

### III. Kits

Accordingly, the invention provides kits useful for detecting the presence or absence of nucleic acids in a sample. The term “nucleic acid”, “oligonucleotide” or “polynucleotide” herein means at least two nucleotides covalently linked together. A nucleic acid of the present invention will generally contain phosphodiester bonds, although in some cases (for example to stabilize the capture probes) the nucleic acids may have alternate backbones as known in the art.

Nucleic acids detected using the kits of may be referred to as “target,” “target nucleic acid” or “target sequence.” A target sequence may be a portion of a gene, a regulatory sequence, genomic DNA, cDNA, RNA including mRNA and rRNA, the complements of any of these and others. In the present case, the target sequence is a section of the DPYD gene.

The target sequence may in some embodiments be a secondary target such as a product of an amplification reaction such as PCR, (e.g. an “amplicon”) etc. In some embodiments, the complement of a target sequence may be usefully detected and can provide the same information as detecting the target sequence. In some cases it is possible to detect the SNP in either the sense or antisense strand, or both: e.g. capture probes can be designed to detect “Watson”, or “Crick”, or both, depending on the assay.

Target sequences may be of any length, with the understanding that longer sequences are more specific. As is outlined more fully below, capture probes are made to hybridize to target sequences to determine the presence or absence of the target sequence in a sample.

As is more fully outlined below, the target sequence comprises a position for which sequence information is desired, generally referred to herein as the “detection position.” In a preferred embodiment, the detection position is a single nucleotide, although in some embodiments, it may comprise a plurality of nucleotides, either contiguous with each other or separated by one or more nucleotides. For example, the SNP referred to as *2A is actually an exon-skipping variant, as more fully described below. In exemplary embodiments, the detection position in a target sequence corresponds to a potential SNP in a DPD gene that results in expression of a variant DPD protein with a reduced capacity to metabolize 5-fluorouracil. As used herein, the base of the capture probe that basepairs with the detection position base in a hybrid is termed the “interrogation position.”

The kits of the invention comprise a solid support. The term “solid support” or “substrate” refers to any material that can be modified to contain discrete individual sites appropriate for the attachment or association of a capture probe, described below. Suitable substrates include metal surfaces such as gold, electrodes, glass and modified or functionalized glass, plastics (including acrylics, polystyrene and copolymers of styrene and other materials, polypropylene, polyethylene, polybutylene, polycarbonate, polyurethanes, Teflon, derivatives thereof, etc.), polysaccharides, nylon or nitrocellulose, resins, mica, silica or silica-based materials including silicon and modified silicon, carbon, metals, inorganic glasses, fiberglass, ceramics, GETEK (a blend of polypropylene oxide and fiberglass) and a variety of other polymers. Solid supports of particular use in the present invention include those provided by ClonDiag.

Thus, in exemplary embodiments, a ClonDiag™ chip platform is used for the colorimetric detection of biomarkers. In various embodiments, a ClonDiag™ ArrayTube (AT) is used. One unique feature of the ArrayTube is the combination of a micro probe array (the biochip) and micro reaction vial. In various embodiments, where a target sequence is a nucleic acid, detection of the target sequence is done by amplifying and biotinylating the target sequence contained in a sample and optionally digesting the amplification products. The amplification product (amplicon) is then allowed to hybridize with capture probes contained on the ClogDiag™ chip and described below. A solution of a streptavidin-enzyme conjugate, such as Poly horseradish peroxidase (HRP) conjugate solution, is contacted with the ClogDiag™ chip. After washing, a dye solution such as o-dianisidine substrate solution is contacted with the chip. Oxidation of the dye results in precipitation that can be detected colorimetrically. Further description of the ClogDiag™ platform is found in Monecke S, Slickers P, Hotzel H et al., Clin Microbiol Infect 2006, 12: 718-728; Monecke S, Berger-Bächi B, Coombs C et al., Clin Microbiol Infect 2007, 13: 236-249; Monecke S, Leube I and Ehricht R, Genome Lett 2003, 2: 106-118; German Patent DE 10201463; US Publication US/2005/0064469 and ClonDiag, ArrayTube (AT) Experiment Guideline for DNA-Based Applications, version 1.2, 2007, all incorporated by reference in their entirety. Use of the ClogDiag™ platform for genotyping is described in Sachse K et al., BMC Microbiology 2008, 8: 63; Monecke S and Ehricht R, Clin Microbiol Infect 2005, 11: 825-833; and Monecke S et al., Clin Microbiol Infect 2008, 14(6): 534-545. One of skill in the art will appreciate that numerous other dyes that react with a peroxidase can be utilized to produce a colorimetric change, such as 3,3′,5,5′-tetramethylbenzidine (TMB). For information on specific assay protocols, see www.clondiag.com/technologies/publications.php. Such dyes may be referred to as a precipitating agent herein.

If solid supports other than the ClonDiag platform are used, attachment and/or immobilization of the capture probes is done as is known in the art.

The invention provides numerous kits for genotyping the DPYD gene. Kits can be used for performing any of the methods disclosed herein for a number of medical (including diagnostic and therapeutic), industrial, forensic and research applications. Kits may comprise a portable carrier, such as a box, carton, tube or the like, having in close confinement therein one or more containers, such as vials, tubes, ampoules, bottles, pouches, envelopes and the like. In various embodiments, a kit comprises one or more components selected from one or more media or media ingredients and reagents for the measurement of the various target species disclosed herein. For example, kits of the invention may also comprise, in the same or different containers, in any combination, one or more DNA polymerases, one or more primers, one or more probes, one or more binding ligands, one or more suitable buffers, one or more nucleotides (such as deoxynucleoside triphosphates (dNTPs) and preferably labeled dNTPs, such as biotin labeled dNTPs), one or more detectable labels and markers and one or more solid supports, any of which is described herein. The components may be contained within the same container, or may be in separate containers to be admixed prior to use. The kits of the present invention may also comprise one or more instructions or protocols for carrying out the methods of the present invention. The kits may comprise a detector for detecting a signal generated through use of the components of the invention in conjunction with a sample. The kits may also comprise a computer or a component of a computer, such as a computer-readable storage medium or device. Examples of storage media include, without limitation, optical disks such as CD, DVD and Blu-ray Discs (BD); magneto-optical disks; magnetic media such as magnetic tape and internal hard disks and removable disks; semi-conductor memory devices such as EPROM, EEPROM and flash memory; and RAM. The computer-readable storage medium may comprise software for data analysis or for encoding references to the various therapies, treatment regimens, risk classifications and instructions. The software may be interpreted by a computer to provide the practitioner with such information. Generally, any of the methods disclosed herein can comprise using any of the kits (comprising primers, probes, enzymes, labels, ligands, solid supports and other components, in any combination) disclosed herein.

The kits of the invention comprise a solid support comprising a capture probe set. Capture probes sets comprise a plurality of “capture probes,” which are compounds used to detect the presence or absence of, or to quantify, relatively or absolutely, a target species or target sequence. Capture probes that bind directly to a target species may be said to be “selective” for, “specifically bind” or “selectively bind” their target. It should be noted that capture probes are designed to be complementary to either of the strands of the gene, e.g. either the sense or the antisense strand. In most cases, the capture probes of the invention are complementary to the sense strand; that is, assuming the sense strand is referred to as “Watson”, the capture probe would be “Crick”. However, as will be appreciated by those in the art, the situation can be reversed.

Capture probes that “selectively bind” (i.e., are “complementary” or “substantially complementary”) to or are “selective for” a target nucleic acid find use in the present invention. “Complementary” or “substantially complementary” refers to the hybridization or base pairing or the formation of a duplex between nucleotides or nucleic acids, such as, for instance, between the two strands of a double stranded DNA molecule or between an oligonucleotide primer and a primer binding site on a single stranded nucleic acid. Complementary nucleotides are, generally, A and T (or A and U), or C and G. Two single stranded RNA or DNA molecules may be said to be substantially complementary when the nucleotides of one strand, optimally aligned and compared and with appropriate nucleotide insertions or deletions, pair with at least about 80% of the nucleotides of the other strand, usually at least about 90% to 95%, and more preferably from about 98 to 100%. Alternatively, substantial complementarity exists when an RNA or DNA strand will hybridize under selective hybridization conditions (for example, stringent conditions as known in the art) to its complement. Typically, selective hybridization will occur when there is at least about 65% complementary over a stretch of at least 14 to 25 nucleotides, preferably at least about 75%, more preferably at least about 90% complementary. See, M. Kanehisa, Nucleic Acids Res., 2004, 12: 203.

“Duplex” means at least two oligonucleotides and/or polynucleotides that are fully or partially complementary undergo Watson-Crick type base pairing among all or most of their nucleotides so that a stable complex is formed. The terms “annealing” and “hybridization” are used interchangeably to mean the formation of a stable duplex. In one embodiment, stable duplex means that a duplex structure is not destroyed by a stringent wash, e.g. conditions including temperature of about 5° C. less than the Tₘ of a strand of the duplex and low monovalent salt concentration, e.g. less than 0.2 M, or less than 0.1 M. “Perfectly matched” in reference to a duplex means that the poly- or oligonucleotide strands making up the duplex form a double stranded structure with one another such that every nucleotide in each strand undergoes Watson-Crick basepairing with a nucleotide in the other strand. The term “duplex” includes the pairing of nucleoside analogs, such as deoxyinosine, nucleosides with 2-aminopurine bases, PNAs, and the like, that may be employed. A “mismatch” in a duplex between two oligonucleotides or polynucleotides means that a pair of nucleotides in the duplex fails to undergo Watson-Crick bonding.

In a preferred embodiment, one or more capture probes are used to identify the base at the detection position. In this embodiment, each different probe comprises a different base at an “interrogation position,” which will differentially hybridize to the detection position of the target sequence. By using different probes, each with a different base at the interrogation position, the identification of the base at the detection position is elucidated. In some embodiments, a capture probe does not comprise an interrogation position. Such embodiments might be useful for detecting deletion mutants. For example, in one embodiment, a capture probe for a wild-type allele comprises an interrogation position, and a capture probe for a deletion mutant of the allele would not comprise the interrogation position.

In one embodiment, all nucleotides outside of the interrogation position in two or more probes are the same; that is, in some embodiments it is preferable to use probes that have all other components equal (e.g. both the length of the probes as well as the non-interrogation bases) to allow good discrimination. In some embodiments, it may be desirable to alter other components, in order to maximize discrimination at the detection position. For example, all nucleotides outside of the interrogation position in two probes may be the same except for one or two nucleic acids added to the end of only one probe.

As a preliminary matter, the strand that gives the most favorable difference for Tₘ differences should be chosen; G/T is chosen over C/A and G/A over C/T mismatches, for example. Similarly, preferred embodiments generally utilize probes that have the interrogation base in the middle region of the probe, rather than towards one of the ends. However, as outlined herein, the shifting of the interrogation position within the probe can be used to maximize discrimination in some embodiments.

For example, in a preferred embodiment, the perfect match/mismatch discrimination of the probes may be enhanced by changing the binding affinities of bases at and near the mismatch position. For example, sequences that have G-C pairs adjacent to the detection position (or within 3 bases) can hinder good discrimination of match/mismatch. By choosing substitutions in these areas, better discrimination is achieved. For example, this may be done to either destabilize the base pairing in the detection position, or preferably to stabilize the base pairing in the detection position while destabilizing the base pairs in the positions adjacent to the detection position. Base substitutions reduce the number of hydrogen bonds to only two or less hydrogen bonds per base pair without disturbing the stacking structure of the double strand in the area. The amount of destabilization will depend on the chemical nature of the substitution, the number of substitutions and the position of the substitutions relative to the detection position. The local strand destabilization has to be balanced against the loss of specificity of the probe. These substitutions can be either naturally occurring or synthetic base analogs as known in the art.

In a preferred embodiment, the discrimination of the capture probes can be altered by altering the length of the probes. For example, as noted above, certain mismatches, such as G/A differences, can be difficult due to the stability of G:T mispairings. By decreasing the standard probe length from 15-25 basepairs to 10-15 basepairs, increased discrimination may be done.

In addition, matching the Tₘs of the different capture probes with their complements allows for good multiplexing; that is, the panel of different SNPs to be evaluated need to tested under one set of conditions, and thus the capture probes are designed accordingly.

Thus, the invention provides capture probes comprising an interrogation position that can be used to identify the nucleotide at a number of detection positions within the DPD gene or fragments thereof. In exemplary embodiments, the nucleotide at a detection position corresponds to a SNP of a DPYD allele.

In one embodiment, a capture probe comprising an interrogation position is perfectly complementary to a DPYD fragment outside of the interrogation position. In these embodiments, the capture probe can be of any length that permits differential hybridization compared to a second capture probe having the same length but a different nucleotide at the interrogation position. In some embodiments, the length of a capture probe can be selected from about 10 to about 60 nucleic acids, about 10 to about 50 nucleic acids, about 15 to about 45 nucleic acids, about 16 to about 30 nucleic acids. In an exemplary embodiment, the length of a capture probe is about 18 to about 30 nucleic acids. What is important is that the set of probes work well together in a multiplex assay as described herein.

Accordingly, the invention provides a capture probe set (e.g. an array comprising a capture probe set, each at a different location), that is used to determine the base at the detection position for the following DPYD SNPs: *2A, *3, *4, *5, *6, *7, *8, *10, *12, *13, A551T, M166V and D949V. As will be appreciated by those in the art, additional capture probes can be included on the chip, including control sequences (e.g. β-actin) or other positive and/or negative control sequences. In some embodiments, only *2A, *3, *4, *5, *6, *7, *8, *10, *12, *13, A551T, M166V and D949V alleles are probed.

Thus, a capture probe set comprises or consists of a plurality of capture probes useful for detecting the following mutations in the DPYD gene.

| | Amino acid | |
|---|---|---|
| Mutation | change | Nucleotide change |
| *2A | exon 14 | IVS14 + 1G > A |
| | skipping | (c.1905 + 1G > A) |
| *3 | frameshift | 1897delC |
| *4 | S534N | 1601G > A |
| *5 | I543V | 1627A > G |
| *6 | V732I | 2194G > A |
| *7 | frameshift | 295_298delTCAT |
| *8 | R235W | 703C > T |
| *9B | D949V | 2846A > T |
| *10 | V995F | 2983G > T |
| *12 | E386Ter | 1156G > T |
| | A551T | 1651G > A |
| | M166V | 496A > G |
| *13 | I560S | 1679T > G |

In some embodiments, a capture probe set comprises or consists of a plurality of capture probes useful for detecting the following mutations in the DPYD gene optionally including the *9A allele (85C>T, C29R).

In some embodiments, a capture probe set includes or excludes a capture probe for detecting the *2A mutation. In some embodiments, a capture probe set includes or excludes a capture probe for detecting the *3 mutation. In some embodiments, a capture probe set includes or excludes a capture probe for detecting the *4 mutation. In some embodiments, a capture probe set includes or excludes a capture probe for detecting the *5 mutation. In some embodiments, a capture probe set includes or excludes a capture probe for detecting the *6 mutation. In some embodiments, a capture probe set includes or excludes a capture probe for detecting the *7 mutation. In some embodiments, a capture probe set includes or excludes a capture probe for detecting the *8 mutation. In some embodiments, a capture probe set includes or excludes a capture probe for detecting the *9B mutation. In some embodiments, a capture probe set includes or excludes a capture probe for detecting the *10 mutation. In some embodiments, a capture probe set includes or excludes a capture probe for detecting the *12 mutation. In some embodiments, a capture probe set includes or excludes a capture probe for detecting the *13 mutation. In some embodiments, a capture probe set includes or excludes a capture probe for detecting the SNP causing an A551T mutation (which SNP is also referred to as A551T). In some embodiments, a capture probe set includes or excludes a capture probe for detecting the SNP causing an M116V mutation (which SNP is also referred to as M116V). Thus, any mutation may be conveniently referred to by the change caused in the expressed protein. (e.g. D949V for *9B).

Any capture probe set disclosed herein can be attached to a solid support for the purposes of the invention.

In one embodiment, capture probes are designed to determine whether a patient has the *2A SNP corresponding to position 476002 of the DPYD gene, RefSeq Accession Record NG_{—}008807.1, hereby incorporated by reference in its entirety. The *2A occurs at the GT 5′ splicing recognition sequence of intron 14, resulting in a 165-bp deletion (corresponding to exon 14) in DPYD mRNA. The *2A SNP also corresponds to interrogation position 9 of SEQ ID NO: 1, which is a C in the wild type sequence (that is, the wild type sequence comprises a C, and the capture probe comprises the complementary base, G, at the interrogation position). The *2A SNP is also assayed by using SEQ ID NO: 2, which corresponds to the variant having a T at the detection position (again, SEQ ID NO: 2 is the complement of the sequence comprising the detection position). Capture probes are designed that target this area, and can be about 10 to about 40 bases long or any other appropriate length described herein in general. In some embodiments, the interrogation position is positioned roughly in the middle of the capture probe.

In some embodiments, SEQ ID NO:1 and SEQ ID NO:2 are used to probe the *2A status of a patient.

In one embodiment, capture probes are designed to determine whether a patient has the *3 SNP, which corresponds to a deletion at position 475993 of the DPYD gene, Accession NG_{—}008807.1, hereby incorporated by reference in its entirety. The *3 SNP also corresponds to interrogation position 7 of SEQ ID NO: 3, which is a G in the wild type sequence (that is, the wild type sequence comprises a G, and the capture probe comprises the complementary base, C, at the interrogation position). The *3 SNP is also assayed by using SEQ ID NO: 4, which detects a deletion variant (again, SEQ ID NO: 4 is the complement of the sequence being detected). The *3 SNP is also assayed by using SEQ ID NO: 5, which detects a deletion variant (again, SEQ ID NO: 5 is the complement of the sequence being detected). Capture probes are designed that target this area, and can be about 10 to about 40 bases long or any other appropriate length described herein in general. In some embodiments, the interrogation position is positioned roughly in the middle of the capture probe.

In some embodiments, SEQ ID NO: 3, SEQ ID NO: 4 and SEQ ID NO: 5 are used to probe the *3 status of a patient.

In one embodiment, capture probes are designed to determine whether a patient has the *4 SNP, which corresponds to position 410195 of the DPYD gene, Accession No. NG_{—}008807.1, hereby incorporated by reference in its entirety. The *4 SNP also corresponds to interrogation position 12 of SEQ ID NO: 6, which is a G in the wild type sequence (that is, the wild type sequence comprises a G, and the capture probe comprises the complementary base, C, at the interrogation position). The *4 SNP also corresponds to interrogation position 10 of SEQ ID NO: 7, which is a G in the wild type sequence (that is, the wild type sequence comprises a G, and the capture probe comprises the complementary base, C, at the interrogation position). The *4 SNP is also assayed by using SEQ ID NO: 8, which corresponds to the variant, having a T at the detection position (again, SEQ ID NO: 8 is the complement of the sequence comprising the detection position). Capture probes are designed that target this area, and can be about 10 to about 40 bases long or any other appropriate length described herein in general. In some embodiments, the interrogation position is positioned roughly in the middle of the capture probe.

In some embodiments, SEQ ID NO: 6, SEQ ID NO: 7 and SEQ ID NO: 8 are used to probe the *4 status of a patient.

In one embodiment, capture probes are designed to determine whether a patient has the *5 SNP, which corresponds to position 410221 of the DPYD gene, Accession No. NG_{—}008807.1, hereby incorporated by reference in its entirety. The *5 SNP also corresponds to interrogation position 13 of SEQ ID NO: 9, which is an A in the wild type sequence (that is, the wild type sequence comprises an A, and the capture probe comprises the complementary base, T, at the interrogation position). The *5 SNP also corresponds to interrogation position 15 of SEQ ID NO: 10, which is an A in the wild type sequence (that is, the wild type sequence comprises an A, and the capture probe comprises the complementary base, T, at the interrogation position). The *5 SNP is also assayed by using SEQ ID NO: 11, which corresponds to the variant, having a G at the detection position (again, SEQ ID NO: 11 is the complement of the sequence comprising the detection position). Capture probes are designed that target this area, and can be about 10 to about 40 bases long or any other appropriate length described herein in general. In some embodiments, the interrogation position is positioned roughly in the middle of the capture probe.

In some embodiments, SEQ ID NO: 9, SEQ ID NO: 10 and SEQ ID NO: 11 are used to probe the *5 status of a patient.

In one embodiment, capture probes are designed to determine whether a patient has the *6 SNP, which corresponds to position 620696 of the DPYD gene, Accession No. NG_{—}008807.1, hereby incorporated by reference in its entirety. The *6 SNP also corresponds to interrogation position 7 of SEQ ID NO:12, which is a C in the wild type sequence (that is, the wild type sequence comprises a C, and the capture probe comprises the complementary base, G, at the interrogation position). The *6 SNP also corresponds to interrogation position 7 of SEQ ID NO:13, which is a C in the wild type sequence (that is, the wild type sequence comprises a C, and the capture probe comprises the complementary base, G, at the interrogation position). The *6 SNP is also assayed by using SEQ ID NO: 14, which corresponds to the variant, having a T at the detection position (again, SEQ ID NO: 14 is the complement of the sequence comprising the detection position). Capture probes are designed that target this area, and can be about 10 to about 40 bases long or any other appropriate length described herein in general. In some embodiments, the interrogation position is positioned roughly in the middle of the capture probe.

In some embodiments, SEQ ID NO: 12, SEQ ID NO: 13 and SEQ ID NO: 14 are used to probe the *6 status of a patient.

In one embodiment, capture probes are designed to determine whether a patient has the *7 SNP, which corresponds to deletions at positions 185642-185645 of the DPYD gene, Accession NG_{—}008807.1, hereby incorporated by reference in its entirety. The *7 SNP also corresponds to interrogation positions 17-20 of SEQ ID NO: 15, which is TACT in the wild type sequence (that is, the wild type sequence comprises TACT, and the capture probe comprises the complementary base, ATGA, at the interrogation position). The *7 SNP is also assayed by using SEQ ID NO: 16, which detects a deletion variant (again, SEQ ID NO: 16 is the complement of the sequence being detected). Capture probes are designed that target this area, and can be about 10 to about 40 bases long or any other appropriate length described herein in general. In some embodiments, the interrogation position is positioned roughly in the middle of the capture probe.

In some embodiments, SEQ ID NO: 15 and SEQ ID NO: 16 are used to probe the *7 status of a patient.

In one embodiment, capture probes are designed to determine whether a patient has the *8 SNP, which corresponds to position 234284 of the DPYD gene, Accession NG_{—}008807.1, hereby incorporated by reference in its entirety. The *8 SNP also corresponds to interrogation position 6 of SEQ ID NO: 17, which is a C in the wild type sequence (that is, the wild type sequence comprises a C, and the capture probe comprises the complementary base, G, at the interrogation position). The *8 SNP also corresponds to interrogation position 6 of SEQ ID NO: 18, which is a C in the wild type sequence (that is, the wild type sequence comprises a C, and the capture probe comprises the complementary base, G, at the interrogation position). The *8 SNP is also assayed by using SEQ ID NO: 19, which corresponds to the variant, having a T at the detection position (again, SEQ ID NO: 19 is the complement of the sequence comprising the detection position). Capture probes are designed that target this area, and can be about 10 to about 40 bases long or any other appropriate length described herein in general. In some embodiments, the interrogation position is positioned roughly in the middle of the capture probe.

In some embodiments, SEQ ID NO: 17, SEQ ID NO: 18 and SEQ ID NO: 19 are used to probe the *8 status of a patient.

In one embodiment, capture probes are designed to determine whether a patient has the *10 SNP, which corresponds to position 846989 of the DPYD gene, Accession NG_{—}008807.1, hereby incorporated by reference in its entirety. The *10 SNP also corresponds to interrogation position 11 of SEQ ID NO: 20, which is a G in the wild type sequence (that is, the wild type sequence comprises a G, and the capture probe comprises the complementary base, C, at the interrogation position). The *10 SNP also corresponds to interrogation position 13 of SEQ ID NO: 21, which is a G in the wild type sequence (that is, the wild type sequence comprises a G, and the capture probe comprises the complementary base, C, at the interrogation position). The *10 SNP is also assayed by using SEQ ID NO: 22, which corresponds to the variant, having a T at the detection position (again, SEQ ID NO: 22 is the complement of the sequence comprising the detection position). The *10 SNP is also assayed by using SEQ ID NO: 23, which corresponds to the variant, having a T at the detection position (again, SEQ ID NO: 23 is the complement of the sequence comprising the detection position). Capture probes are designed that target this area, and can be about 10 to about 40 bases long or any other appropriate length described herein in general. In some embodiments, the interrogation position is positioned roughly in the middle of the capture probe.

In some embodiments, SEQ ID NO: 20, SEQ ID NO: 21, SEQ ID NO: 22 and SEQ ID NO: 23 are used to probe the *10 status of a patient.

In one embodiment, capture probes are designed to determine whether a patient has the *12 SNP, which corresponds to position 352117 of the DPYD gene, Accession NG_{—}008807.1, hereby incorporated by reference in its entirety. The *12 SNP also corresponds to interrogation position 14 of SEQ ID NO: 24, which is a C in the wild type sequence (that is, the wild type sequence comprises a C, and the capture probe comprises the complementary base, G, at the interrogation position). The *12 SNP is also assayed by using SEQ ID NO: 25, which corresponds to the variant, having an A at the detection position (again, SEQ ID NO: 25 is the complement of the sequence comprising the detection position). Capture probes are designed that target this area, and can be about 10 to about 40 bases long or any other appropriate length described herein in general. In some embodiments, the interrogation position is positioned roughly in the middle of the capture probe.

In some embodiments, SEQ ID NO: 24 and SEQ ID NO: 25 are used to probe the *12 status of a patient.

In one embodiment, capture probes are designed to determine whether a patient has the *13 SNP, which corresponds to position 410273 of the DPYD gene, Accession NG_{—}008807.1, hereby incorporated by reference in its entirety. The *13 SNP also corresponds to interrogation position 8 of SEQ ID NO: 26, which is a T in the wild type sequence (that is, the wild type sequence comprises a T, and the capture probe comprises the complementary base, A, at the interrogation position). The *13 SNP is also assayed by using SEQ ID NO: 27, which corresponds to the variant, having a C at the detection position (again, SEQ ID NO: 27 is the complement of the sequence comprising the detection position). The *13 SNP is also assayed by using SEQ ID NO: 28, which corresponds to the variant, having a G at the detection position (again, SEQ ID NO: 28 is the complement of the sequence comprising the detection position). Capture probes are designed that target this area, and can be about 10 to about 40 bases long or any other appropriate length described herein in general. In some embodiments, the interrogation position is positioned roughly in the middle of the capture probe.

In some embodiments, SEQ ID NO: 26, SEQ ID NO: 27 and SEQ ID NO: 28 are used to probe the *13 status of a patient.

In one embodiment, capture probes are designed to determine whether a patient has the A551T SNP, which corresponds to position 410245 of the DPYD gene, Accession NG_{—}008807.1, hereby incorporated by reference in its entirety. The A551T SNP also corresponds to interrogation position 14 of SEQ ID NO: 29, which is a C in the wild type sequence (that is, the wild type sequence comprises a C, and the capture probe comprises the complementary base, G, at the interrogation position). The A551T SNP also corresponds to interrogation position 16 of SEQ ID NO: 30, which is a C in the wild type sequence (that is, the wild type sequence comprises a C, and the capture probe comprises the complementary base, G, at the interrogation position). The A551T SNP is also assayed by using SEQ ID NO: 31, which corresponds to the variant, having a T at the detection position (again, SEQ ID NO: 31 is the complement of the sequence comprising the detection position). Capture probes are designed that target this area, and can be about 10 to about 40 bases long or any other appropriate length described herein in general. In some embodiments, the interrogation position is positioned roughly in the middle of the capture probe.

In some embodiments, SEQ ID NO: 29, SEQ ID NO: 30 and SEQ ID NO: 31 are used to probe the A551T status of a patient.

In one embodiment, capture probes are designed to determine whether a patient has the M166V SNP, which corresponds to position 226525 of the DPYD gene, Accession NG_{—}008807.1, hereby incorporated by reference in its entirety. The D949V SNP also corresponds to interrogation position 12 of SEQ ID NO: 32, which is a T in the wild type sequence (that is, the wild type sequence comprises a T, and the capture probe comprises the complementary base, A, at the interrogation position). The D949V SNP also corresponds to detection position 12 of SEQ ID NO: 33, which is a T in the wild type sequence (that is, the wild type sequence comprises a T, and the capture probe comprises the complementary base, A, at the interrogation position). The M166V SNP is also assayed by using SEQ ID NO: 34, which corresponds to the variant, a C at the detection position (again, SEQ ID NO: 34 is the complement of the sequence comprising the detection position). Capture probes are designed that target this area, and can be about 10 to about 40 bases long or any other appropriate length described herein in general. In some embodiments, the interrogation position is positioned roughly in the middle of the capture probe.

In some embodiments, SEQ ID NO: 32, SEQ ID NO: 33 and SEQ ID NO: 34 are used to probe the M166V status of a patient.

In one embodiment, capture probes are designed to determine whether a patient has the D949V SNP, which corresponds to position 843669 of the DPYD gene, Accession NG_{—}008807.1, hereby incorporated by reference in its entirety. The D949V SNP also corresponds to interrogation position 15 of SEQ ID NO: 35, which is an A in the wild type sequence (that is, the wild type sequence comprises an A, and the capture probe comprises the complementary base, T, at the interrogation position). The D949V SNP is also assayed by using SEQ ID NO: 36, which corresponds to the variant, having an A at the detection position (again, SEQ ID NO: 36 is the complement of the sequence comprising the detection position). Capture probes are designed that target this area, and can be about 10 to about 40 bases long or any other appropriate length described herein in general. In some embodiments, the interrogation position is positioned roughly in the middle of the capture probe.

In some embodiments, SEQ ID NO: 35 and SEQ ID NO: 36 are used to probe the D949V status of a patient.

In some embodiments, the invention provides a capture probe comprising an isolated nucleic acid comprising any one of SEQ ID NOS: 1-36, wherein the isolated nucleic acid has about a length of about 10 to about 50 nucleic acids. Other possible lengths are disclosed herein.

In some embodiments, the solid supports of the invention include the capture probe set of SEQ ID NO: 1-36. In some embodiments, a solid support of the invention comprises or consists of the capture probe set of SEQ ID NOs: 1-36.

In one embodiment, a capture probe comprising an interrogation position is perfectly complementary to a DPYD fragment outside of the interrogation position except for a number of mismatches. In exemplary embodiments, the number of mismatches is selected from 1, 2, 3, 4, 5, 6, 7, 8, 9 or 10 mismatches.

Accordingly, the invention provides a capture probe comprising an isolated nucleic acid comprising a variant of a sequence selected from SEQ ID NOS: 1-36, wherein the isolated nucleic acid is varied at 1, 2, 3, 4, 5, 6, 7, 8, 9 or 10 positions outside of the interrogation position compared to the selected sequence. The invention also provides a capture probe comprising an isolated nucleic acid consisting of a variant of a sequence selected from SEQ ID NOS: 1-36, wherein the isolated nucleic acid is varied at 1, 2, 3, 4, 5, 6, 7, 8, 9 or 10 positions outside of the interrogation position compared to the selected sequence. As will be understood in the art, in one embodiment, a capture probe for detecting a deletion mutant does not comprise an interrogation position, and in that embodiment, the capture probe comprises an isolated nucleic acid consisting of a variant of the sequence wherein the isolated nucleic acid is varied at 1, 2, 3, 4, 5, 6, 7, 8, 9 or 10 positions compared to the selected sequence.

In one embodiment, both a length and a variation, as discussed above, may be applied to any of SEQ ID NO: 1-36 to generate an additional probe that will target the corresponding DPYD allele.

Further probes that may of use in the invention are described in the Figures.

The probes are specifically designed to detect the relevant mutations, as compared with other techniques, e.g. the AmpliChip, which use much larger sets. The AmpliChip carries a set of probes just varying in the position to the mutation, with one set for the wild type and one set for the mutated allele. For genotyping the mean value of all probes is calculated. This approach leads to increased production cost, since a high number of probes have to be used to detect each mutation.

In order to identify the optimal probe for each mutation, a complex experimental evaluation was performed. Thus, fewer probes have to be spotted on the macroarray chip itself and production costs decrease enormously.

To accomplish this, two special multiplex PCR reactions have been developed, one for genomic DNA and one for whole blood samples, both amplifying all required 12 targets in a single reaction and tube.

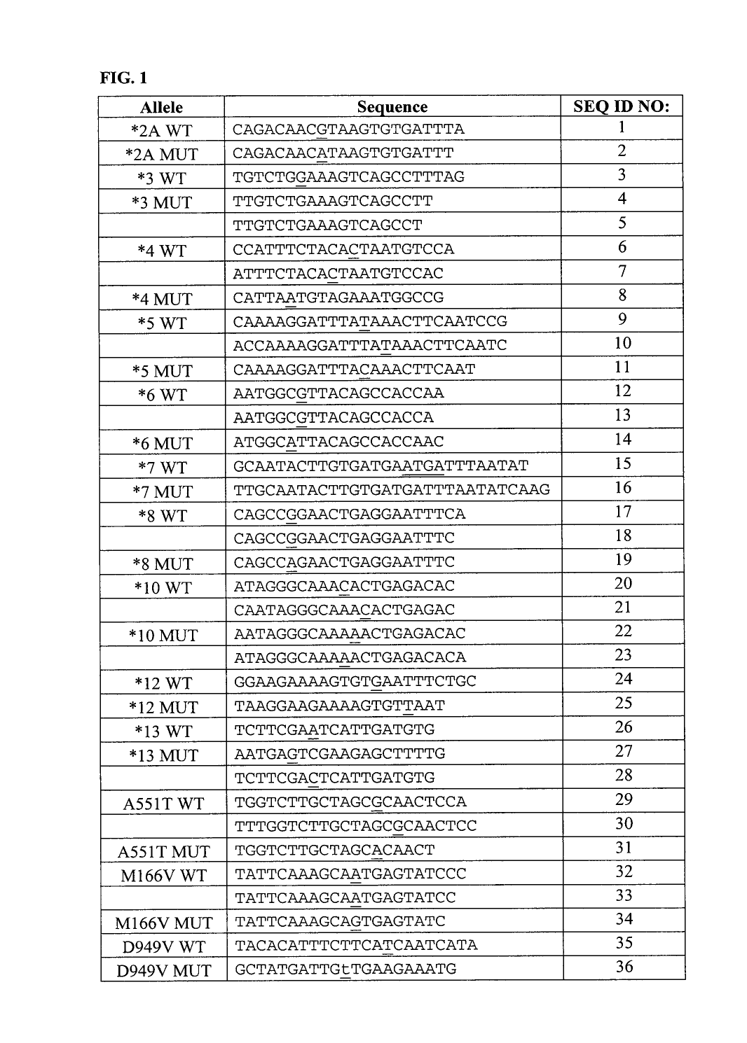

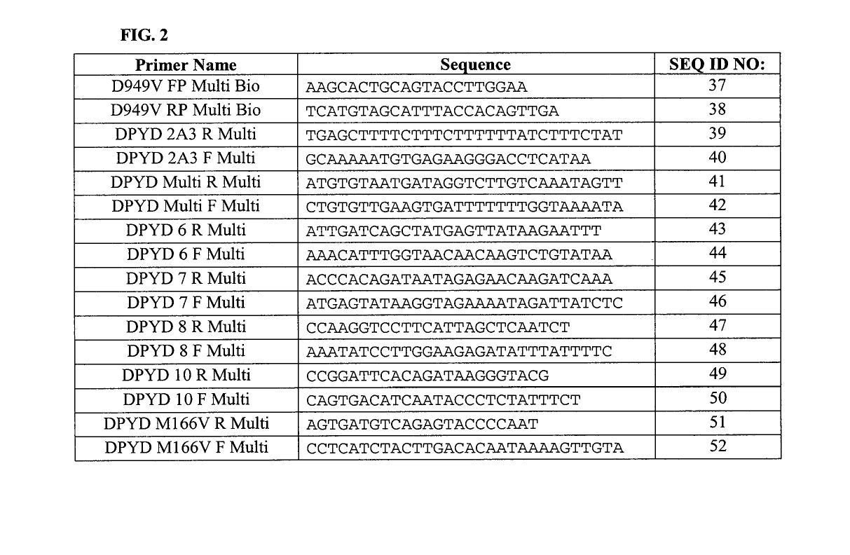

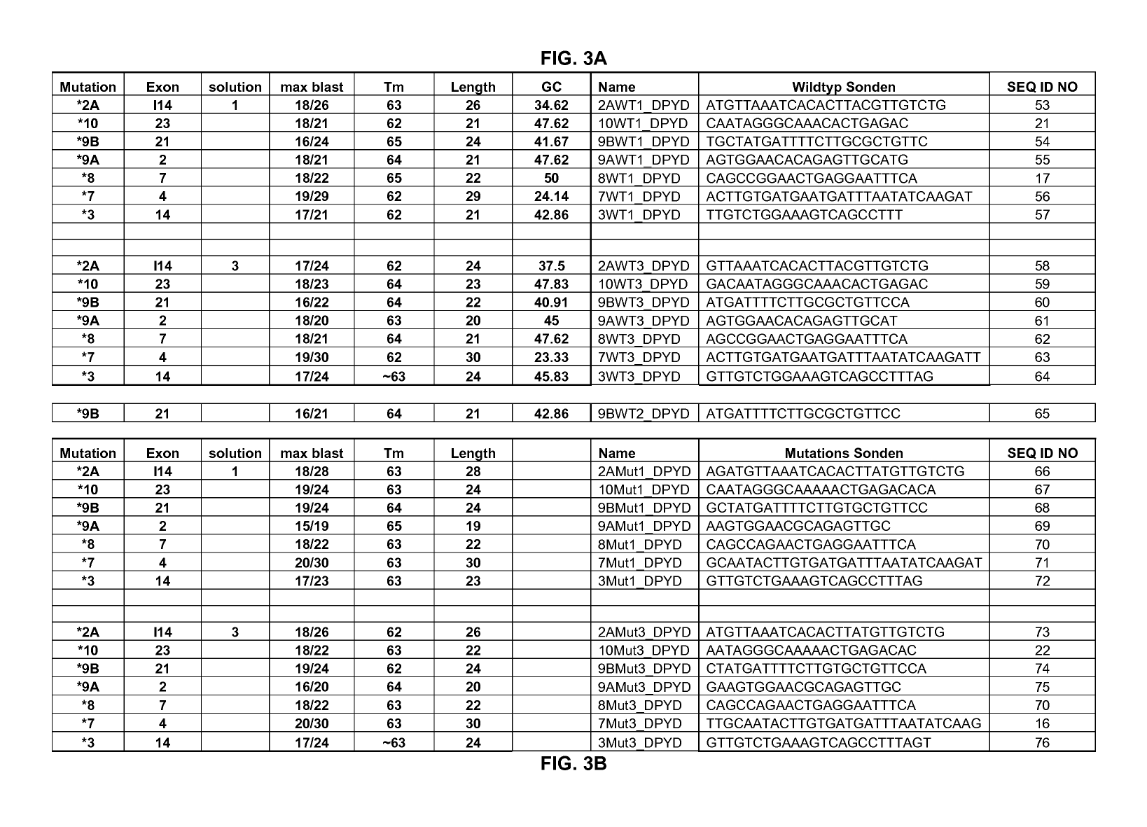

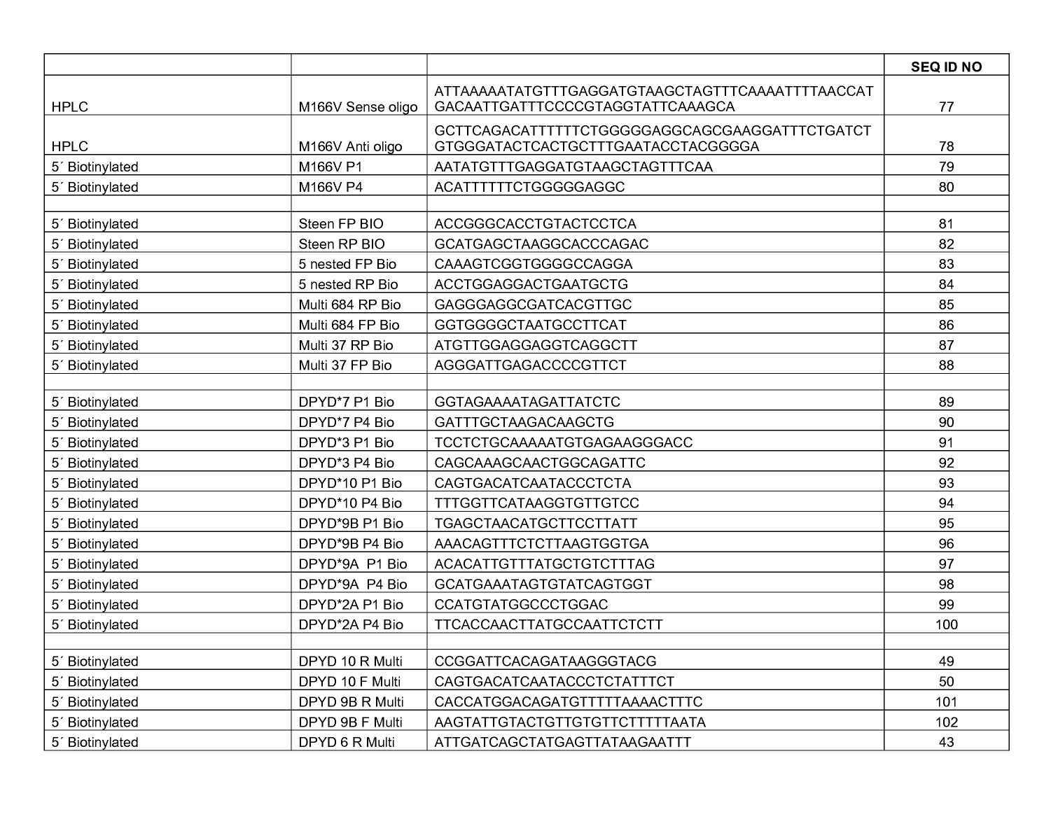

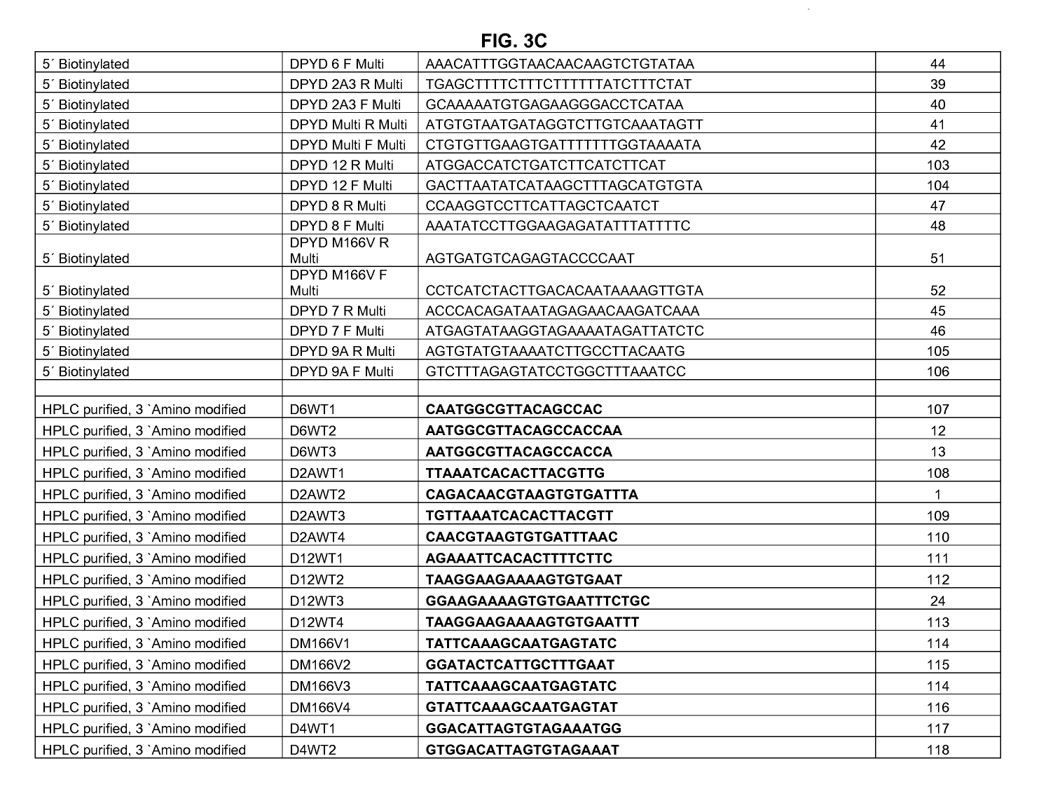

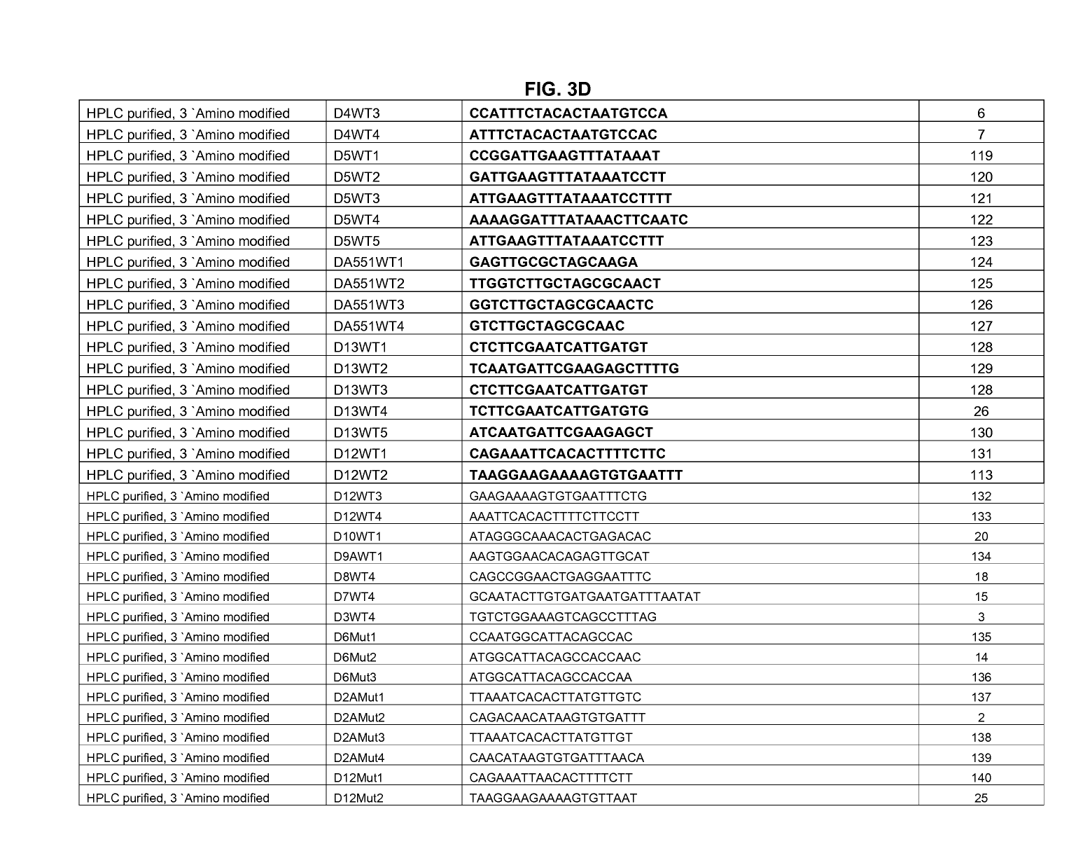

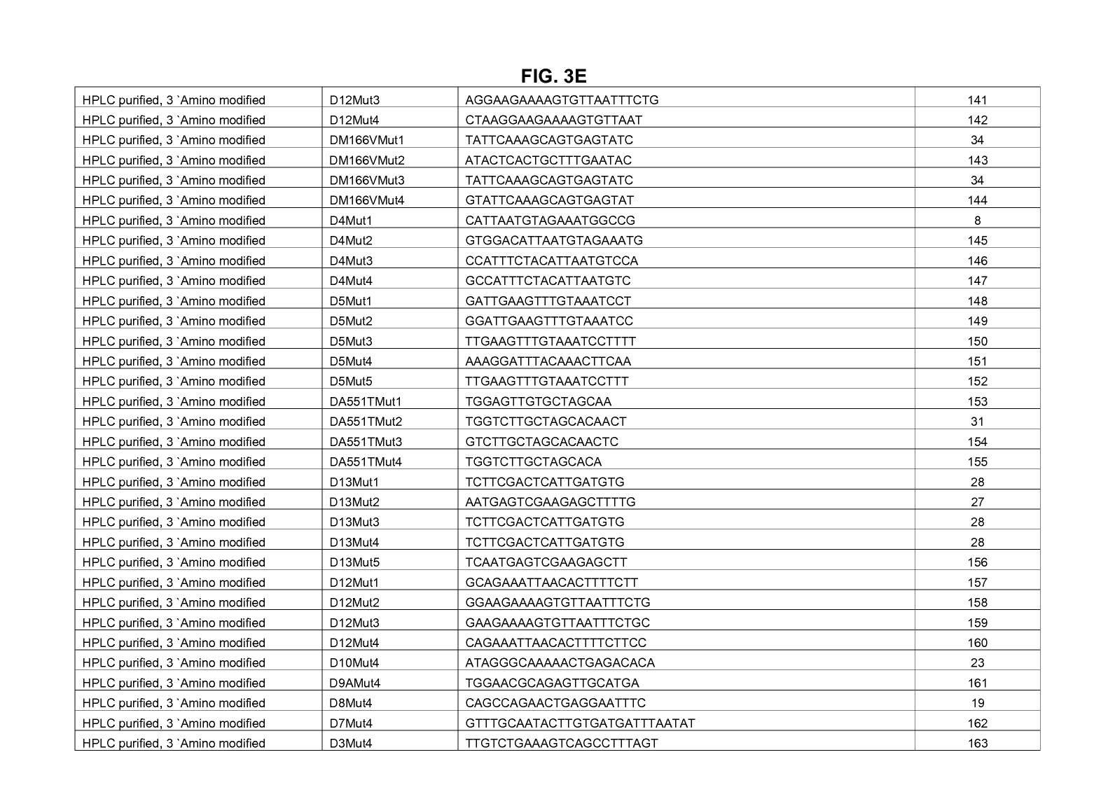

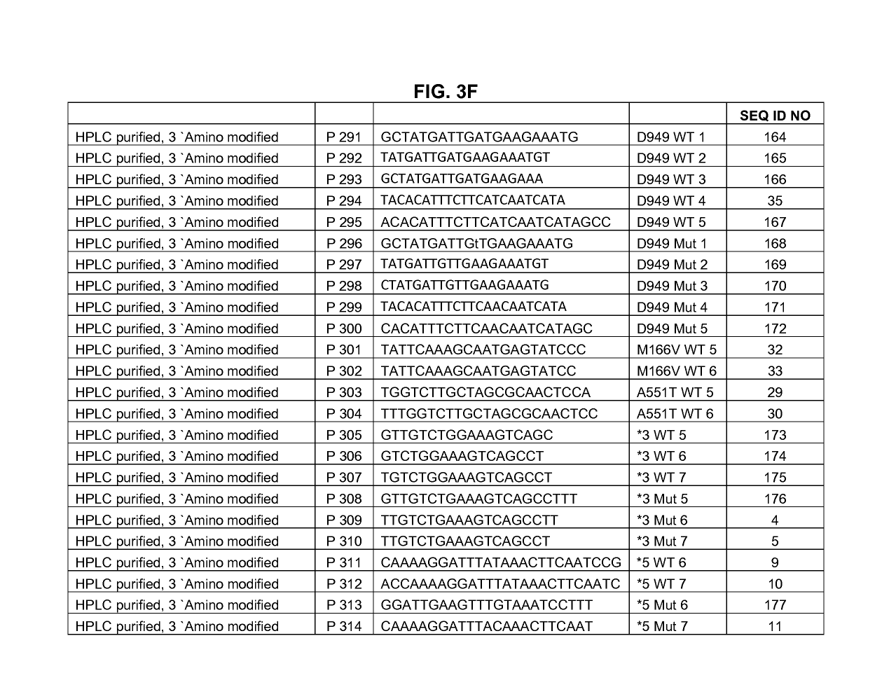

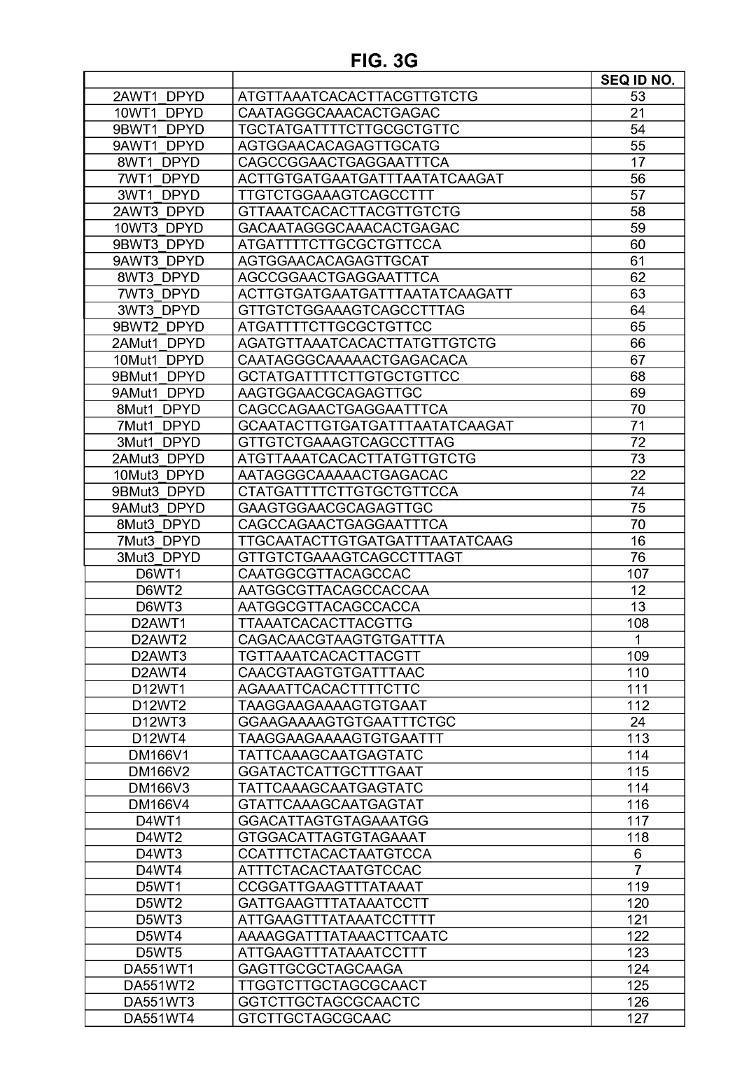

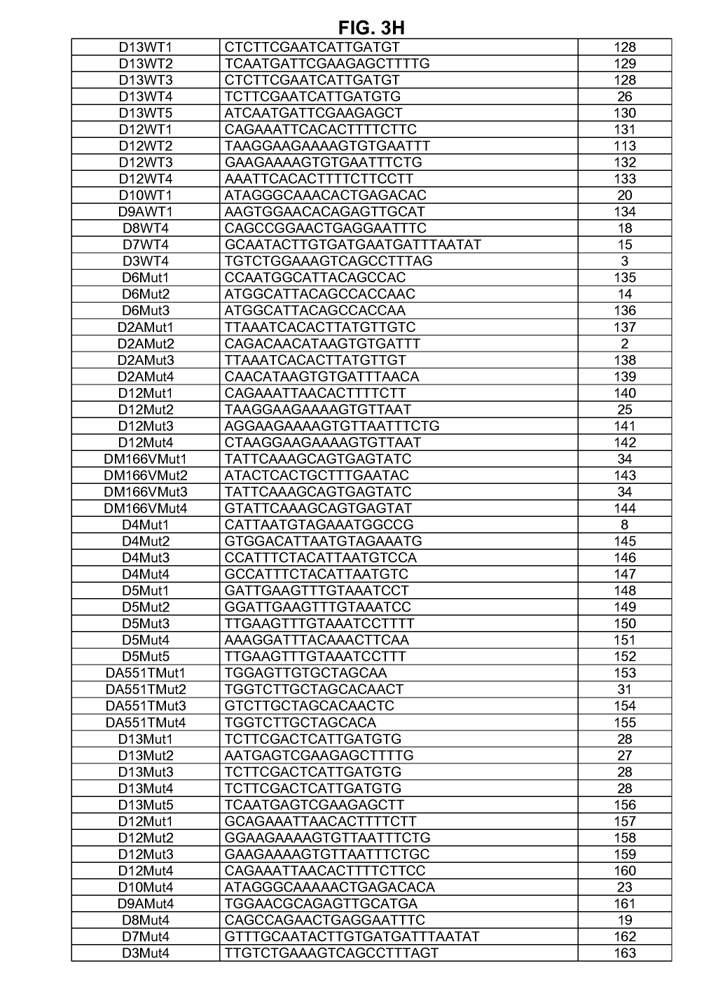

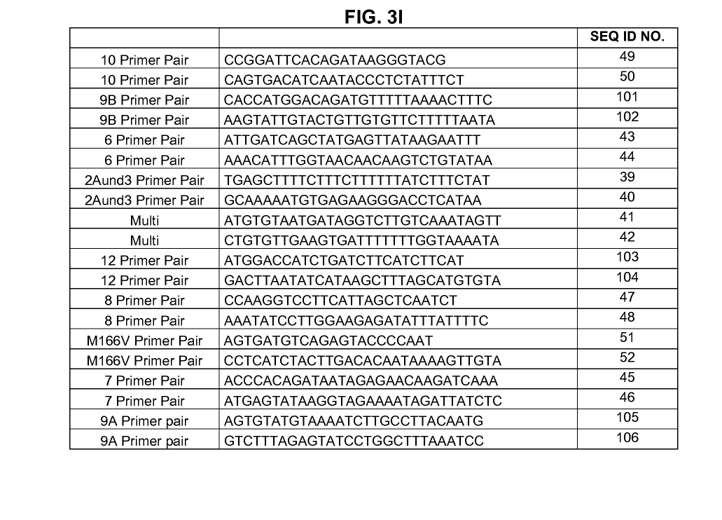

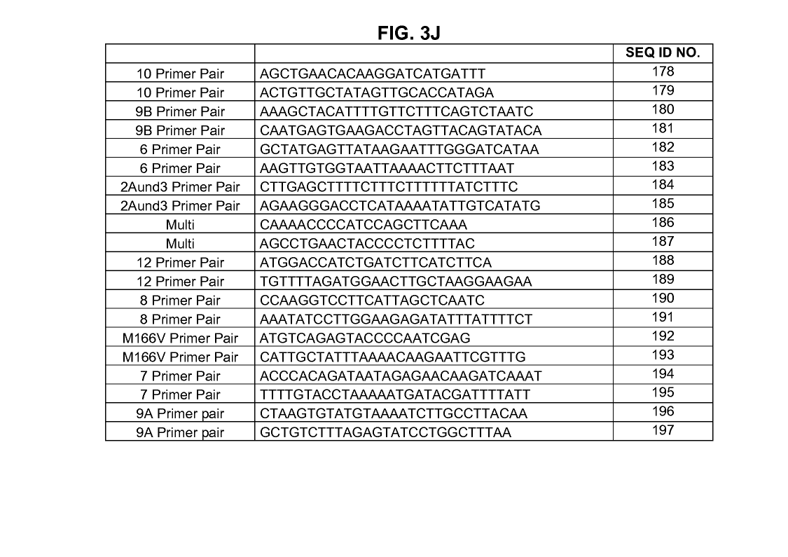

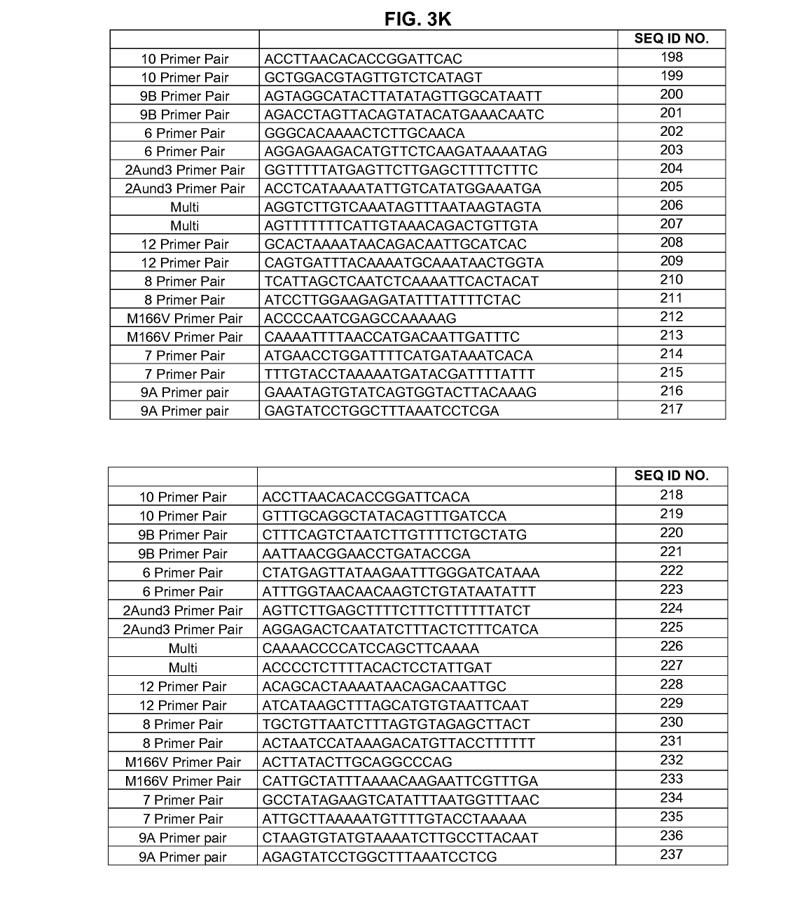

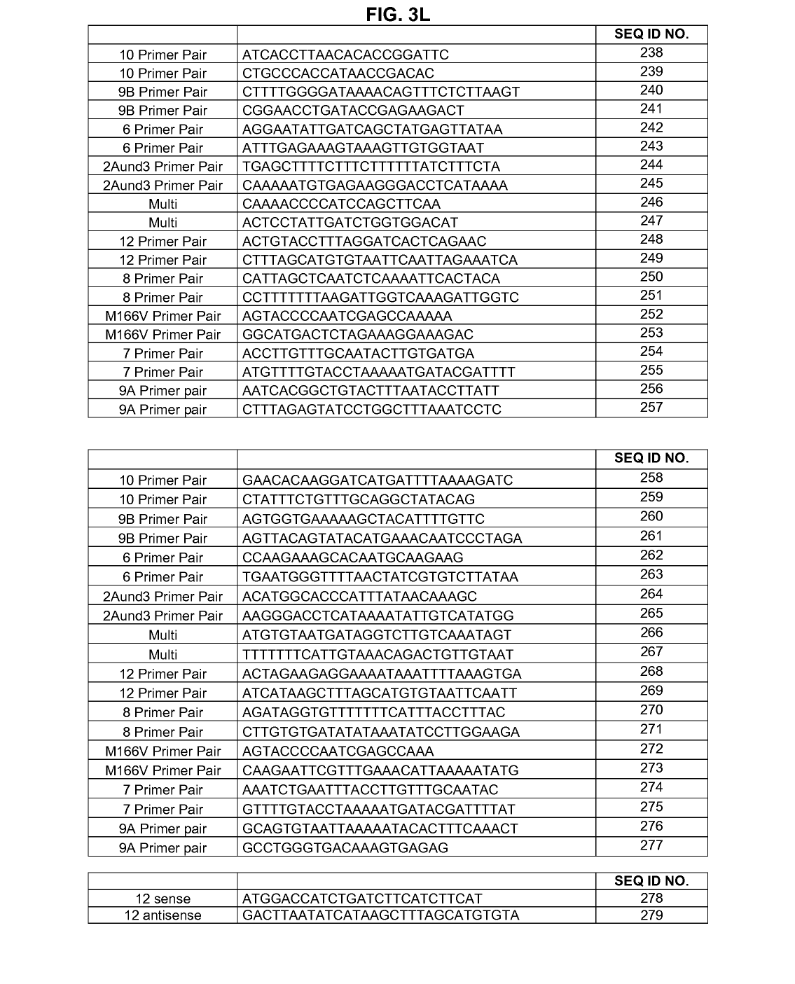

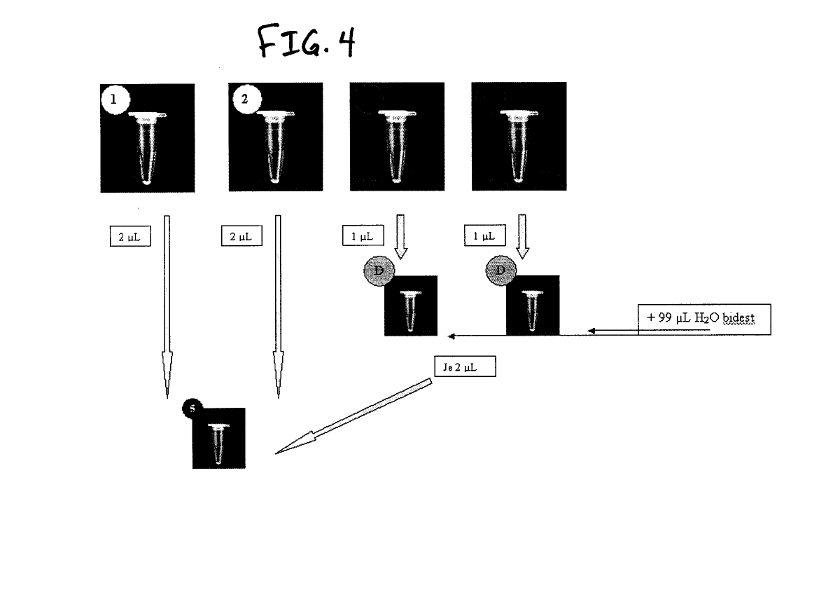

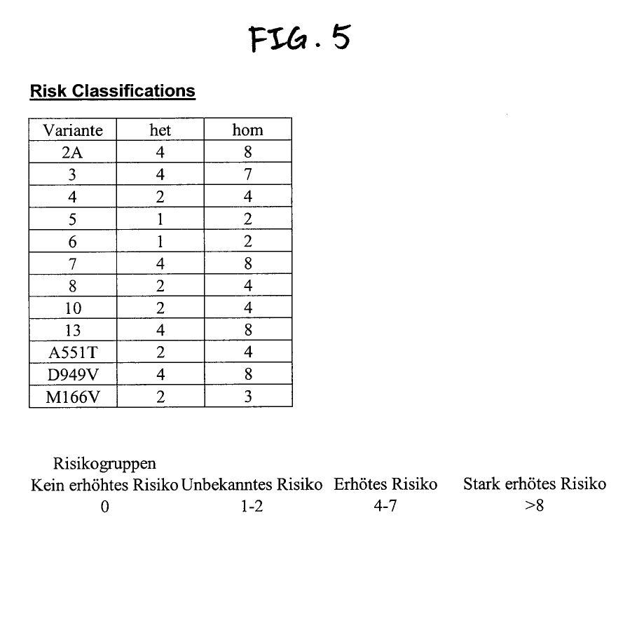

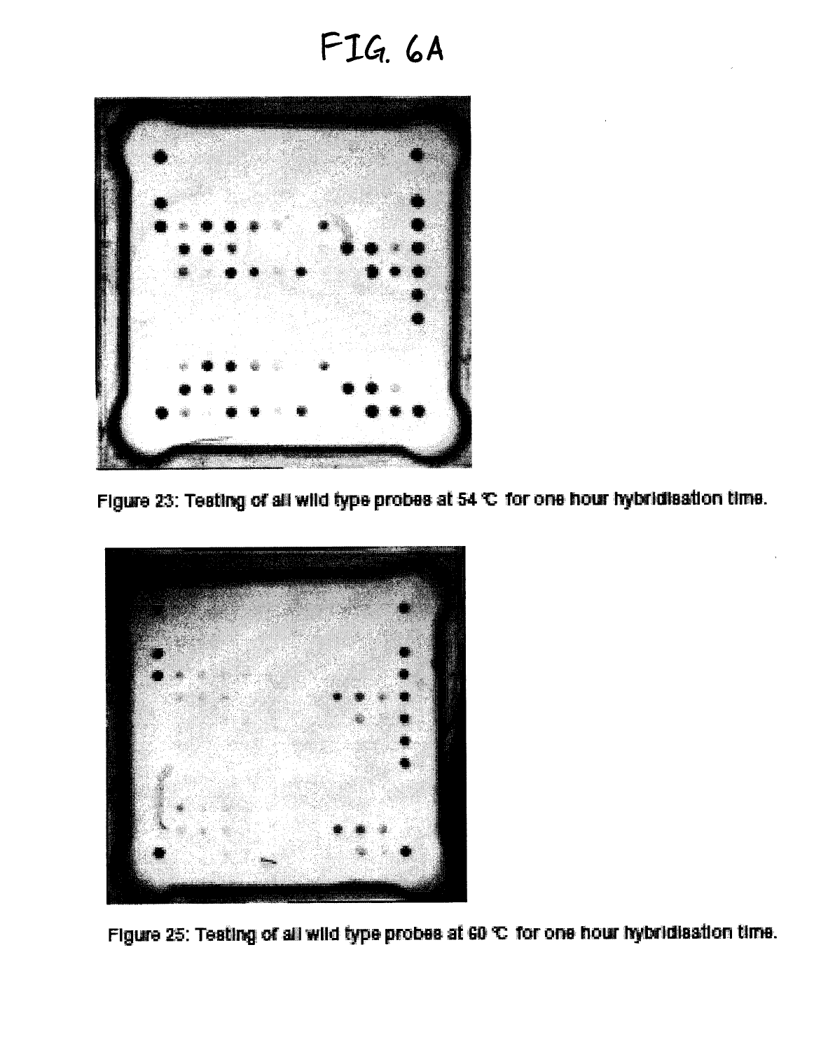

The allele-specific probe pairs used for genotyping the pharmacogenetic syndrome of DPD deficiency is listed in FIG. 1.

In some embodiments, the kits of the invention optionally provide primers that are useful for genotyping the DPYD gene for determine the SNP status of a patient using the capture probe set(s) outlined herein. Thus, the invention provides a primer comprising or consisting of an isolated nucleic acid comprising or consisting of any of SEQ ID NO: 37-52. Additionally, primer sets are provided that include any combination of one or more primer of the invention. Any primer can also be modified to hybridize to the DPYD gene under stringent conditions or other appropriate conditions.

In general, current SNP detection methods utilize a first amplification step such as PCR to amplify sections of the patient's DPYD gene. As will be appreciated by those in the art, the size of the DPYD gene is huge, and thus smaller fragments are amplified to allow more efficient and less expensive processing. In addition, labels are added during the amplification step.

In general, primer pairs are used to amplify relatively short fragments of the DPYD gene which are then used as the target sequences. In some cases, a single amplicon may contain two SNP positions; alternatively, separate amplicons are generated for each SNP location.

As will be appreciated by those in the art, the length of a primer can vary, and generally can be selected from about 10 to about 50, about 15 to about 30 and about 18 to about 22 nucleic acids. In some embodiments, a primer has a length of about 10 to about 30 nucleic acids. In some embodiments, a primer has a length of about 21 to about 50 nucleic acids. In some embodiments, a primer has a length of about 21 to about 40 nucleic acids. In exemplary embodiments, a primer has a length of about 21 to about 30 nucleic acids. A preferred set of primers for use in the present invention is shown in FIG. 2. Any set of primers disclosed herein, including in the figures may also be used.

### Methods

To analyse the mutations a Multiplex-PCR is performed in four reaction tubes that amplify the variable part of the DPYD gene, using genomic DNA as template. The amplification product can be directly transferred to the DNA macroarray and is processed according to the provided protocol. The analysis via precipitation reaction facilitates distinct genotyping of all variants of the DPYD gene that are spotted onto the macroarray. To accomplish the Multiplex-PCR, several pairs of biotin labelled primers are used that flank the regions containing the mutations and generate the desired amplificates.

The amplified product is transferred onto the DNA macroarray, where it binds to the immobilised probes. According to genotype, the amplified DNA will bind either a wildtype or a mutation probe. After this several washing steps using different washing buffers and temperatures are performed, to remove non-perfectly bound fragments (mismatches) from the probes so that only the perfectly bound fragments (perfect matches) remain on the array. Subsequently the enzyme Poly-HRP is added to the DNA macroarray, and forms a complex with the biotin. After addition of the substrate, a blue precipitate will form only in those spots where DNA is still bound to a probe. This precipitate is then detected by the PharmGenomics Reader and the signals are evaluated by the software.

Three different precipitation patterns can be expected corresponding to the respective genotype. Precipitate only in spots where wildtype probes are located demonstrates a homozygous wildtype genotype. The same scheme holds for the mutation probes showing precipitate for a homozygous mutation genotype. Detection of precipitate for wildtype and mutation probes demonstrates a heterozygous genotype for this variant.

### Components

Each test kit contains the following components for the performance of 20 Array Tube assays and an instruction manual.

| Description | Number |
|---|---|
| Primer Master Mix 1-4 | 1 |
| Polymerase Mix | 1 |
| Hybridisation Buffer | 1 |
| Blocking Powder | 1 |
| Blocking Solution | 1 |
| Washing Buffer I-III | 1 |
| Poly-HRP Enzyme | 1 |
| Substrate | 1 |
| Array Tubes | 20 |
| 20x SSPE | 1 |
| Instruction Manual | 1 |

### Materials

Macroarray Analysing Tool (Reader for the DNA-Macroarray) (available from PharmGenomics)
Evaluation software for the DNA-Macroarray (available from PharmGenomics)
Thermocycler for PCR
Thermomixer with cooling function
Tabletop centrifuge
PCR reaction tubes
Pipettes (0.5-500 μL)
sterile filter tips
sterile reaction tubes (0.2 mL)
Gloves (powder free)
PCR water, nuclease free

### Storage and Shelf Life

The Poly-HRP enzyme and the PCR Master Mix have to be stored at −20 ° C. and can be used until the printed date of expiry
Strictly avoid thawing and freezing the Primer Master Mix more than two times. Thawing has to be done at 2-8° C. The date of expiry can be seen on the label of the respective vials
The substrate has to be strictly protected against light exposure and is stored at 4° C.
After unsealing a bag single, unused arrays have to be stored with lids open inside the packaging at room temperature (RT)
After unsealing a bag, the lids of the remaining Array Tubes (AT) have to remain open
The AT have to be stored at a dry and dark place inside the light protective bag. Additionally the AT have to be protected from humidity
To avoid loss of performance, we recommend to use up one bag of Array Tubes within two weeks
The AT have to be protected against direct exposure to sunlight and dust

### Working Conditions of Array Tubes

The maximum working temperature is 60° C.
Never centrifuge the AT
Do not shake the AT
Do not touch the surface of the Macroarray with the pipet
Use only those substances that are mentioned in the protocol

### Considerations and Precautions

The guidelines and principles for working in a bio-molecular laboratory have to be followed.
The PGDx test kit is only to be used for in vitro diagnostics
The test is suitable to be used with genomic DNA extracted from whole blood as starting material
Always use pipetting devices
Do not eat, drink or smoke in the laboratory. Always wear gloves and a lab coat. After performing a test, wash your hands thoroughly. Avoid contact of the substances with the skin, eyes and mucosal membranes. If you get in contact with one of the substances, immediately rinse thoroughly with water.
Avoid contaminations from microorganisms and nucleases, especially when making aliquots
Dispose of unused reagents only according to the local legal requirements
Do not mix reagents from different lots
Do not use the kit and all of its components after the date of expiry
The ATs are:
   for single-use only
   for in vitro diagnostic use only
   to be handled with gloves at all times
Do not let the array dry out!
The workflow has to happen in two separate locations: a pre- and a post-amplification area. All used reagents and devices have to remain in the respective area and are not to be moved out.
The PGDx DPD Kit is designed to be used with the analysis system and software by PharmGenomics
This test has to be performed by specially trained personnel
The rules for Good Laboratory Practice (GLP) have to be followed
When handling human blood samples it has to be kept in mind that this is potentially infectious material
Carefully mix the above mentioned components of the kit by pipetting them up and down before use
Perform all steps in a timely manner
Keep all stock solutions cooled while working
Protect the substrate from light exposure
Always freeze the kit components in an upright position
When handling the AT 0.5 mL pipette tips have to be used, as with those the volumes can be pipetted more precisely
Never touch the reaction surface of the array
Always open the AT with both hands and do not apply pressure to the array
Optimal results can only be assured when using recently isolated DNA

### Sample Collection

The template for PCR amplification is genomic DNA extracted from whole blood. This is best done using a DNA extraction kit (e.g. QIAmp DNA Blood Mini Kit) and should have a concentration of 30 ng/μL. The extracted DNA has to be stored at 2-8° C. or at −20° C. for long term storage. There are no known interferences of genomic DNA with the provided reagents.

### Test Procedure

### PCR Product Generation

Before beginning the assay, all working surfaces and required devices should be decontaminated. All components required for the PCR should be prepared and then the assay is performed using the following protocol. The following concentrations of each amplified sample are optimal to conduct this assay. Note that the DNA concentrations and PCR efficiency can vary between different laboratories.
MM1: 662 (634) ng/μL
MM2: 408 (505) ng/μL
MM3: undiluted 577 ng/μL, after dilution ˜8 ng/μL
MM4: undiluted 534 ng/μL, after dilution ˜4 ng/μL

### Master Mix

The table below shows the composition and pipetting scheme for one analysis of the DPYD gene per 25 μL reaction. To amplify all targets, 4 reaction tubes are needed per assay, one for each Master Mix. All components should be pipetted in the same order as they are listed in the tables. The starting concentration of the DNA should be 30 ng/μL.

Master Mix 1

| Component | Volume per 25 μL reaction |
|---|---|
| DNA (~60 ng) | 2 μL |
| Primer Master Mix 1 | 6 μL |
| PCR H₂O | 4.5 μL |
| Polymerase Mix | 12.5 μL |

Master Mix 2

| Component | Volume per 25 μL reaction |
|---|---|
| DNA (~60 ng) | 2 μL |
| Primer Master Mix 2 | 6 μL |
| PCR H₂O | 4.5 μL |
| Polymerase Mix | 12.5 μL |

Master Mix 3

| Component | Volume per 25 μL reaction |
|---|---|
| DNA (~60 ng) | 2 μL |
| Primer Master Mix 3 | 2 μL |
| PCR H₂O | 8.5 μL |
| Polymerase Mix | 12.5 μL |

Master Mix 4

| Component | Volume per 25 μL reaction |
|---|---|
| DNA (~60 ng) | 2 μL |
| Primer Master Mix 4 | 2 μL |
| PCR H₂O | 8.5 μL |
| Polymerase Mix | 12.5 μL |

The obtained samples are carefully mixed by pipetting up and down, and then placed in the thermocycler and the following PCR program is used.

### PCR Protocol

Usually the PCR protocol has to be established anew for each laboratory, as different thermocyclers have different heating rates. The following standard protocol can be used to start establishing the best parameters for an individual laboratory's process.

| | Temperature [° C.] | Time [sec] |
|---|---|---|
| Start | 95 | 300 |
| Denaturation | 95 | 30* |
| Primer Hybridisation | 51.3 | 30* |
| Elongation | 72 | 50* |
| Finale Elongation | 72 | 420 |
| Pause | 4 | ∞ |

*This PCR program runs over 40 cycles.

### Sample Merging and Dilution

Transfer 2 μL of the amplified samples from Master Mix 1 and 2 into a fresh PCR reaction tube (5).

Then dilute the PCR products from Master Mix 3 and 4 each 1:100. For this use 1 μL of each sample and mix it with 99 μL PCR water (nuclease free) in a fresh PCR reaction tube. Transfer 2 μL of each of these dilutions into a reaction tube (5). See FIG. 100 for a representation of this procedure.

### Array Tube Protocol

### Preparation of Array Tubes

If the hybridisation buffer is turbid or a precipitate can be seen, it can be heated up in a microwave for several seconds (240 W) or in a water bath. Gently shake the buffer until it gets clear to homogenise it again. Before use it has to be cooled down to room temperature (RT).
Wash the Array Tube with 500 μL PCR H₂O at 550 rpm and RT for 5 minutes
Carefully remove the water without touching the reaction surface which has the spots!
Wash the Array Tube with 500 μL hybridisation buffer at 550 rpm and RT for 5 minutes
Carefully remove the buffer without touching the reaction surface!
During the washing steps the DNA samples can be prepared

### Preparation for Hybridisation

Denature the prepared samples for 2 minutes at 95° C. in a thermoshaker
Subsequently fill up the denatured DNA sample to 100 μL with hybridisation buffer (i.e. 8 μL DNA+92 μL hybridisation buffer)
Pipette the whole mixture into the Array Tube without touching the reaction surface

### Hybridisation

Hybridise the sample at 48° C. and 550 rpm for 60 minutes in a thermoshaker
During this hybridisation time the blocking mix has to be prepared. To do so add 0.02 g blocking powder to 1 mL blocking solution, mix by vortexing and solubilise this at 65° C. Then allow the blocking mix to cool down to RT before use!

### Washing Steps After Hybridisation

Before starting the washing steps, completely remove the hybridisation buffer without touching the spotted reaction surface! Carefully remove the respective washing buffer after each step without touching the reaction surface!
Wash the Array Tube with 500 μl washbuffer I at 550 rpm and 50° C. for 5 minutes
Wash the Array Tube with 500 μl washbuffer II at 550 rpm and 50° C. for 5 minutes
Wash the Array Tube with 500 μl washbuffer III at 550 rpm and 41° C. for 5 minutes
Wash the Array Tube with 500 μl washbuffer III at 550 rpm and 41° C. for 5 minutes

### Blocking the Array Tubes

Add 100 μl of the freshly prepared blocking solution and incubate for 15 minutes at 550 rpm and RT
During the blocking the HRP-Conjugation Mix has to be prepared. Add 75 μL 20×SSPE to 175 μL PCR H₂O and 0, 5 μL Poly-HRP enzyme, mix and store at 4° C. until use. This amount can be used for 2 arrays.

### Enzyme Conjugation

Carefully remove the blocking solution completely from the tube!
Add 100 μl of the poly-HRP conjugate to the Array Tube and incubate for 15 minutes at 550 rpm and RT
After that carefully remove the conjugate solution completely!

### Washing Steps After Conjugation

Carefully remove the respective washing buffer after each step without touching the reaction surface!
Wash the Array Tube with 500 μl washbuffer I at 550 rpm and RT for 5 minutes
Wash the Array Tube with 500 μl washbuffer II at 550 rpm and RT for 5 minutes
Wash the Array Tube with 500 μl washbuffer III at 550 rpm and RT for 5 minutes

### Staining

Do not shake the array during the staining!
Warm the substrate to RT and centrifuge for 15 seconds at 5000 rpm
Add 100 μl of the centrifuged substrate solution into the Array Tube and incubate for 10 minutes. After that place the tube in the reader for evaluation. Do not remove the substrate solution!

### Evaluation and Interpretation of Results

The evaluation is performed using the reader and the PharmGenomics® evaluation software and a final report is prepared. This report includes the genotype of the tested DNA sample and a risk estimation.
Place the Array Tube in the reader and run the ICONO software
The obtained photograph of the spot pattern on the array is loaded into Partisan ICONO program (“submit to ICONO dust”)
Start the evaluation by pressing the RUN button in the Partisan ICONO program

Now a grid is placed on the spot pattern so that each probe can be allocated one specific signal.

### Positive Control

Each kit contains a genomic DNA positive control of the heterozygous genotype DPD *2A, *5 and M166V. This control can be used as described in the standard protocol of this assay.

### Examples

### Example 1

The protocols described herein were performed to prepare numerous samples for testing on various solid supports comprising different combinations of capture probes. Three different solid support arrays having three different sets of capture probes were used. A variety of probes and primers have been tested and are shown in the Figures. A number of probes were rejected because they were too short or too long, causing insufficient or unspecific binding of target.

For the first chip, hybridisation temperatures were varied between 54 and 60° C. For amplification, primers amplifying just single targets in no multiplex reactions were exclusively used. The following primers were tested:

| *2A 14 | |
|---|---|
| Forward: | 5′-CATGTATGGCCCTGGAC-3′ |
| Reverse: | 5′-AACTTATGCCAATTCTCTTGTTT-3 |
| 156 | |
| *10 23 | |
| Forward: | 5′-CAGTGACATCAATACCCTCTA-3′ |
| Reverse: | 5′-TTTGGTTCATAAGGTGTTGTCC-3′ |
| 168 | |
| *9B 2/21 | |
| Forward: | 5′-TGAGCTAACATGCTTCCTTATT-3′ |
| Reverse: | 5′-AAACAGTTTCTCTTAAGTGGTGA-3′ |
| 153 | |
| *9A 2 | |
| Forward: | 5′-AGAGAGACCGTGTCTCAA-3′ |
| Reverse: | 5′-TGGTACTTACAAAGCAGTTCTTATC-3′ |
| 223 | |
| *8 7 | |
| Forward: | 5′-GTCCTCATGCATATCTTGTGTG-3′ |
| Reverse: | 5′-GCTTCTGCCTGATGTAGC-3′ |
| 360 | |
| *7 4 | |
| Forward: | 5′-GGTAGAAAATAGATTATCTC-3′ |
| Reverse: | 5′-GATTTGCTAAGACAAGCTG-3′ |
| 241 | |
| *3 14 | |
| Forward: | 5′-TCCTCTGCAAAAATGTGAGAAGGGACC-3′ |
| Reverse: | 5′-CAGCAAAGCAACTGGCAGATTC-3′ |
| 415 | |

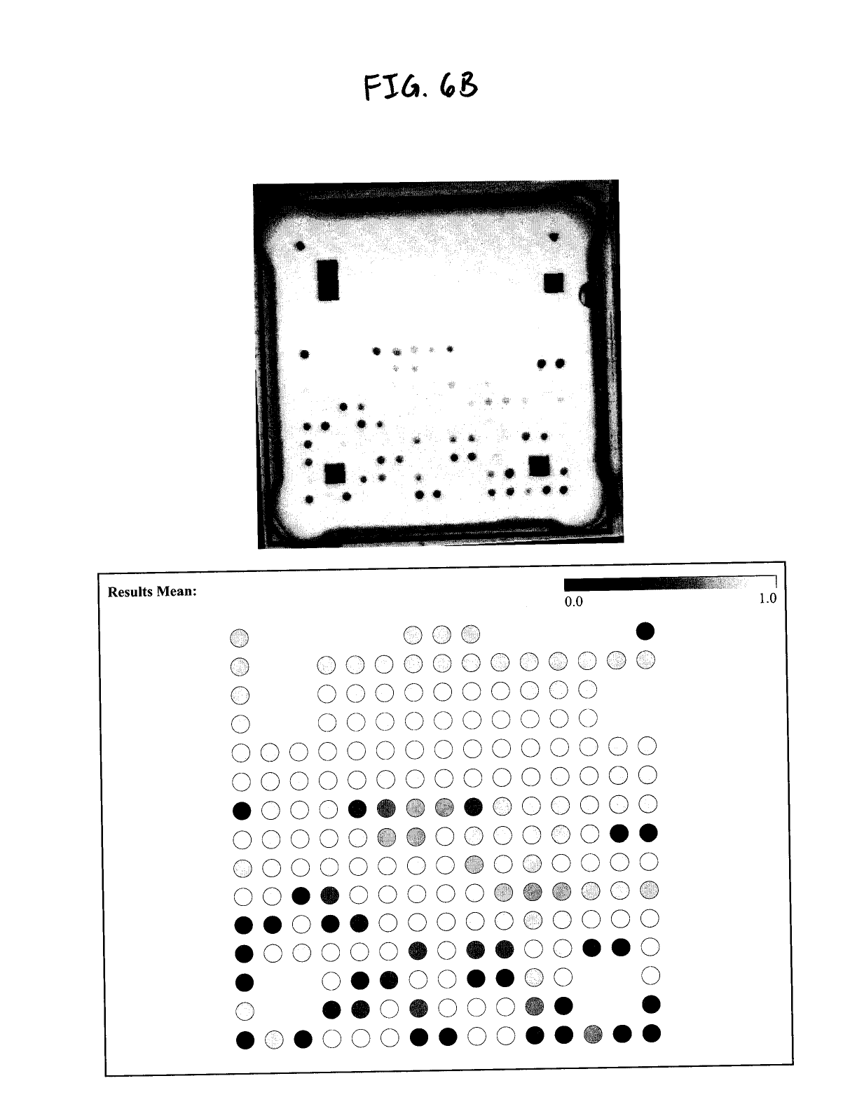

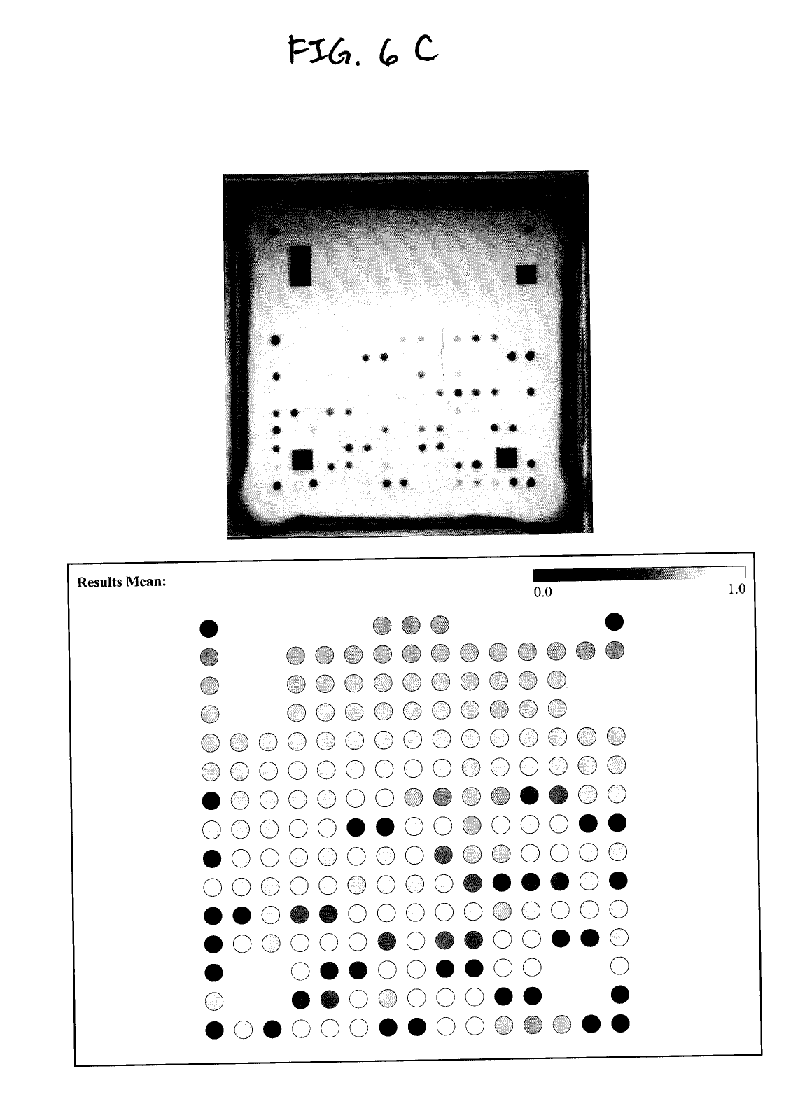

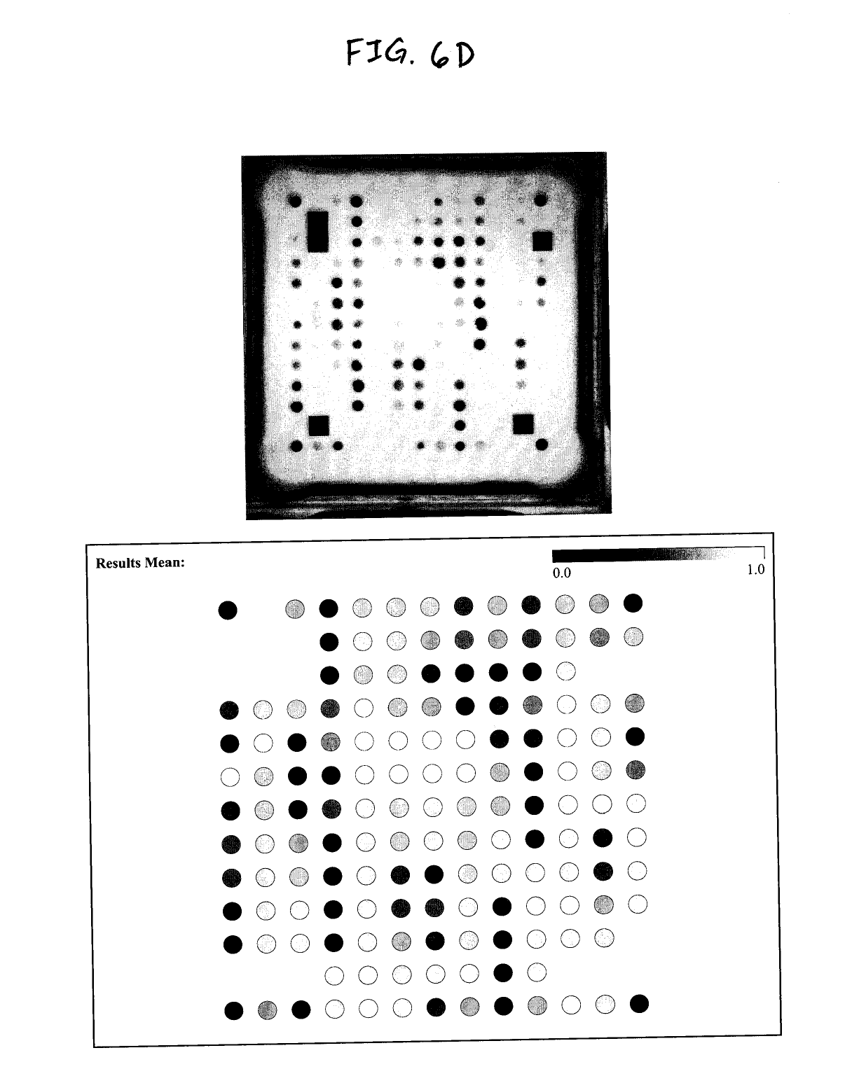

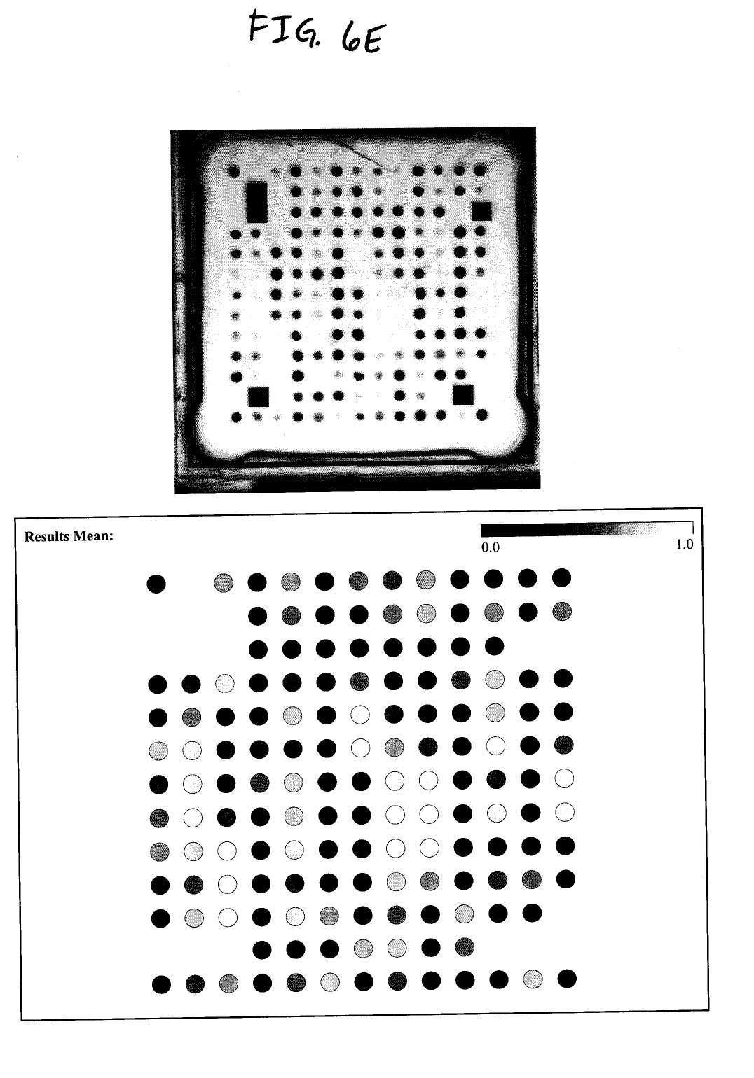

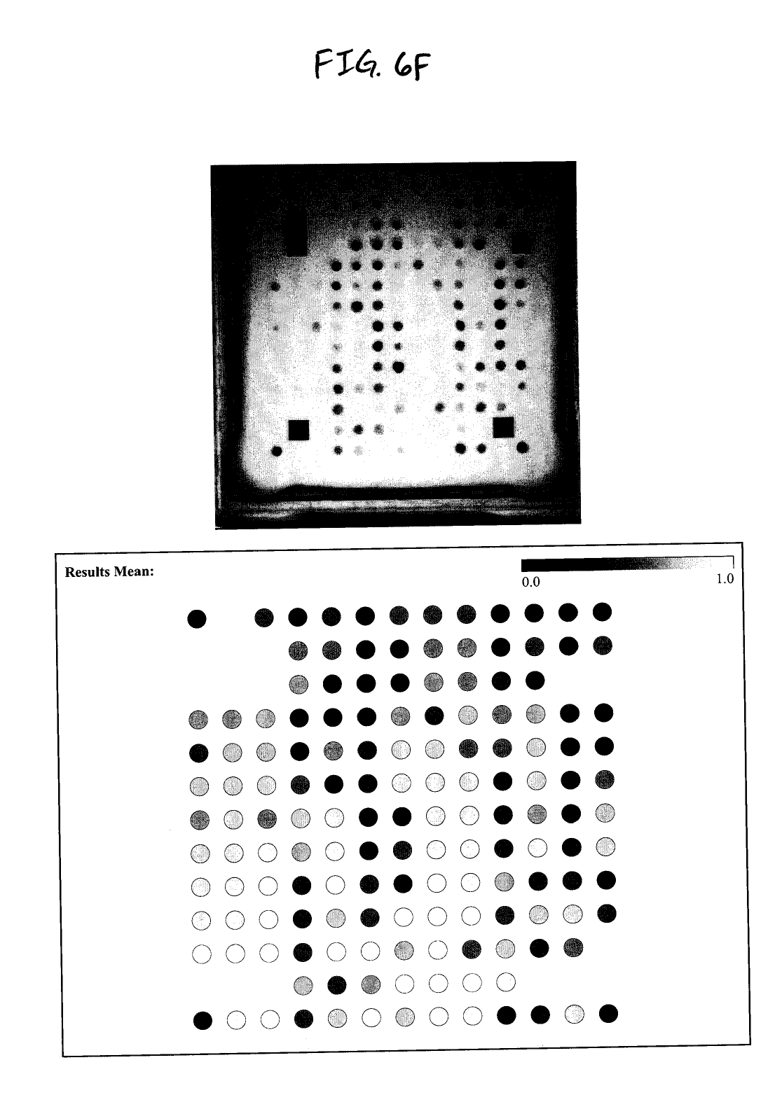

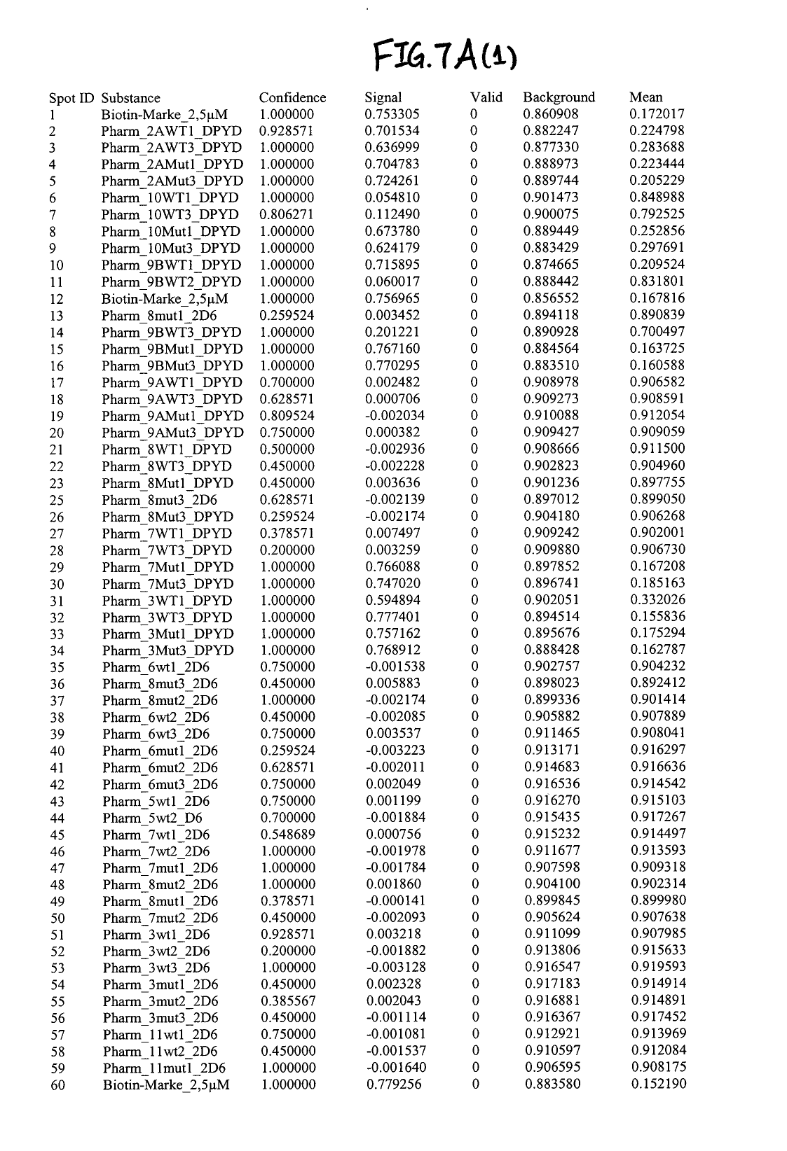

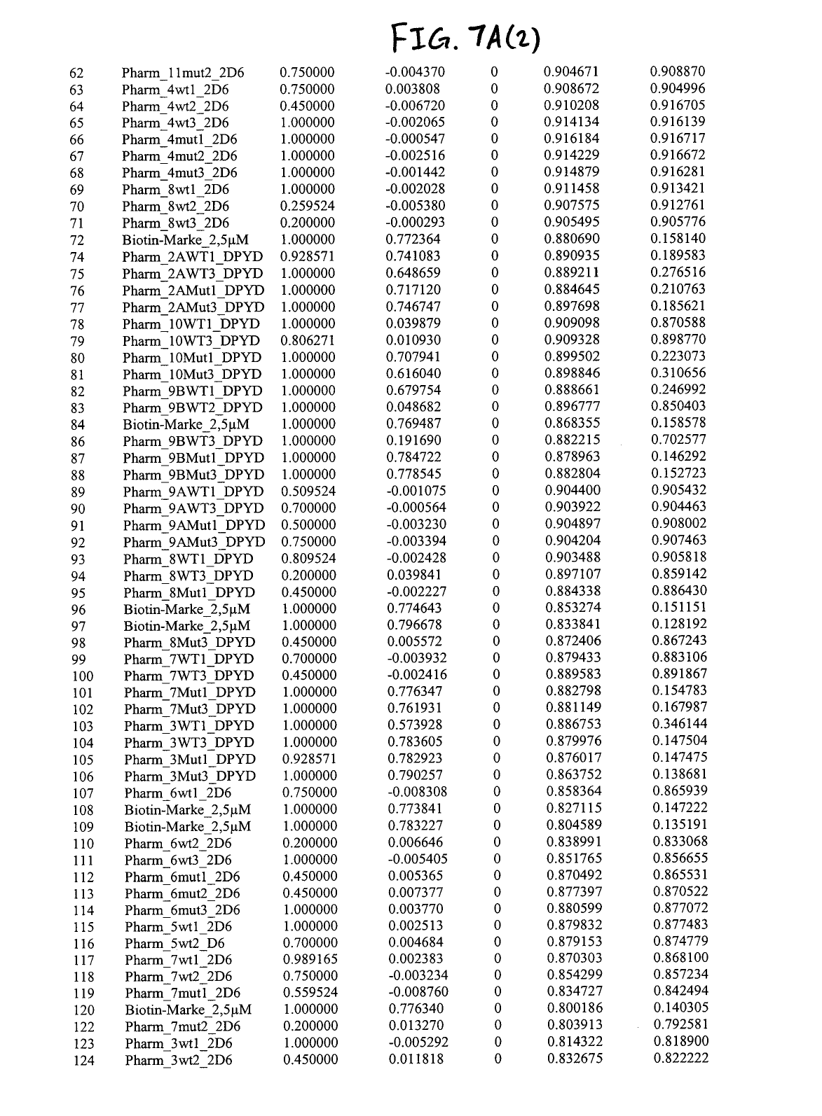

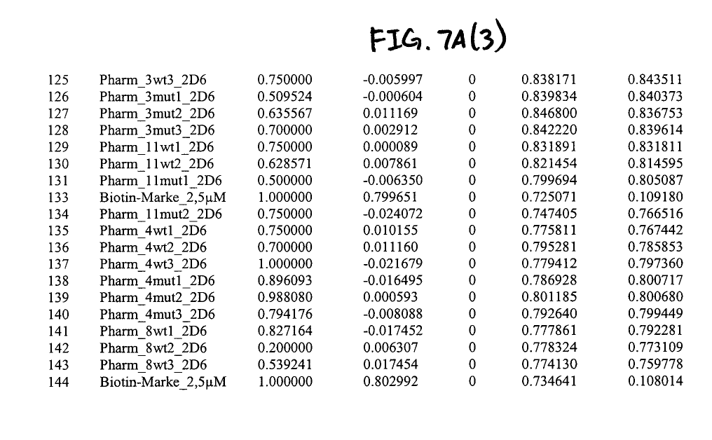

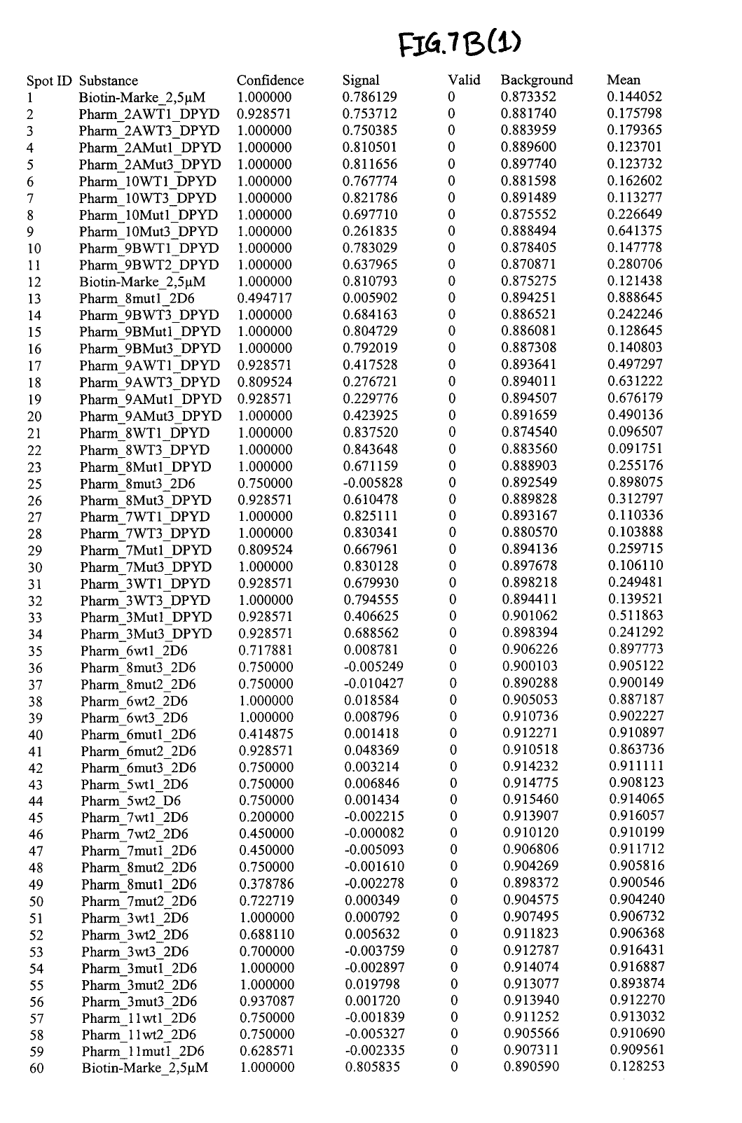

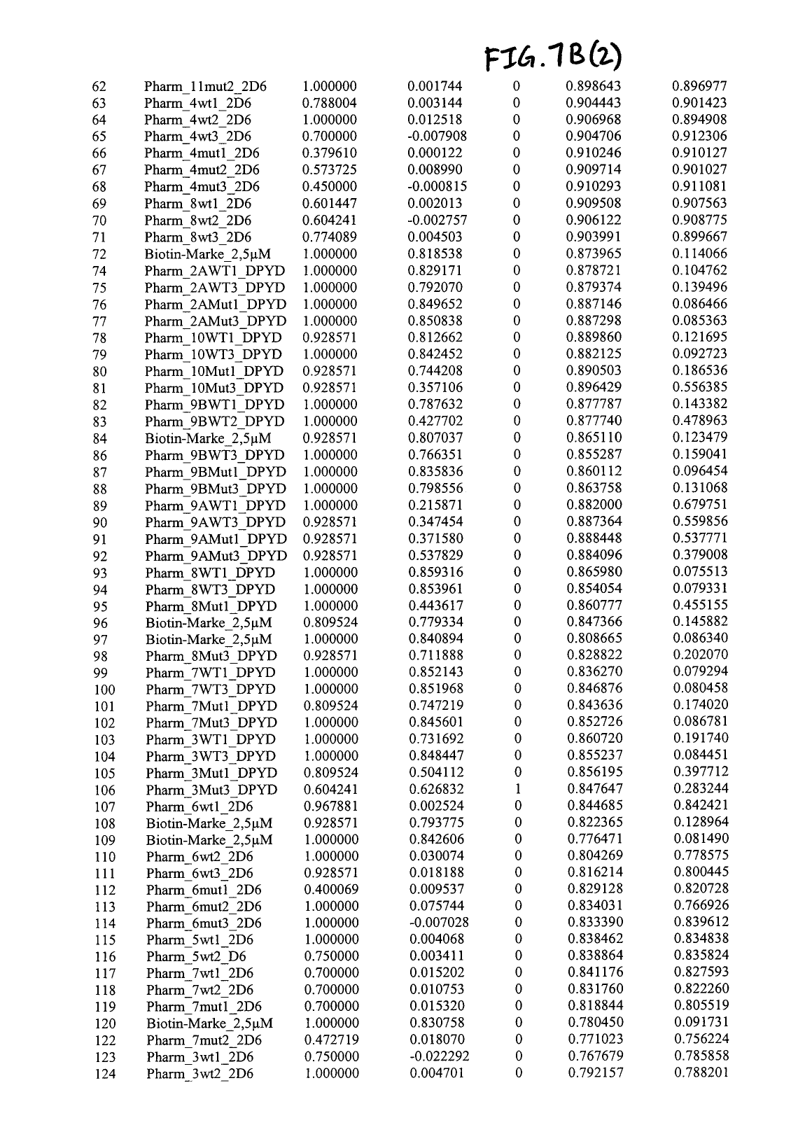

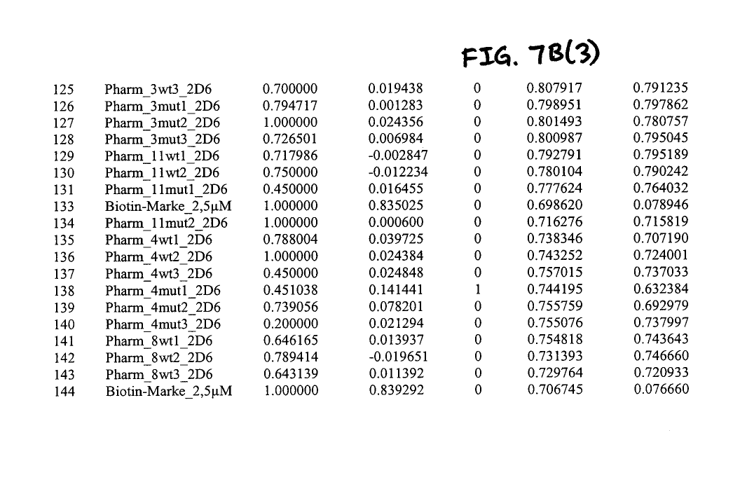

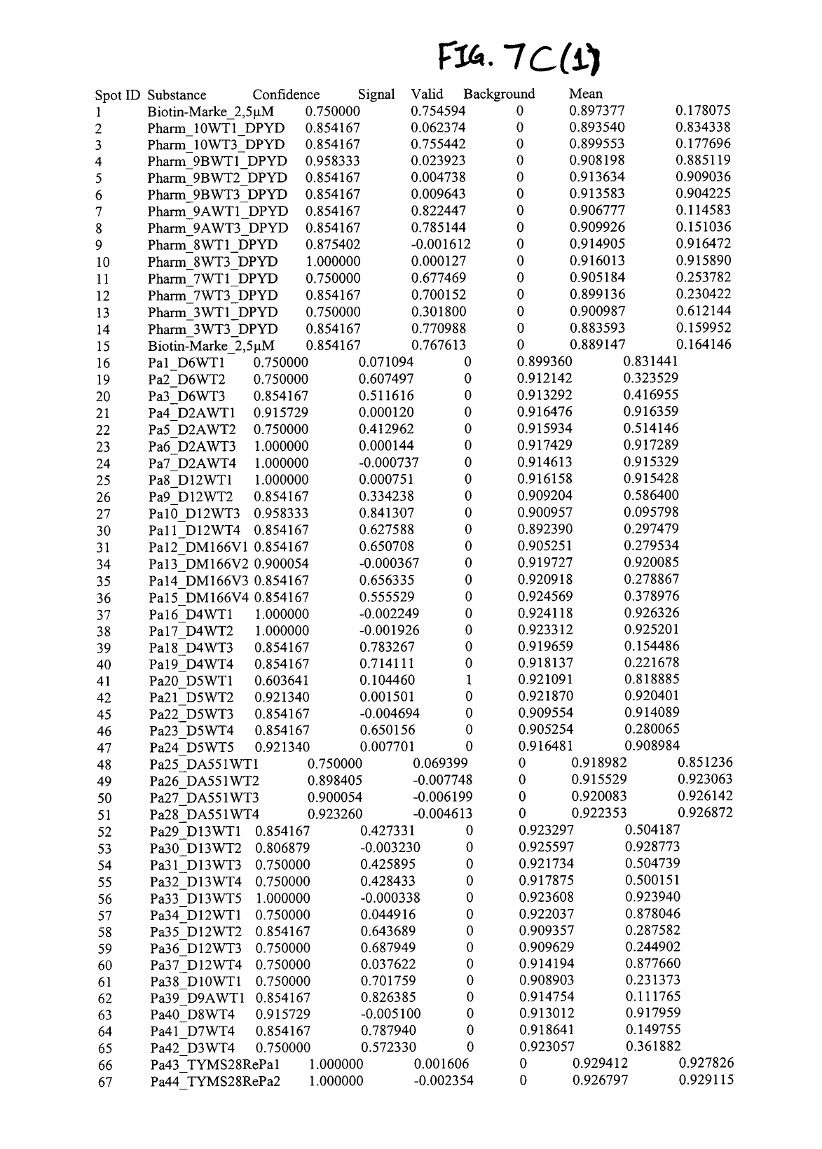

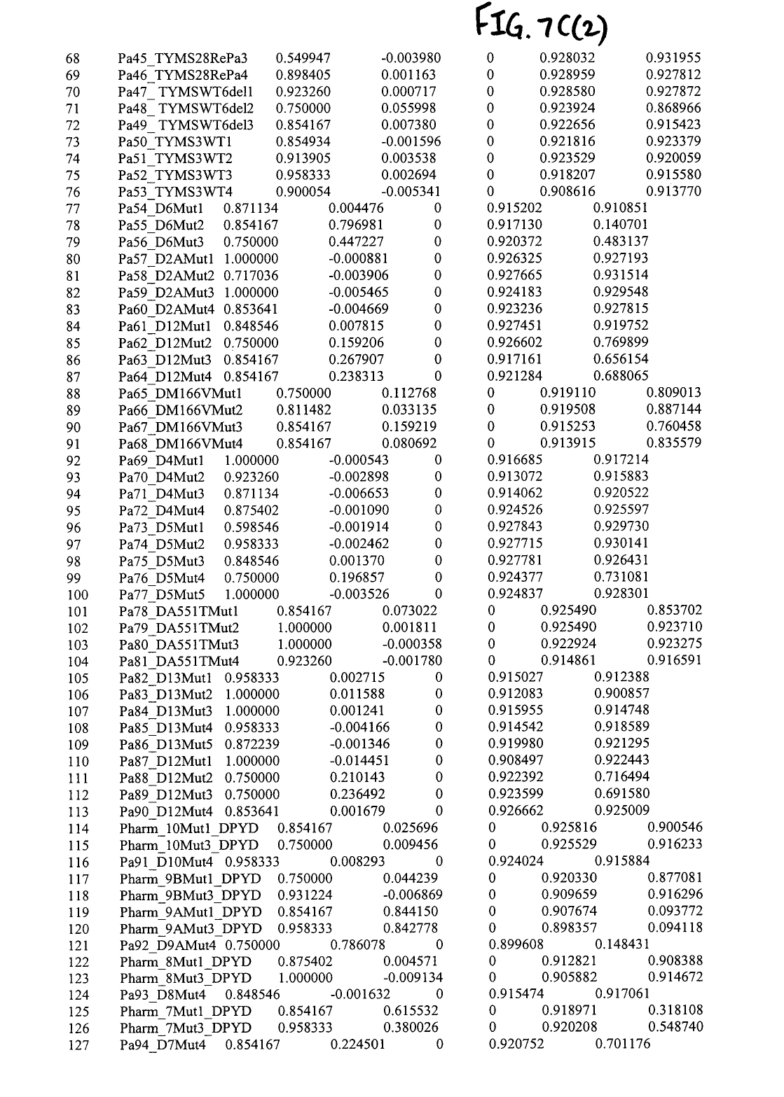

An example image of the solid support showing the detection of a target can be seen in FIG. 6A.

### Example 2

For the second chip, multiplex primers were used to amplify target. Here, variations in experimental conditions were tested. For example, hybridisation temperature was varied from 45-50° C. The following washing steps were tested following hybridisation (always 5 min with the respective washing buffers I-III from the above protocol at the given temperature):
variant 1: 50/50/50/50
variant 2: 50/50/50
variant 3: 50/50/48
variant 4: 50/50/45
variant 5: 50/50/42
variant 6: 50/50/40

Accordingly, an example image of the solid support showing the detection of a target can be seen in FIGS. 6B and 6C.

### Example 3

A third chip with a different combination of probes was also tested. Example images are shown in FIGS. 6D-6F.

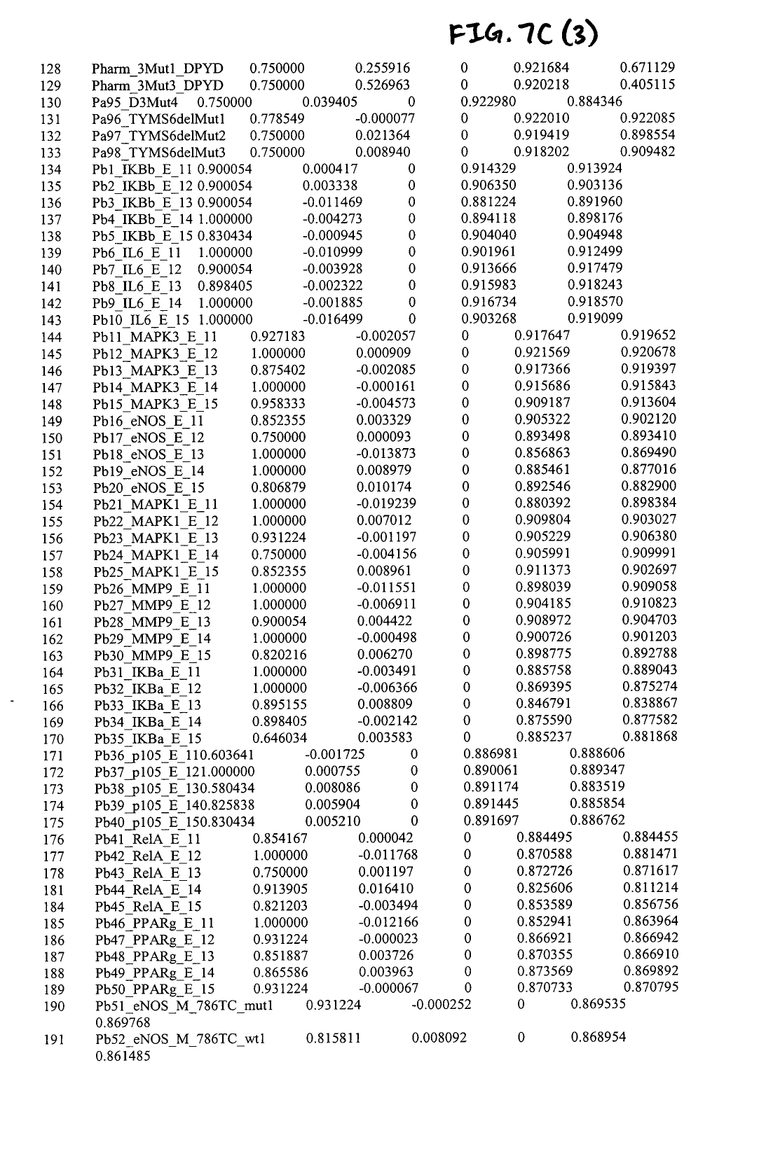

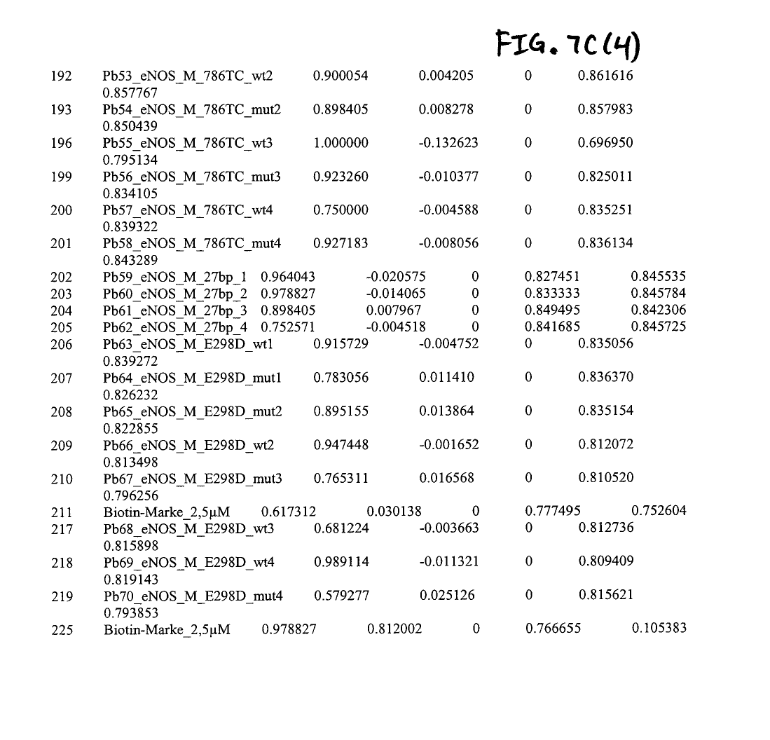

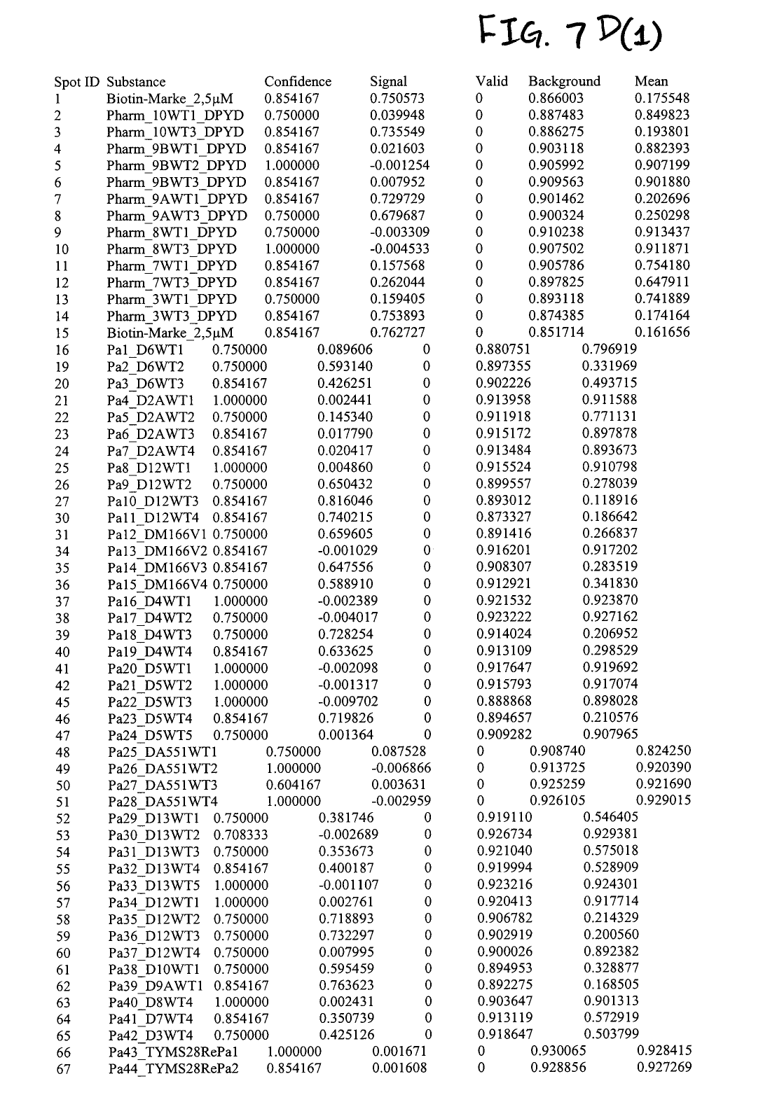

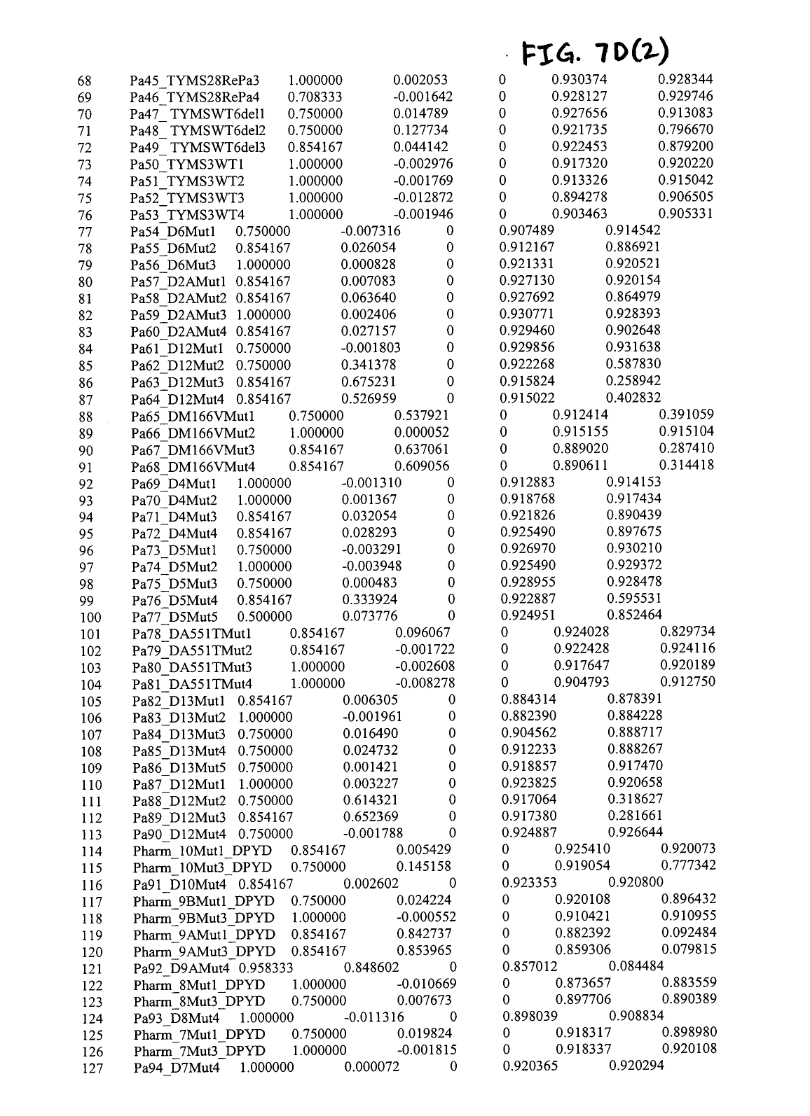

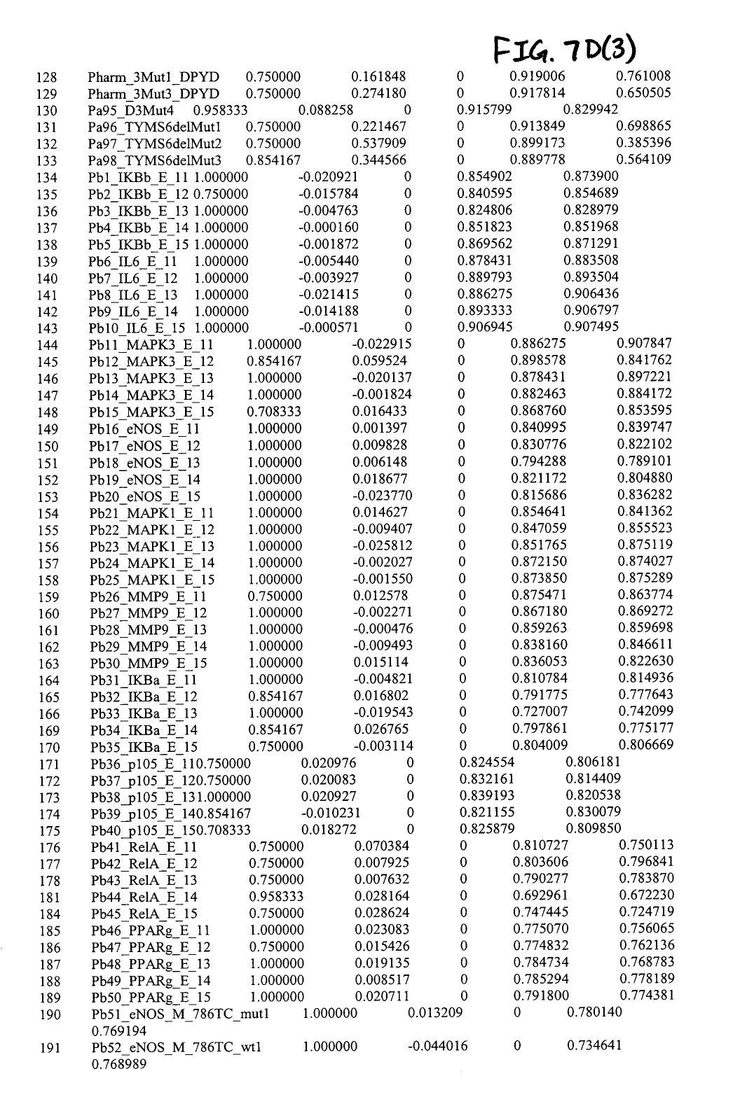

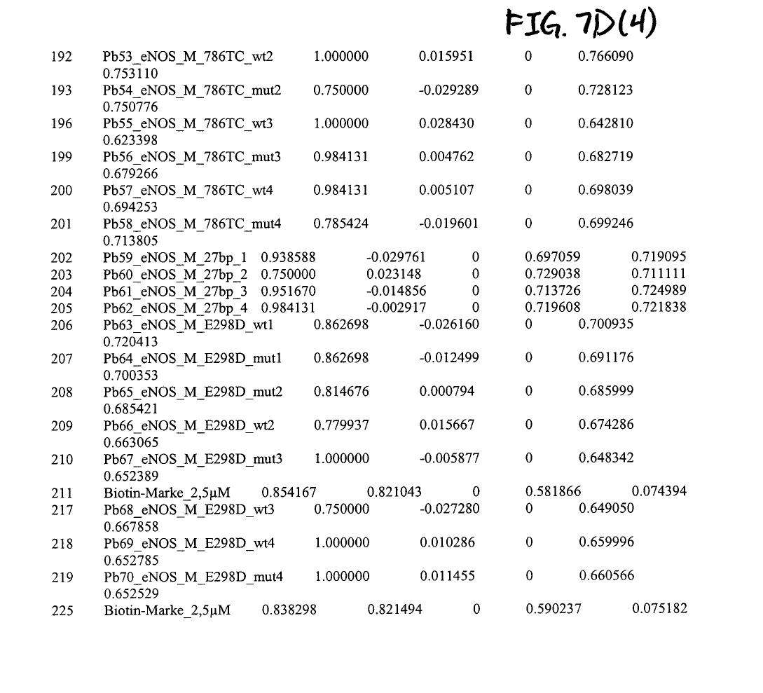

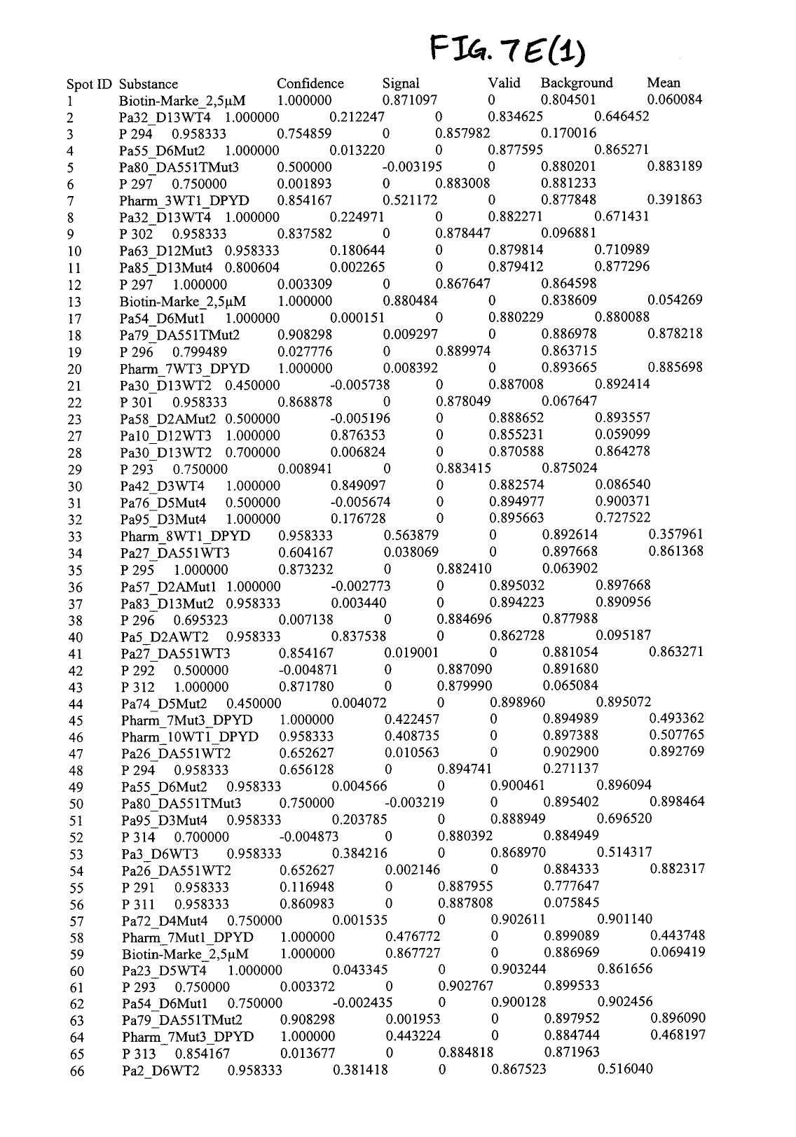

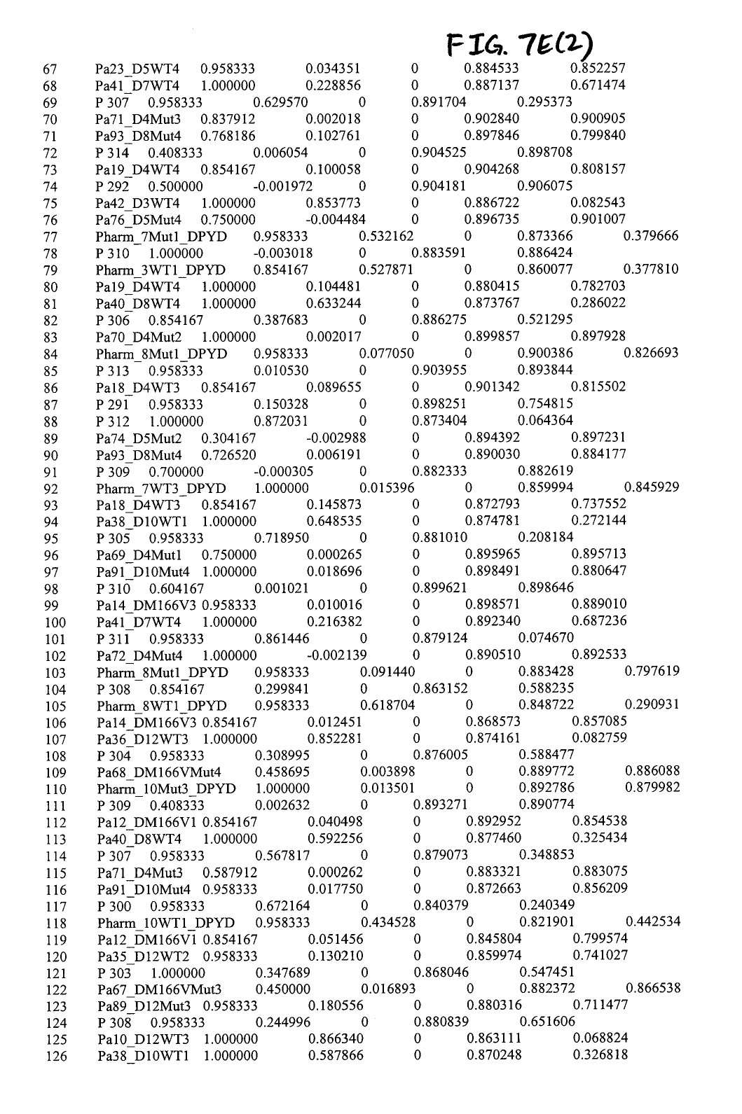

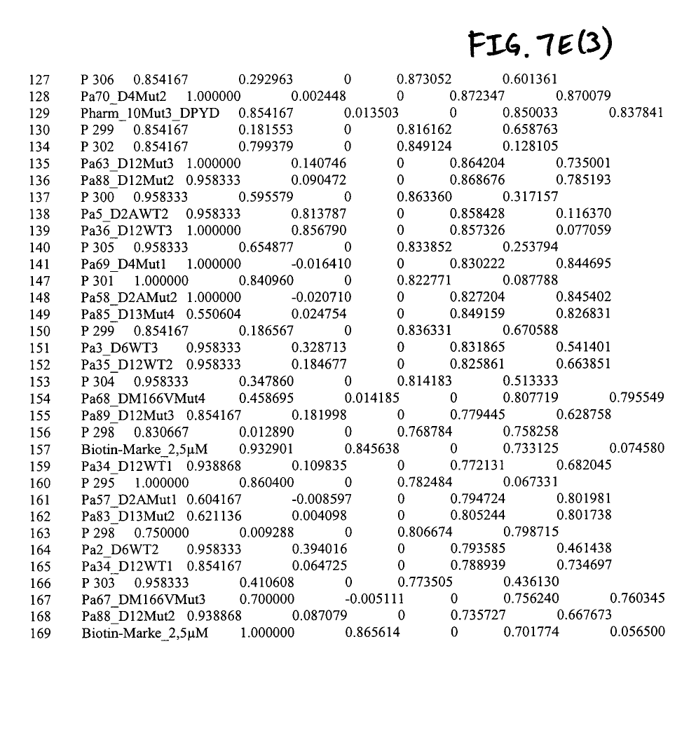

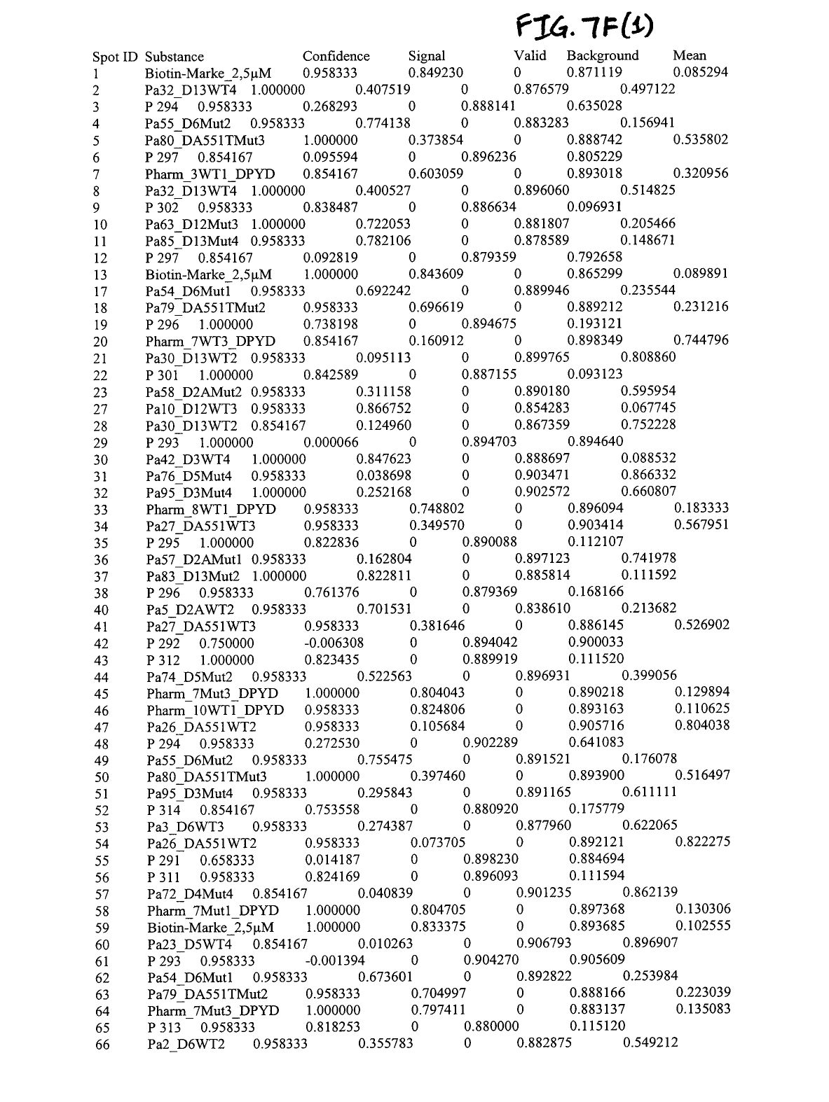

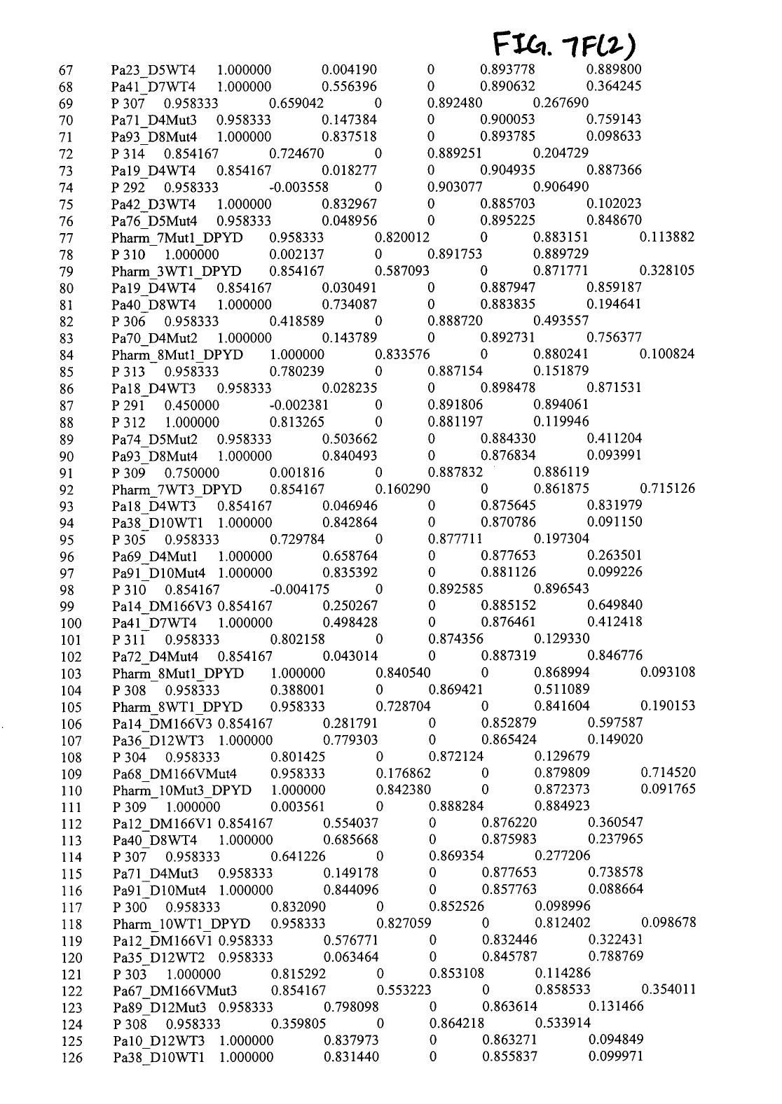

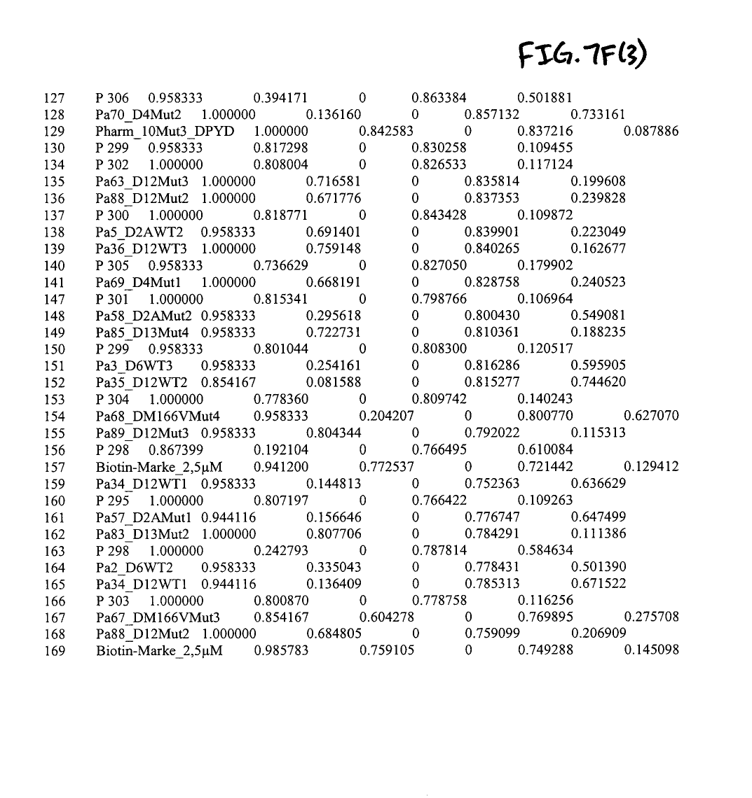

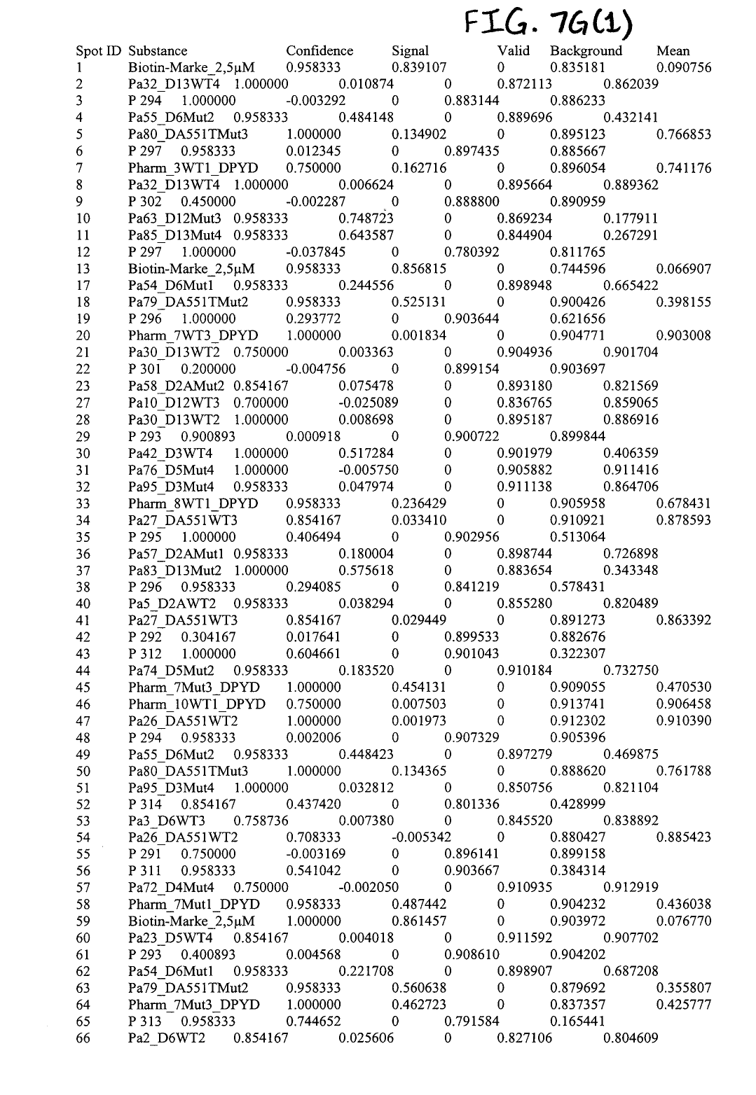

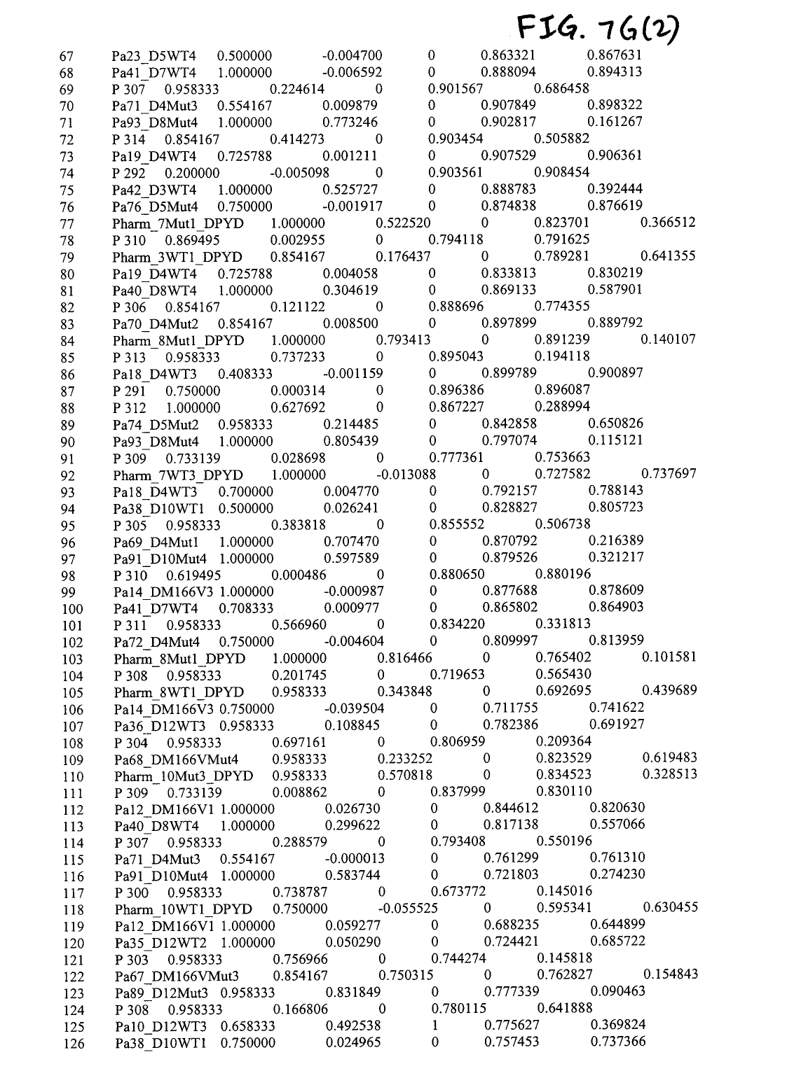

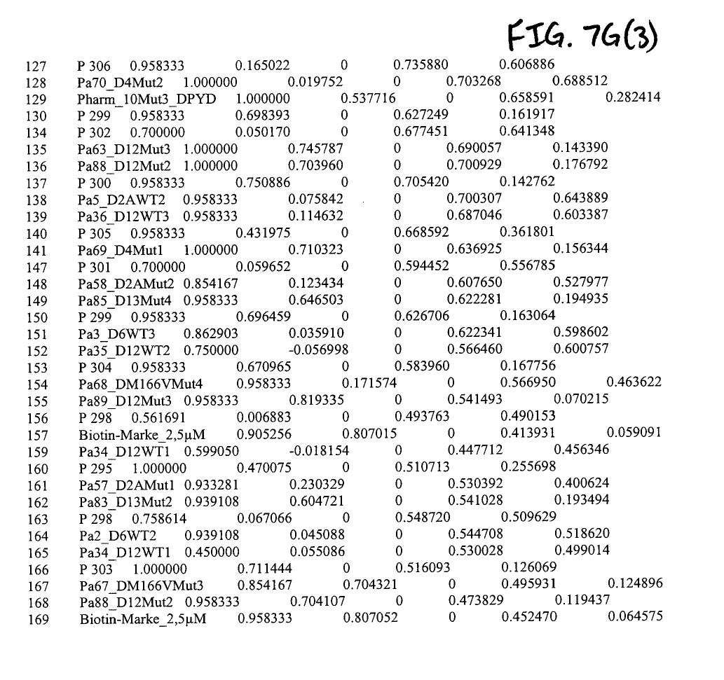

A large amount of data has been collected for the three different chips. A small sample of this data is presented in FIG. 7, which shows signal detected from the three different chips.

The articles “a,” “an” and “the” as used herein do not exclude a plural number of the referent, unless context clearly dictates otherwise. The conjunction “or” is not mutually exclusive, unless context clearly dictates otherwise. The term “include” is used to refer to non-exhaustive examples.

All references, publications, patent applications, issued patents, accession records and databases cited herein, including in any appendices, are incorporated by reference in their entirety for all purposes.

### CITATIONS

1. Morel A, Boisdron-Celle M, Fey L, et al. Clinical relevance of different dihydropyrimidine dehydrogenase gene single nucleotide polymorphisms on 5-fluorouracil tolerance. Mol Cancer Ther. 2006; 5: 2895-2904.
2. Lecomte T, Ferraz J-M, Zinzindohoué F, et al. Thymidylate synthase gene polymorphism predicts toxicity in colorectal cancer patients receiving 5-fluorouracil-based chemotherapy. Clin Cancer Res. 2004; 10: 5880-5888.
3. SantaLucia J., 1998, A unified view of polymer, dumbbell, and oligonucleotide DNA nearest-neighbor thermodynamics, Proc. Natl. Acad. Sci. USA Vol. 95, pp. 1460-1465.
4. Mol Cancer Ther. 2006; 5(11): 2895-2904
5. Clin Cancer Res. 2006; 12(13): 3928-3934
6. Pharmacogenomics, 2001; J1: 65-70
7. J Clin Oncol. 2008; 26(13): 2130-2137

1. A kit comprising a solid support comprising a capture probe set comprising:
(a) an isolated nucleic acid comprising SEQ ID NO: 1 or its complement, (b) an isolated nucleic acid comprising SEQ ID NO: 2 or its complement, (c) an isolated nucleic acid comprising SEQ ID NO: 3 or its complement, (d) an isolated nucleic acid comprising SEQ ID NO: 4 or its complement, (e) an isolated nucleic acid comprising SEQ ID NO: 5 or its complement, (f) an isolated nucleic acid comprising SEQ ID NO: 6 or its complement, (g) an isolated nucleic acid comprising SEQ ID NO: 7 or its complement, (h) an isolated nucleic acid comprising SEQ ID NO: 8 or its complement, (i) an isolated nucleic acid comprising SEQ ID NO: 9 or its complement, (j) an isolated nucleic acid comprising SEQ ID NO: 10 or its complement, (k) an isolated nucleic acid comprising SEQ ID NO: 11 or its complement, (l) an isolated nucleic acid comprising SEQ ID NO:
12 or its complement, (m) an isolated nucleic acid comprising SEQ ID NO: 13 or its complement, (n) an isolated nucleic acid comprising SEQ ID NO: 14 or its complement, (o) an isolated nucleic acid comprising SEQ ID NO: 15 or its complement, (p) an isolated nucleic acid comprising SEQ ID NO: 16 or its complement, (q) an isolated nucleic acid comprising SEQ ID NO: 17 or its complement, (r) an isolated nucleic acid comprising SEQ ID NO: 18 or its complement, (s) an isolated nucleic acid comprising SEQ ID NO:
19 or its complement, (t) an isolated nucleic acid comprising SEQ ID NO: 20 or its complement, (u) an isolated nucleic acid comprising SEQ ID NO: 21 or its complement, (v) an isolated nucleic acid comprising SEQ ID NO: 22 or its complement, (w) an isolated nucleic acid comprising SEQ ID NO: 23 or its complement, (x) an isolated nucleic acid comprising SEQ ID NO: 24 or its complement, (y) an isolated nucleic acid comprising SEQ ID NO: 25 or its complement, (z) an isolated nucleic acid comprising SEQ ID NO: 26 or its complement, (aa) an isolated nucleic acid comprising SEQ ID NO:
27 or its complement, (ab) an isolated nucleic acid comprising SEQ ID NO: 28 or its complement, (ac) an isolated nucleic acid comprising SEQ ID NO: 29 or its complement, (ad) an isolated nucleic acid comprising SEQ ID NO: 30 or its complement, (ae) an isolated nucleic acid comprising SEQ ID NO: 31 or its complement, (af) an isolated nucleic acid comprising SEQ ID NO: 32 or its complement, (ag) an isolated nucleic acid comprising SEQ ID NO: 33 or its complement, (ah) an isolated nucleic acid comprising SEQ ID NO: 34 or its complement, (ai) an isolated nucleic acid comprising SEQ ID NO: 35 or its complement, and (aj) a nucleic acid comprising SEQ ID NO: 36 or its complement, wherein each of the isolated nucleic acids has a length of about 18 to about 50 nucleic acids.

2. The kit of claim 1 wherein the capture probe set comprises: (a) an isolated nucleic acid consisting of SEQ ID NO: 1, (b) an isolated nucleic acid consisting of SEQ ID NO: 2, (c) an isolated nucleic acid consisting of SEQ ID NO: 3, (d) an isolated nucleic acid consisting of SEQ ID NO: 4, (e) an isolated nucleic acid consisting of SEQ ID NO:
5, (f) an isolated nucleic acid consisting of SEQ ID NO: 6, (g) an isolated nucleic acid consisting of SEQ ID NO: 7, (h) an isolated nucleic acid consisting of SEQ ID NO: 8, (i) an isolated nucleic acid consisting of SEQ ID NO: 9, (j) an isolated nucleic acid consisting of SEQ ID NO: 10, (k) an isolated nucleic acid consisting of SEQ ID NO: 11, (l) an isolated nucleic acid consisting of SEQ ID NO: 12, (m) an isolated nucleic acid consisting of SEQ ID NO: 13, (n) an isolated nucleic acid consisting of SEQ ID NO: 14, (o) an isolated nucleic acid consisting of SEQ ID NO: 15, (p) an isolated nucleic acid consisting of SEQ ID NO: 16, (q) an isolated nucleic acid consisting of SEQ ID NO: 17, (r) an isolated nucleic acid consisting of SEQ ID NO: 18, (s) an isolated nucleic acid consisting of SEQ ID NO: 19, (t) an isolated nucleic acid consisting of SEQ ID NO: 20, (u) an isolated nucleic acid consisting of SEQ ID NO: 21, (v) an isolated nucleic acid consisting of SEQ ID NO: 22, (w) an isolated nucleic acid consisting of SEQ ID NO: 23, (x) an isolated nucleic acid consisting of SEQ ID NO: 24, (y) an isolated nucleic acid consisting of SEQ ID NO: 25, (z) an isolated nucleic acid consisting of SEQ ID NO: 26, (aa) an isolated nucleic acid consisting of SEQ ID NO: 27, (ab) an isolated nucleic acid consisting of SEQ ID NO: 28, (ac) an isolated nucleic acid consisting of SEQ ID NO: 29. (ad) an isolated nucleic acid consisting of SEQ ID NO: 30, (ae) an isolated nucleic acid consisting of SEQ ID NO: 31, (af) an isolated nucleic acid consisting of SEQ ID NO: 32, (ag) an isolated nucleic acid consisting of SEQ ID NO: 33, (ah) an isolated nucleic acid consisting of SEQ ID NO: 34, (ai) an isolated nucleic acid consisting of SEQ ID NO: 35, and (aj) a nucleic acid consisting of SEQ ID NO: 36.

3. The kit of claim 1 further comprising a primer set comprising: (a) an isolated nucleic acid comprising SEQ ID NO: 37 or its complement, (b) an isolated nucleic acid comprising SEQ ID NO: 38 or its complement, (c) an isolated nucleic acid comprising SEQ ID NO: 39 or its complement, (d) an isolated nucleic acid comprising SEQ ID NO: 40 or its complement, (e) an isolated nucleic acid comprising SEQ ID NO: 41 or its complement, (f) an isolated nucleic acid comprising SEQ ID NO: 42 or its complement, (g) an isolated nucleic acid comprising SEQ ID NO: 43 or its complement, (h) an isolated nucleic acid comprising SEQ ID NO: 44 or its complement, (i) an isolated nucleic acid comprising SEQ ID NO: 45 or its complement, (j) an isolated nucleic acid comprising SEQ ID NO: 46 or its complement, (k) an isolated nucleic acid comprising SEQ ID NO: 47 or its complement, (l) an isolated nucleic acid comprising SEQ ID NO: 48 or its complement, (m) an isolated nucleic acid comprising SEQ ID NO: 49 or its complement, (n) an isolated nucleic acid comprising SEQ ID NO: 50 or its complement, (o) an isolated nucleic acid comprising SEQ ID NO: 51 or its complement, and (p) an isolated nucleic acid comprising SEQ ID NO: 52 or its complement, wherein each of the isolated nucleic acids has a length of about 21 to about 50 nucleic acids.

4. The kit of claim 3 wherein the primer set comprises: (a) an isolated nucleic acid consisting of SEQ ID NO: 37, (b) an isolated nucleic acid consisting of SEQ ID NO:
38, (c) an isolated nucleic acid consisting of SEQ ID NO: 39, (d) an isolated nucleic acid consisting of SEQ ID NO: 40, (e) an isolated nucleic acid consisting of SEQ ID NO: 41, (f) an isolated nucleic acid consisting of SEQ ID NO: 42, (g) an isolated nucleic acid consisting of SEQ ID NO: 43, (h) an isolated nucleic acid consisting of SEQ ID NO: 44, (i) an isolated nucleic acid consisting of SEQ ID NO: 45, (j) an isolated nucleic acid consisting of SEQ ID NO: 46, (k) an isolated nucleic acid consisting of SEQ ID NO: 47, (l) an isolated nucleic acid consisting of SEQ ID NO: 48, (m) an isolated nucleic acid consisting of SEQ ID NO: 49, (n) an isolated nucleic acid consisting of SEQ ID NO: 50, (o) an isolated nucleic acid consisting of SEQ ID NO: 51 and (p) an isolated nucleic acid consisting of SEQ ID NO: 52.

5. The kit of claim 3 wherein at least one of the isolated nucleic acids of the primer set comprises a detectable label.

6. The kit of claim 5 wherein the detectable label is biotin.

7. The kit of claim 6 further comprising a conjugated enzyme.

8. The kit of claim 7 further comprising a precipitating agent.

9. A method of detecting one or more polymorphisms in a nucleic acid comprising the DPYD gene, the method comprising:
(a) generating a plurality of amplicons in a sample comprising the nucleic acid, wherein the generating step comprises contacting the sample with a primer set comprising (i) an isolated nucleic acid comprising SEQ ID NO: 37 or its complement, (ii) an isolated nucleic acid comprising SEQ ID NO: 38 or its complement, (iii) an isolated nucleic acid comprising SEQ ID NO: 39 or its complement, (iv) an isolated nucleic acid comprising SEQ ID NO: 40 or its complement, (v) an isolated nucleic acid comprising SEQ ID NO: 41 or its complement, (vi) an isolated nucleic acid comprising SEQ ID NO: 42 or its complement, (vii) an isolated nucleic acid comprising SEQ ID NO: 43 or its complement, (viii) an isolated nucleic acid comprising SEQ ID NO: 44 or its complement, (ix) an isolated nucleic acid comprising SEQ ID NO: 45 or its complement, (x) an isolated nucleic acid comprising SEQ ID NO: 46 or its complement, (xi) an isolated nucleic acid comprising SEQ ID NO: 47 or its complement, (xii) an isolated nucleic acid comprising SEQ ID NO: 48 or its complement, (xiii) an isolated nucleic acid comprising SEQ ID NO: 49 or its complement, (xiv) an isolated nucleic acid comprising SEQ ID NO: 50 or its complement, (xv) an isolated nucleic acid comprising SEQ ID NO: 51 or its complement, and (xvi) an isolated nucleic acid comprising SEQ ID NO: 52 or its complement, wherein each of the isolated nucleic acids has a length of about 21 to about 50 nucleic acids; and wherein each of the plurality of amplicons comprises a detectable label;
(b) contacting the plurality of amplicons with the solid support of the kit of claim 1; and
(c) detecting the presence or absence of the detectable label, thereby detecting one or more polymorphisms in the nucleic acid.

10. The method of claim 9 wherein the detecting step comprises contacting the sample with a conjugated enzyme.

11. The method of claim 10 wherein the detecting step comprises contacting the sample with a precipitating agent.

12. A method of determining dihydropyrimidine dehydrogenase genotype in a subject, the method comprising determining whether a nucleic acid in a sample from the subject is characterized by a plurality of DPYD alleles comprising *2A, *3, *4, *5, *6, *7, *8, *10, *12, *13, A551T, M166V and D949V.

13. The method of claim 12 wherein the plurality of DPYD alleles consists of *2A, *3, *4, *5, *6, *7, *8, *10, *12, *13, A551T, M166V and D949V.

14. A kit comprising:
a) a capture probe that will hybridize under high stringency conditions to the complement of SEQ ID NO: 1 and contains G at a position corresponding to position 9 of SEQ ID NO: 1;
b) a capture probe that will hybridize under high stringency conditions to the complement of SEQ ID NO: 2 and contains A at a position corresponding to position 9 of SEQ ID NO: 2;
c) a capture probe that will hybridize under high stringency conditions to the complement of SEQ ID NO: 3 and contains G at a position corresponding to position 7 of SEQ ID NO: 3;
d) a capture probe that will hybridize under high stringency conditions to the complement of SEQ ID NO: 4;
e) a capture probe that will hybridize under high stringency conditions to the complement of SEQ ID NO: 5;
f) a capture probe that will hybridize under high stringency conditions to the complement of SEQ ID NO: 6 and contains C at a position corresponding to position 12 of SEQ ID NO: 6;
g) a capture probe that will hybridize under high stringency conditions to the complement of SEQ ID NO: 7 and contains C at a position corresponding to position 10 of SEQ ID NO: 7;
h) a capture probe that will hybridize under high stringency conditions to the complement of SEQ ID NO: 8 and contains A at a position corresponding to position 6 of SEQ ID NO: 8;
i) a capture probe that will hybridize under high stringency conditions to the complement of SEQ ID NO: 9 and contains T at a position corresponding to position 13 of SEQ ID NO: 9;
j) a capture probe that will hybridize under high stringency conditions to the complement of SEQ ID NO: 10 and contains T at a position corresponding to position 15 of SEQ ID NO: 10;
k) a capture probe that will hybridize under high stringency conditions to the complement of SEQ ID NO: 11 and contains C at a position corresponding to position 13 of SEQ ID NO: 11;
l) a capture probe that will hybridize under high stringency conditions to the complement of SEQ ID NO: 12 and contains G at a position corresponding to position 7 of SEQ ID NO: 12;
m) a capture probe that will hybridize under high stringency conditions to the complement of SEQ ID NO: 13 and contains G at a position corresponding to position 7 of SEQ ID NO: 13;
n) a capture probe that will hybridize under high stringency conditions to the complement of SEQ ID NO: 14 and contains A at a position corresponding to position 6 of SEQ ID NO: 14;
o) a capture probe that will hybridize under high stringency conditions to the complement of SEQ ID NO: 15 and contains ATGA at positions corresponding to positions 17-20 of SEQ ID NO: 15;
p) a capture probe that will hybridize under high stringency conditions to the complement of SEQ ID NO: 16;
q) a capture probe that will hybridize under high stringency conditions to the complement of SEQ ID NO: 17 and contains G at a position corresponding to position 6 of SEQ ID NO: 17;
r) a capture probe that will hybridize under high stringency conditions to the complement of SEQ ID NO: 18 and contains G at a position corresponding to position 6 of SEQ ID NO: 18;
s) a capture probe that will hybridize under high stringency conditions to the complement of SEQ ID NO: 19 and contains A at a position corresponding to position 6 of SEQ ID NO: 19;
t) a capture probe that will hybridize under high stringency conditions to the complement of SEQ ID NO: 20 and contains C at a position corresponding to position 11 of SEQ ID NO: 20;
u) a capture probe that will hybridize under high stringency conditions to the complement of SEQ ID NO: 21 and contains C at a position corresponding to position 13 of SEQ ID NO: 21;
v) a capture probe that will hybridize under high stringency conditions to the complement of SEQ ID NO: 22 and contains A at a position corresponding to position 12 of SEQ ID NO: 22;
w) a capture probe that will hybridize under high stringency conditions to the complement of SEQ ID NO: 23 and contains A at a position corresponding to position 11 of SEQ ID NO: 23;
x) a capture probe that will hybridize under high stringency conditions to the complement of SEQ ID NO: 24 and contains G at a position corresponding to position 14 of SEQ ID NO: 24;
y) a capture probe that will hybridize under high stringency conditions to the complement of SEQ ID NO: 25 and contains T at a position corresponding to position 17 of SEQ ID NO: 25;
z) a capture probe that will hybridize under high stringency conditions to the complement of SEQ ID NO: 26 and contains A at a position corresponding to position 8 of SEQ ID NO: 26;
aa) a capture probe that will hybridize under high stringency conditions to the complement of SEQ ID NO: 27 and contains G at a position corresponding to position 6 of SEQ ID NO: 27;
ab) a capture probe that will hybridize under high stringency conditions to the complement of SEQ ID NO: 28 and contains C at a position corresponding to position 8 of SEQ ID NO: 28;
ac) a capture probe that will hybridize under high stringency conditions to the complement of SEQ ID NO: 29 and contains G at a position corresponding to position 14 of SEQ ID NO: 29;
ad) a capture probe that will hybridize under high stringency conditions to the complement of SEQ ID NO: 30 and contains G at a position corresponding to position 16 of SEQ ID NO: 30;
ae) a capture probe that will hybridize under high stringency conditions to the complement of SEQ ID NO: 31 and contains A at a position corresponding to position 14 of SEQ ID NO: 31;
af) a capture probe that will hybridize under high stringency conditions to the complement of SEQ ID NO: 32 and contains A at a position corresponding to position 12 of SEQ ID NO: 32;
ag) a capture probe that will hybridize under high stringency conditions to the complement of SEQ ID NO: 33 and contains A at a position corresponding to position 12 of SEQ ID NO: 33;
ah) a capture probe that will hybridize under high stringency conditions to the complement of SEQ ID NO: 34 and contains G at a position corresponding to position 12 of SEQ ID NO: 34;
ai) a capture probe that will hybridize under high stringency conditions to the complement of SEQ ID NO: 35 and contains T at a position corresponding to position 15 of SEQ ID NO: 35; and
aj) a capture probe that will hybridize under high stringency conditions to the complement of SEQ ID NO: 36 and contains T at a position corresponding to position 11 of SEQ ID NO: 36;

15. The kit of claim 14 wherein each of the capture probes has a length of about 18 to about 50 nucleic acids.

16. The kit of claim 15 wherein each of the capture probes has a length of about 18 to about 40 nucleic acids.

17. The kit of claim 16 wherein each of the capture probes has a length of about 18 to about 30 nucleic acids.
